(19) United States
(12) Patent Application Publication
(10) Pub. No.: US 2005/0210014 A1
(43) Pub. Date: Sep. 22, 2005

(54) Information-processing method, decryption method, information-processing apparatus and computer program

(75) Inventor: Tomoyuki Asano, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/072,596

(22) Filed: Mar. 7, 2005

(30) Foreign Application Priority Data
Mar. 8, 2004 (JP) P2004-063477
Mar. 15, 2004 (JP) P2004-073057

(51) Int. Cl. G06F 7/00

(52) U.S. Cl. 707/3

(57) ABSTRACT

There is provided an information-processing method for generating a hierarchical tree to be applied to processing to provide decryption apparatus with cryptograms, which can be decrypted only by specifically selected ones of the decryption apparatus excluding revoked decryption apparatus, by adoption of a broadcast encryption method based on a hierarchical tree configuration, the method including: a tree generation step of generating a one-way hierarchical tree as a tree in which a node key assigned to each of nodes composing the one-way hierarchical tree is set at such a value that the node key assigned to a node on a hierarchical layer at a higher level can be computed by applying a one-way function F to at least one of node keys assigned to nodes on a hierarchical layer at a lower level; and a node-key selection step at which, as node keys to be provided to each of the decryption apparatus each serving as a receiver associated with any particular one of terminal nodes on a hierarchical layer at a lowest level of the one-way hierarchical tree, as few node keys as possible are selected among node keys assigned to nodes on a path from the particular lowest-layer terminal node associated with the receiver to a node serving as a root on a hierarchical layer at a highest level of the one-way hierarchical tree except that, as selectable node keys, those of nodes each having a node key computable by applying the one-way function F are excluded.

### BACKGROUND OF THE INVENTION

The present invention relates to an information-processing method, a decryption method, an information-processing apparatus and a computer program. More particularly, the present invention relates to an information-processing method and a decryption method, which are used for reducing the amount of key information stored in a receiver and implementing efficient and secure distribution of information by applying a one-way hierarchical tree having a configuration allowing keys ranging from low-order keys to high-order keys to be computed by using a one-way function for a complete sub-tree method (CS method) presently known in a broadcast encryption method applying a hierarchical tree structure, relates to an information-processing apparatus adopting the information-processing method and the decryption method as well as relates to a computer program implementing the information-processing method and the decryption method.

In recent years, contents are distributed through a network such as the Internet and information-recording media such as a CD (Compact Disc), a DVD (Digital Versatile Disk) and an MD (Mini Disk). The distributed contents include audio data such as music, video data such as pictures and various kinds of software data such as a game program and a variety of application programs. The distributed contents are reproduced and utilized in a variety of information-processing apparatus owned by the user. The information-processing apparatus include a PC (Personal Computer), a player and a game machine.

In general, an author or distributor of many contents such as musical data and picture data owns the right to distribute the contents. Thus, when these. contents are distributed, a distribution system/method is generally adopted. In the distribution system, a certain utilization limit is applied to the contents. That is to say, only an authorized user is allowed to utilize the distributed contents and processing such as an unauthorized copy operation is not permitted.

Particularly, in recent years, a recording medium and a recording apparatus for digitally recording data onto the recording medium have been becoming popular. In accordance with such a digital recording apparatus and such a digital recording medium, data such as a picture and a sound can be recorded and reproduced repeatedly without deteriorating the data. In consequence, there is raised a problem of distribution of an illegally copied content through the Internet and an illegal operation to copy contents recorded on a recording medium such as CD-R.

There is a system in which, as a method for preventing such a content from being used illegally, a content or a key for decrypting an encrypted content is encrypted before being distributed. In such a system, only a specifically authorized user or a specifically authorized device is allowed to decrypt the distributed data. A hierarchical tree structure is applied to a known typical configuration of the system. The hierarchical tree structure is an implementation of the broadcast encryption method.

Processing to provide encrypted data such as an encryption key applying the hierarchical tree structure is explained by referring to diagrams.

A hierarchical tree structure shown in FIG. 1 is a 2-branch tree structure in which the hierarchical layer at the lowest level is referred to as a hierarchical layer comprising leaves. A 2-branch tree is defined as a tree in which each node except a leaf has 2 direct subordinate nodes. The hierarchical tree structure comprises nodes including the vertex, branch points and the leaves themselves. It is to be noted that, in the following description, the vertex is referred to as a root or a root node. The 2-branch hierarchical tree structure shown in FIG. 1 comprises nodes 1 to 15 including the root 1 and leaves 8 to 15.

The leaves 8 to 15 on the hierarchical layer at the lowest level of the 2-branch hierarchical tree structure are each assigned to an information-processing apparatus functioning as an apparatus for utilizing a content. Examples of an apparatus for utilizing a content include a reproduction apparatus and a receiver.

In addition, a node key is assigned to each of the nodes 1 to 15 including the leaves 8 to 15. In some cases, node keys assigned to leaves 8 to 15 are each referred to as a leaf key.

Node keys assigned to nodes on a path from any particular leaf to the root are given to an information-processing apparatus associated with the particular leaf. The configuration shown in FIG. 1 includes 8 information-processing apparatus associated with the leaves 8 to 15 respectively. Node keys assigned to the nodes 1 to 15 are given to the 8 information-processing apparatus. To be more specific, for example, 4 node keys assigned to nodes 1, 2, 4 and 8 are given to an information-processing apparatus 101 associated with the leaf 8 whereas 4 node keys assigned to nodes 1, 3, 6 and 12 are given to an information-processing apparatus 102 associated with the leaf 12. In the information-processing apparatus, the node keys are stored in a safe manner.

By referring to FIG. 2, the following description explains a method for transmitting information that can be acquired by a selected information-processing apparatus as a method using setting accompanying processing to distribute node keys. For example, assume a system in which an encrypted content is distributed by adoption of a broadcasting technique or by using a recording medium such as a DVD for recording the content. An encrypted content such as a piece of specific music or specific picture data is a content obtained as a result of an encryption process. A key for decrypting the encrypted content is provided to only a specific user having the right to utilize a legal content or only a specific information-processing apparatus. The key for decrypting an encrypted content is referred to as a content key K_{c}.

Assume that in a tree shown in FIG. 2, an information-processing apparatus associated with a leaf 14 has been determined to be an invalid apparatus and therefore revoked from the tree. The remaining information-processing apparatus are each regarded as a valid apparatus. In this case, cryptograms are generated as an encrypted code not allowing the invalid information-processing apparatus associated with the leaf 14 to acquire the content key K_{c} but allowing the other valid information-processing apparatus to acquire the content key K_{c}. The cryptograms are distributed to users and/or information-processing apparatus by way of a network or by storing the cryptogram onto a recording medium.

In this case, some specific node keys shared by as many information-processing apparatus are used in an encryption process to generate the cryptograms to be distributed. The specific node keys shared by as many information-processing apparatus are keys assigned to nodes in the upper portion of the tree. The specific node keys must be keys other than node keys held by the revoked information-processing apparatus. The node keys held by the revoked information-processing apparatus are each a key denoted by a cross (x) mark in the figure.

In the typical tree shown in FIG. 2, a set of a cryptogram is distributed as an encrypted code generated as a result of encrypting the node key K_{c} by using node keys assigned to nodes 2, 6 and 15. In the figure, notation E (NK₂,K_{c}), E (NK₆,K_{c}), E (NK₁₅,K_{c}) represents the set of cryptograms. The set of cryptograms is generated and distributed to users and/or information-processing apparatus by way of a network or by recording the cryptogram set onto a recording medium. It is to be noted that notation E (A,B) represents encrypted data obtained as a result of a process to encrypt data B by using a key A. Notation NKₙ denotes a node key having a number n where n is the number assigned to a node in the tree. That is to say, notation E (NK₂,K_{c}), E (NK₆,K_{c}), E (NK₁₅,K_{c}) represents a set of 3 cryptograms expressed by respectively E (NK₂,K_{c}) representing a cryptogram obtained as a result of encrypting the content key K_{c} by using the node key NK₂, E (NK₆,K_{c}) representing a cryptogram obtained as a result of encrypting the content key K_{c} by using the node key NK₆ and E (NK₁₅,K_{c}) representing a cryptogram obtained as a result of encrypting the content key K_{c} by using the node key NK₁₅.

By creating the 3 cryptograms and transmitting the cryptograms through typically a broadcasting transmission channel, any of unrevoked information-processing apparatus is capable of decrypting one of the cryptograms by using the node key of its own to obtain the content key K_{c}. In the example shown in FIG. 2, the unrevoked information-processing apparatus are information-processing apparatus associated with the leaves 8 to 13 and the leaf 15. Since the information-processing apparatus associated with the revoked leaf 14 does not hold either of the 3 node keys NK₂, NK₆ and NK₁₅ applied to their respective cryptograms, however, the information-processing apparatus associated with the revoked leaf 14 is not capable of decrypting the cryptograms even if the information-processing apparatus receives the cryptograms. Thus, the information-processing apparatus associated with the revoked leaf 14 is not capable of obtaining the content key K_{c}.

Broadcast encryption methods announced so far in formal gatherings such as academic conferences include a method described in non-patent reference 1. The announced broadcast encryption method described in non-patent reference 1 is referred to as a CS (Complete Sub-tree) method.

In a process to distribute information by using such a tree structure, however, a large number of information-processing apparatus each associated with a leaf of the tree structure raises a problem that the number of messages transmitted by adoption of a broadcasting technique and the amount of key information to be kept in safe manner in each of the information-processing apparatus also increase as well. The key information to be kept in safe manner in each of the information-processing apparatus includes node keys. In the following description, an information-processing each associated with a leaf of the tree structure is also referred to as a user apparatus.

In the case of the CS method cited above, assume for example that the total number of receivers (or recipients) in the broadcast encryption system is N and the number of revoked information-processing apparatus incapable of receiving secret information transmitted by adoption of a broadcasting technique in the system is r. In this case, the number of messages (or cryptograms) to be transmitted by adoption of a broadcasting technique is r×log(N/r). In addition, the number of keys to be stored in a safe memory is log N+1 for each receiver. It is to be noted that, in this specification, the base of the logarithmic function is 2 unless another base is particularly specified.

As described above, the information distribution system using a tree structure raises a problem that, if the number of information-processing apparatus each associated with a leaf of the tree structure rises, the number of messages transmitted by adoption of a broadcasting technique and the amount of key information such as node keys to be kept in safe manner in each of the information-processing apparatus also increase as well. If the number of node keys to be stored in a receiver increases, the amount of information to be managed in each information-processing apparatus with a high degree of security also rises as well. Thus, the information distribution system using a tree structure raises a problem that the size of a secure memory in each user apparatus also need to be increased, causing the manufacturing cost of the user apparatus to rise as well.

Methods each proposed so far as a technique to solve the problems described above include an SD (Subset Difference) method and an LSD (Layered Subset Difference) method, which is an improved version of the SD method. The SD method is described in documents including non-patent reference 1. On the other hand, the LSD method is described in documents including non-patent reference 2.

Assuming that the total number of receivers (or recipients) in the broadcast encryption system is N and the number of revoked information-processing apparatus incapable of receiving secrete information transmitted by adoption of a broadcasting technique in the system is r, in either of the methods, the number of messages (cryptograms) to be transmitted by adoption of a broadcasting technique is O(r), which is small in comparison with other methods including the complete sub-tree method cited above. Thus, either of the LSD and SD methods is superior to the other methods.

However, the number of keys (or labels each used for generating a key) to be stored by each receiver in a safe memory is O(log² N) in the case of the SD method and O(log^{1+ε} N) in the case of the LSD method. In this case, symbol e denotes any arbitrary positive number. Thus, the number of key for each of the SD and LSD methods is large in comparison with other methods including the complete sub-tree method, raising a problem of how to reduce the numbers of keys. It is to be noted that, in this specification, the base of the logarithmic function is 2 unless another base is particularly specified as described above.

Non-Patent Reference 1:

Advances in Cryptography-Crypto 2001, Lectures Notes in Computer Science 2139, Springer, 2001, pp. 41-62 “Revocation and Tracing Schemes for Stateless Receivers” authored by D. Naor, M. Naor and J. Lotspiech.

Non-Patent Reference 2:

Advances in Cryptography-Crypto 2002, Lectures Notes in Computer Science 2442, Springer, 2002, pp. 47-60 “The LSD Broadcast Encryption Scheme” authored by D. Halevy and A. Shamir.

### SUMMARY OF THE INVENTION

It is thus an object of the present invention addressing the problems described above to provide an information-processing method and a decryption-method, which are capable of reducing the number of keys (or labels each used for finding a key) to be stored in each receiver by applying a one-way hierarchical tree described below to a CS (complete sub-tree) method presently known in a broadcast encryption method as a basic method, an SD (subset difference) method known in an information distribution configuration applying a typical hierarchical tree structure as a relatively efficient configuration and an LSD (Layered Sub-set Difference) method serving as an improved version of the SD method, to provide an information-processing apparatus adopting the information-processing method and the decryption method, and to provide computer programs implementing the information-processing method and the decryption method.

In order to solve the problems described above, according to a first aspect of the present invention, there is provided an information-processing method for generating a hierarchical tree to be applied to processing to provide decryption apparatus with cryptograms, which can be decrypted only by specifically selected ones of the decryption apparatus excluding revoked decryption apparatus, by adoption of a broadcast encryption method based on a hierarchical tree configuration, the information-processing method including: a tree generation step of generating a one-way hierarchical tree as a tree in which a node key assigned to each of nodes composing the one-way hierarchical tree is set at such a value that the node key assigned to a node on a hierarchical layer at a higher level can be computed by applying a one-way function F to at least one of node keys assigned to nodes on a hierarchical layer at a lower level; and a node-key selection step at which, as node keys to be provided to each of the decryption apparatus each serving as a receiver associated with any particular one of terminal nodes on a hierarchical layer at a lowest level of the one-way hierarchical tree, as few node keys as possible are selected among node keys assigned to nodes on a path from the particular lowest-layer terminal node associated with the receiver to a node serving as a root on a hierarchical layer at a highest level of the one-way hierarchical tree except that, as selectable node keys, those of nodes each having a node key computable by applying the one-way function F are excluded.

According to a second aspect of the present invention, there is provided a decryption method for carrying out a process to decrypt a cryptogram obtained as a result of an encryption process using a node key for a node in a hierarchical tree by adoption of a broadcast encryption method based on a hierarchical tree configuration, the decryption method including: a cryptogram selection step of selecting a decryptable cryptogram from a set of cryptograms each obtained as a result of the encryption process as a cryptogram that can be decrypted by using a node key held by an apparatus adopting the decryption method or a higher-level node key computable from the held node key; a node-key computation step at which, if a node key to be used for decrypting the selected cryptogram is not the held node key, the node key to be used for decrypting the selected cryptogram is computed by applying a one-way function F to the held node key; and a cryptogram decryption step of decrypting the selected cryptogram by using the held node key or the node key computed by applying the one-way function F to the held node key.

According to a third aspect of the present invention, there is provided an information-processing apparatus for generating a hierarchical tree to be applied to processing to provide decryption apparatus with cryptograms, which can be decrypted only by specifically selected ones of the decryption apparatus excluding revoked decryption apparatus, by adoption of a broadcast encryption method based on a hierarchical tree configuration, the information-processing apparatus including: a tree generation unit for generating a one-way hierarchical tree as a tree in which a node key assigned to each of nodes composing the one-way hierarchical tree is set at such a value that the node key assigned to a node on a hierarchical layer at a higher level can be computed by applying a one-way function F to at least one of node keys assigned to nodes on a hierarchical layer at a lower level; and a node-key selection unit wherein, as node keys to be provided to each of the decryption apparatus each serving as a receiver associated with any particular one of terminal nodes on a hierarchical layer at a lowest level of the one-way hierarchical tree, as few node keys as possible are selected among node keys assigned to nodes on a path from the particular lowest-layer terminal node associated with the receiver to a node serving as a root on a hierarchical layer at a highest level of the one-way hierarchical tree except that, as selectable node keys, those of nodes each having a node key computable by applying the one-way function F are excluded.

According to a fourth aspect of the present invention, there is provided an information-processing apparatus for carrying out a process to decrypt a cryptogram obtained as a result of an encryption process using a node key for a node in a one-way hierarchical tree by adoption of a broadcast encryption method based on a hierarchical tree configuration, the information-processing apparatus including: a cryptogram selection unit for selecting a decryptable cryptogram from a set of cryptograms each obtained as a result of the encryption process as a cryptogram that can be decrypted by using a node key held by the information-processing apparatus or a higher-level node key computable from the held node key; a node-key computation unit for computing a node key to be used for decrypting the selected cryptogram by applying a one-way function F to the held node key in case the node key to be used for decrypting the selected cryptogram is not the held node key; and a cryptogram decryption unit for decrypting the selected cryptogram by using the held node key or the node key computed by applying the one-way function F to the held node key.

According to a fifth aspect of the present invention, there is provided a computer program for generating a hierarchical tree to be applied to processing to provide decryption apparatus with cryptograms, which can be decrypted only by specifically selected ones of the decryption apparatus excluding revoked decryption apparatus, by adoption of a broadcast encryption method based on a hierarchical tree configuration, the computer program including: a tree generation step of generating a one-way hierarchical tree as a tree in which a node key assigned to each of nodes composing the one-way hierarchical tree is set at such a value that the node key assigned to a node on a hierarchical layer at a higher level can be computed by applying a one-way function F to at least one of node keys assigned to nodes on a hierarchical layer at a lower level; and a node-key selection step at which, as node keys to be provided to each of the decryption apparatus each serving as a receiver associated with any particular one of terminal nodes on a hierarchical layer at a lowest level of the one-way hierarchical tree, as few node keys as possible are selected among node keys assigned to nodes on a path from the particular lowest-layer terminal node associated with the receiver to a node serving as a root on a hierarchical layer at a highest level of the one-way hierarchical tree except that, as selectable node keys, those of nodes each having a node key computable by applying the one-way function F are excluded.

According to a sixth aspect of the present invention, there is provided a computer program for carrying out a process to decrypt a cryptogram obtained as a result of an encryption process using a node key for a node in a hierarchical tree by adoption of a broadcast encryption method based on a hierarchical tree configuration, the computer program including: a cryptogram selection step of selecting a decryptable cryptogram from a set of cryptograms each obtained as a result of the encryption process as a cryptogram that can be decrypted by using a node key held by an apparatus adopting the decryption method or a higher-level node key computable from the held node key; a node-key computation step of computing a node key to be used for decrypting the selected cryptogram by applying a one-way function F to the held node key if the node key to be used for decrypting the selected cryptogram is not the held node key; and a cryptogram decryption step of decrypting the selected cryptogram by using the held node key or the node key computed by applying the one-way function F to the held node key.

According to a seventh aspect of the present invention, there is provided an information-processing method for generating a hierarchical tree to be applied to processing to provide decryption apparatus with cryptograms, which can be decrypted only by specifically selected ones of the decryption apparatus excluding revoked decryption apparatus, by adoption of a broadcast encryption method based on a hierarchical tree configuration, the information-processing method including: a label generation step of generating labels, which have values of labels for some selected special subsets as values each computable by applying a one-way function F to the value of another label, as labels for subsets determined on the basis of an SD (Subset Difference) method applying a hierarchical tree configuration; a provided-label determination step of determining labels to be provided to each of the decryption apparatus each serving as a receiver associated with a terminal node of the hierarchical tree; and a final-label determination step of selecting labels not provided for special subsets and as few labels provided for special subsets as possible among the labels to be provided to the receiver as final labels to be provided to the receiver by screening the few labels provided for special subsets to exclude those computable by applying the one-way function F to the value of one of the final labels provided to the receiver.

According to an eighth aspect of the present invention, there is provided a decryption method for carrying out a process to decrypt a cryptogram obtained as a result of an encryption process using a subset key for a subset in a hierarchical tree by adoption of an SD (Subset Difference) method implemented as a broadcast encryption method based on a hierarchical tree configuration, the decryption method including: a cryptogram selection step of selecting a decryptable cryptogram from a set of cryptograms each obtained as a result of the encryption process as a cryptogram that can be decrypted by a subset key computable by carrying out a pseudo random number generation process on a label held by a decryption apparatus or another label derivable from the held label; a label derivation step of deriving a label required for computing a subset key to be used for decrypting the selected cryptogram by applying a one-way function F to the held label as a label different from the held label if the subset key to be used for decrypting the selected cryptogram is not a subset key computable by carrying out the pseudo random number generation process on the held label; a subset key generation step of generating a subset key computed by carrying out the pseudo random number generation process on the held label or the label derived from the held label; and a cryptogram decryption step of carrying out a process to decrypt the selected cryptogram by using the subset key computed by carrying out the pseudo random number generation process on the held label or the label derived from the held label.

According to a ninth aspect of the present invention, there is provided an information-processing apparatus for generating a hierarchical tree to be applied to processing to provide decryption apparatus with cryptograms, which can be decrypted only by specifically selected ones of the decryption apparatus excluding revoked decryption apparatus, by adoption of a broadcast encryption method based on a hierarchical tree configuration, the information-processing apparatus including: a label generation unit for generating labels, which have values of labels for some selected special subsets as values each computable by applying a one-way function F to the value of another label, as labels for subsets determined on the basis of an SD (Subset Difference) method applying a hierarchical tree configuration; a provided-label determination unit for determining labels to be provided to each of the decryption apparatus each serving as a receiver associated with a terminal node of the hierarchical tree; and a final-label determination unit for selecting labels not provided for special subsets and as few labels provided for special subsets as possible among the labels to be provided to the receiver as final labels to be provided to the receiver by screening the few labels provided for special subsets to exclude those computable by applying the one-way function F to the value of one of the final labels provided to the receiver.

According to a tenth aspect of the present invention, there is provided an information-processing apparatus for carrying out a process to decrypt a cryptogram obtained as a result of an encryption process using a subset key for a subset in a hierarchical tree by adoption of an SD (Subset Difference) method implemented as a broadcast encryption method based on a hierarchical tree configuration, the information-processing apparatus including: a cryptogram selection unit for selecting a decryptable cryptogram from a set of cryptograms each obtained as a result of the encryption process as a cryptogram that can be decrypted by a subset key computable by carrying out a pseudo random number generation process on a label held by the information-processing apparatus itself or another label derivable from the held label; a label derivation unit for deriving a label required for computing a subset key to be used for decrypting the selected cryptogram by applying a one-way function F to the held label as a label different from the held label if the subset key to be used for decrypting the selected cryptogram is not a subset key computable by carrying out the pseudo random number generation process on the held label; a subset key generation unit for generating a subset key computed by carrying out the pseudo random number generation process on the held label or the label derived from the held label; and a cryptogram decryption unit for carrying out a process to decrypt the selected cryptogram by using the subset key computed by carrying out the pseudo random number generation process on the held label or the label derived from the held label.

According to an eleventh aspect of the present invention, there is provided a computer program for generating a hierarchical tree to be applied to processing to provide decryption apparatus with cryptograms, which can be decrypted only by specifically selected ones of the decryption apparatus excluding revoked decryption apparatus, by adoption of a broadcast encryption method based on a hierarchical tree configuration, the computer program including: a label generation step of generating labels, which have values of labels for some selected special subsets as values each computable by applying a one-way function F to the value of another label, as labels for subsets determined on the basis of an SD (Subset Difference) method applying a hierarchical tree configuration; a provided-label determination step of determining labels to be provided to each of the decryption apparatus each serving as a receiver associated with a terminal node of the hierarchical tree; and a final-label determination step of selecting labels not provided for special subsets and as few labels provided for special subsets as possible among the labels to be provided to the receiver as final labels to be provided to the receiver by screening the few labels provided for special subsets to exclude those computable by applying the one-way function F to the value of one of the final labels provided to the receiver.

According to a twelfth aspect of the present invention, there is provided a computer program for carrying out a process to decrypt a cryptogram obtained as a result of an encryption process using a subset key for a subset in a hierarchical tree by adoption of an SD (Subset Difference) method implemented as a broadcast encryption method based on a hierarchical tree configuration, the computer program including: a cryptogram selection step of selecting a decryptable cryptogram from a set of cryptograms each obtained as a result of the encryption process as a cryptogram that can be decrypted by a subset key computable by carrying out a pseudo random number generation process on a label held by a decryption apparatus or another label derivable from the held label; a label derivation step of deriving a label required for computing a subset key to be used for decrypting the selected cryptogram by applying a one-way function F to the held label as a label different from the held label if the subset key to be used for decrypting the selected cryptogram is not a subset key computable by carrying out the pseudo random number generation process on the held label; a subset key generation step of generating a subset key computed by carrying out the pseudo random number generation process on the held label or the label derived from the held label; and a cryptogram decryption step of carrying out a process to decrypt the selected cryptogram by using the subset key computed by carrying out the pseudo random number generation process on the held label or the label derived from the held label.

It is to be noted that a computer program provided by the present invention is a program typically provided to a computer system capable of executing various kinds of program code. In addition, the computer program is provided to the computer system in a format that can be read by a computer employed in the computer system. On the top of that, the computer program is a program typically provided to a computer system by storing the program in a recording medium such as a CD, FD or MO for the computer system or by way of a communication media such as a network. Moreover, the computer program is executed in the computer system for carrying out processing according to the program.

Other objects of the present invention as well as its characteristics and merits thereof will probably become more obvious from a detailed study of embodiments explained later with reference to accompanying diagrams as embodiments of the present invention. It is to be noted that the technical term ‘system’ used in this specification means a logical set of a plurality apparatus, which are not necessarily enclosed in a single housing.

In accordance with the configuration of the present invention, a one-way hierarchical tree is created as a tree with relations set between nodes composing the tree and the values of node keys each provided for one of the nodes in an information distribution configuration applying a hierarchical tree structure serving as an implementation of a broadcast encryption method. That is to say, in the one-way hierarchical tree, the value of a node key for a node on a hierarchical layer at a higher level is computed by applying a one-way function F to the value of a node key for a node on a hierarchical layer at a lower level. Cryptograms are generated in a process to encrypt secret information by using node keys and distributed to receivers on the basis of the one-way hierarchical tree. Every receiver is provided with as few node keys as possible. The node keys are selected among node keys assigned to nodes on a path from a particular lowest-layer terminal node associated with the receiver to the root node on the hierarchical layer at the highest level of the one-way hierarchical tree. The selected node keys do not include those of nodes each having a node key computable by applying the one-way function F to the node key of a node on a hierarchical layer at a lower level. If a node key to be used for decrypting a received cryptogram is not a node key held by a receiver, the receiver is capable of computing the node key to be used for decrypting a received cryptogram by applying the one-way function F to a node key held by the receiver. By adoption of such a one-way hierarchical tree, the amount of information such as node keys to be held by every receiver in a safe manner can be reduced.

In addition, in an information distribution configuration applying a hierarchical tree structure serving as an implementation of a broadcast encryption method, by further applying the one-way hierarchical tree to the relatively efficient SD (Subset Difference) and the LSD (Layered Subset Difference) methods, it is possible to reduce the amount of information that should be held by every receiver or every information-processing apparatus in a safe manner.

On the top of that, in accordance with the configuration of the present invention, as a rule, labels of subsets determined on the basis of the SD and LSD methods should be held in every receiver. However, some of the labels assigned to some selected particular special subsets can each be set at a value computable by applying the one-way function F to the value of a label for another special subset. Thus, only labels not provided for special subsets and as few labels provided for special subsets as possible are given to every receiver. The few labels provided for special subsets do not include the labels assigned to the particular special subsets because the labels assigned to the particular special subsets can each be set at a value computable by applying the one-way function F to the value of another label determined as a label given to the receiver. Thus, in comparison with the related-art SD and LSD methods, the number of labels to be held by every receiver is small. This is because the value of each label eliminated from a list of labels to be held in the receiver can be found by applying the one-way function F to the value of a label held by the receiver. Thus, it is possible to carry out processing for all subsets set on the basis of the related-art SD and LSD methods. As a result, by adopting the configuration of the present invention, it is possible to reduce the amount of information to be held in every receiver as labels in a safety manner.

### BRIEF DESCRIPTION OF THE DRAWINGS

FIG. 1 is an explanatory diagram referred to in describing the structure of a 2-branch one-way hierarchical tree;

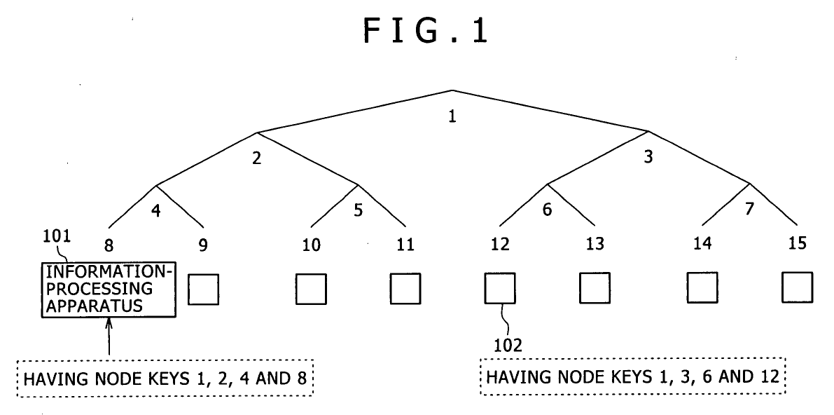

FIG. 2 is an explanatory diagram referred to in describing a method of transmitting information that can be decrypted only by selected information-processing apparatus in the structure of a 2-branch one-way hierarchical tree;

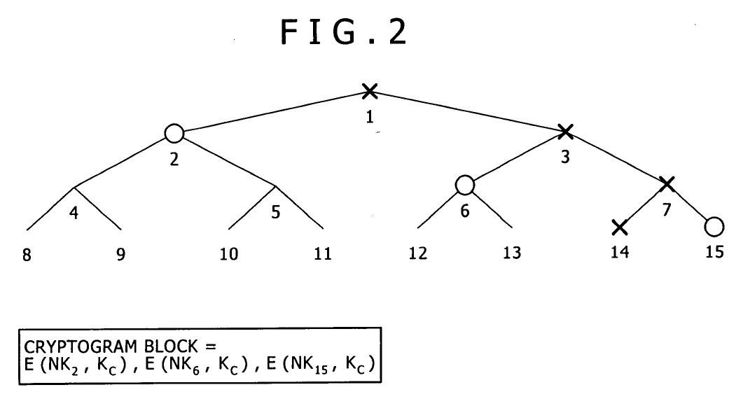

FIG. 3 is an explanatory diagram referred to in describing an overview of a CS (Complete Sub-tree) method;

FIG. 4 is an explanatory diagram referred to in describing node keys held by a receiver associated with a leaf of a 2-branch one-way hierarchical tree;

FIG. 5 is an explanatory diagram referred to in describing a process to selectively provide secret information to only unrevoked receivers;

FIG. 6 is an explanatory diagram referred to in describing different partial trees in a 2-branch one-way hierarchical tree;

FIG. 7 is an explanatory diagram referred to in describing the configuration of a 2-branch one-way hierarchical tree;

FIG. 8 shows a flowchart representing an algorithm for setting values as node keys each assigned to (2N−1) nodes composing a 2-branch one-way hierarchical tree;

FIG. 9 is an explanatory diagram referred to in describing assignment of node numbers to nodes composing a 2-branch one-way hierarchical tree wherein a node number of 1 is assigned to a root of the 2-branch one-way hierarchical tree and other node numbers are assigned to other nodes in a breadth first order;

FIGS. 10A and 10B are explanatory diagrams referred to in describing node keys held in every receiver associated with one of leaves of a 2-branch one-way hierarchical tree;

FIG. 11 is an explanatory diagram referred to in describing bit expressions each representing Path-m of one of 16 receivers u1 to u16 shown in FIGS. 10A and 10B as bit expressions each hinting node keys held in each of the receivers u1 to u16;

FIG. 12 shows a flowchart representing a setup process;

FIG. 13 shows a flowchart representing the procedure of an information distribution process;

FIG. 14 is an explanatory diagram referred to in describing a process to obtain a node key used by a receiver to decrypt a cryptogram in the configuration of a 2-branch one-way hierarchical tree;

FIG. 15 shows a flowchart representing the procedure of a process to decrypt a cryptogram in a receiver;

FIG. 16 is an explanatory diagram referred to in describing node keys held by a receiver and node keys computable by applying a one-way function F in the configuration of a 2-branch one-way hierarchical tree;

FIG. 17 is an explanatory diagram referred to in describing the configuration of an information-processing apparatus carrying out a process to determine node keys and a process to generate cryptograms;

FIG. 18 is an explanatory diagram referred to in describing the configuration of an information-processing apparatus functioning as a receiver for carrying out a process to decrypt a cryptogram;

FIG. 19 is a block diagram referred to in describing a typical hardware configuration of an information-processing apparatus;

FIG. 20 is an explanatory diagram referred to in describing the definition of a subset in an SD (Subset Difference) method;

FIGS. 21A and 21B are explanatory diagrams referred to in describing a configuration for finding a label for each subset in the SD method and computing the subset key of a subset from the label for the subset;

FIGS. 22A through 22D are explanatory diagrams referred to in describing labels to be held in every receiver in the SD method;

FIG. 23 is an explanatory diagram referred to in describing a typical example of labels to be held in a receiver in the SD method for N=16 where N is the total number of receivers;

FIG. 24 is an explanatory diagram referred to in describing details of labels held in every receiver in the SD method;

FIG. 25 is an explanatory diagram referred to in describing details of labels held in every receiver in the SD method;

FIG. 26 is an explanatory diagram referred to in describing details of subsets held in a specific receiver u4 in the SD method;

FIG. 27 is an explanatory diagram referred to in describing the configuration of a 2-branch one-way hierarchical tree;

FIG. 28 shows a flowchart representing an algorithm for setting values as labels each assigned to (2N−1) nodes composing a 2-branch one-way hierarchical tree;

FIG. 29 is an explanatory diagram referred to in describing assignment of node numbers to nodes composing a 2-branch one-way hierarchical tree wherein a node number of 1 is assigned to a root of the 2-branch one-way hierarchical tree and other node numbers of 2, 3, . . . , and 2N−1 are assigned to other nodes in the breadth first order;

FIG. 30 is an explanatory diagram referred to in describing a typical configuration of a first special subset SS_{P(y),S(y)} for the parent node P(y) of a node y and the child node S(y) serving as the sister node of the node y;

FIGS. 31A and 31B are explanatory diagrams referred to in describing a relation between labels for special subsets and (2N−1) C-bit values x₁, x₂, . . . , and x_{2N-1} computed in accordance with the algorithm explained earlier by referring to the flowchart shown in FIG. 28;

FIG. 32 is an explanatory diagram referred to in describing a process to determine labels to be given to a receiver;

FIG. 33 is an explanatory diagram referred to in describing Path-m and PathNodes-m of a receiver um;

FIG. 34 is an explanatory diagram referred to in describing a process to determine labels to be given to a receiver;

FIG. 35 is an explanatory diagram referred to in describing bit expressions each representing Path-m of one of 16 receivers u1 to u16 shown in FIG. 33 as bit expressions each hinting labels held in each of the receivers u1 to u16;

FIG. 36 shows a flowchart representing a setup process;

FIG. 37 is an explanatory diagram referred to in describing subsets, which are used when receivers u5, u11 and u12 are revoked from the configuration of a 2-branch one-way hierarchical tree with N (=16) leaves each associated with a receiver.

FIG. 38 shows a flowchart representing the procedure of a process to distribute information;

FIG. 39 is an explanatory diagram referred to in concretely describing a typical process to compute a subset key;

FIG. 40 is an explanatory diagram referred to in concretely describing a typical process to compute a subset key;

FIG. 41 is an explanatory diagram referred to in describing a process carried out by a receiver to decrypt a cryptogram;

FIG. 42 is an explanatory diagram referred to in describing the configuration of an information-processing apparatus carrying out a process to determine labels and a process to generate cryptograms;

FIG. 43 is an explanatory diagram referred to in describing the configuration of an information-processing apparatus functioning as a receiver for carrying out a process to decrypt a cryptogram;

FIG. 44 is a block diagram referred to in describing a typical hardware configuration of an information-processing apparatus;

FIG. 45 is an explanatory diagram referred to in describing a basic LSD (Layered Subset Difference) method;

FIG. 46 is an explanatory diagram referred to in describing the number of labels held by every receiver in the basic LSD method; and

FIG. 47 is an explanatory diagram referred to in describing a configuration for reducing the number of labels held by every receiver in the basic LSD method adopting a 2-branch one-way hierarchical tree.

### DETAILED DESCRIPTION OF THE PREFERRED EMBODIMENTS

### First Embodiment

By referring to diagrams showing a first embodiment, the following description explains an information-processing method, a decryption method, an information-processing apparatus and a computer program, which are provided by the present invention, in detail.

It is to be noted that the information-processing method, the decryption method, the information-processing apparatus and the computer program are explained in sections arranged in the following order.
1: Overview of a CS (complete sub-tree) method
2: Overview of a configuration for reducing the number of node keys by applying a one-way hierarchical tree to the CS method
3: Processing to distribute cryptograms by applying a one-way hierarchical tree
   1: Overview of a CS (Complete Sub-Tree) Method

The description begins with an explanation of a CS (complete sub-tree) method known as a basic technique of a broadcast encryption method applying an already existing hierarchical tree structure.

It is to be noted that, in the following description, the total number (N) of information-processing apparatus (or receivers) each associated with a leaf of the hierarchical tree structure is assumed to be the power of 2 for the sake of simplicity. In addition, in the following description, the base of the logarithmic function is 2 in all cases. It is also worth noting that any apparatus can be associated with a leaf of the hierarchical tree structure provided that the apparatus is capable of decrypting secret information described below. Examples of an apparatus capable of decrypting secret information include a variety of information-processing apparatus such as a PC and a portable terminal. These apparatus are named generically as receivers in this description. In addition, a cryptogram distribution process provided by the present invention is not limited to a process to provide cryptograms to users and/or apparatus by communication through a communication network but the cryptogram distribution process provided by the present invention can also be a process to provide cryptograms to users and/or apparatus by storing the cryptograms on a recording medium.

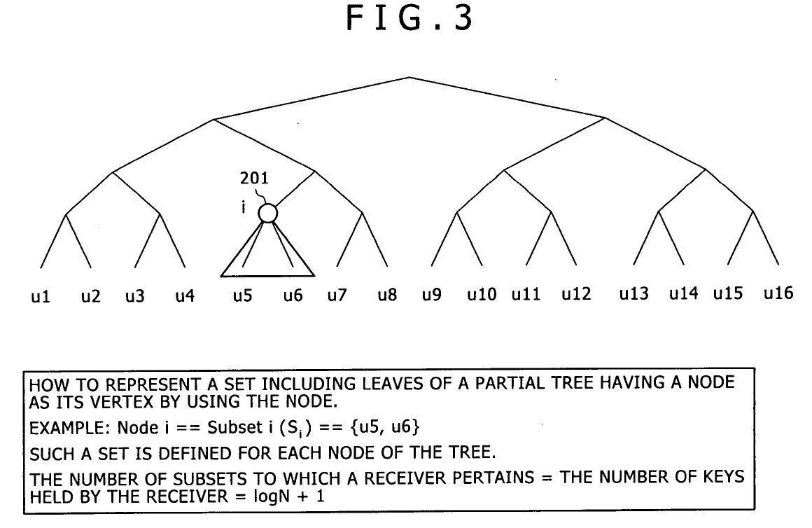

An overview of a CS (complete sub-tree) method is explained by referring to FIG. 3 as follows.

As described before, Non-patent reference 1 is Advances in Cryptography-Crypto 2001, Lectures Notes in Computer Science 2139, Springer, 2001, pp. 41-62 “Revocation and Tracing Schemes for Stateless Receivers” authored by D. Naor, M. Naor and J. Lotspiech. In the CS (complete sub-tree) method described in non-patent reference 1, the hierarchical tree structure is a 2-branch tree in which each node in the tree has 2 direct subordinate nodes as shown in FIG. 3. In the typical tree shown in FIG. 3, the receiver count N is 16. Each of the receivers is associated with a leaf in the 2-branch one-way hierarchical tree. In the tree shown in FIG. 3, symbols u1 to u16 each denote a receiver. A set of receivers is a collection of receivers associated with leaves included in a portion of the tree as leaves sharing a node to serve as a vertex node in the portion of the tree. For example, a node i201 of the tree shown in FIG. 3 is the vertex node of a portion representing a set consisting of the receivers u5 and u6.

In addition, a node key is defined for each of the nodes composing the 2-branch one-way hierarchical tree shown in FIG. 3. Every receiver is provided with node keys defined for nodes on a path from a leaf associated with the receiver to the root on the vertex of the tree. The receiver keeps the node keys in a safe memory. A reliable management center known as a TC (trusted center) carries out processing such as definition of a tree, definition of node keys, determination of leaves to be associated with receivers and distribution of node keys to users and/or receivers.

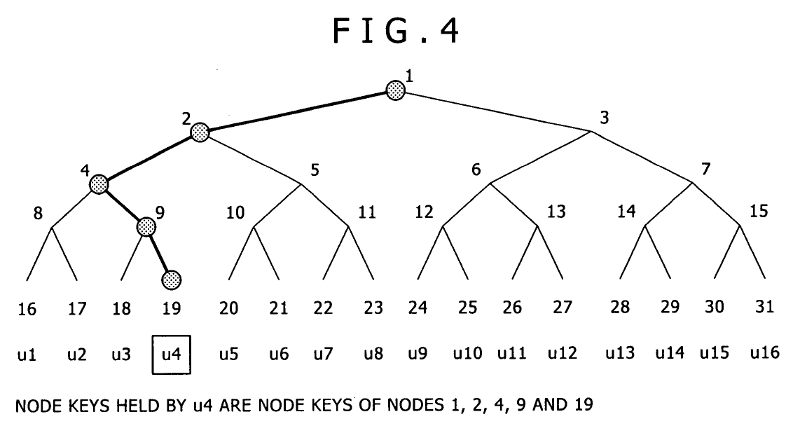

As shown in FIG. 4, 16 receivers u1 to u16 are associated with a hierarchical tree including 31 nodes 1 to 31. The receiver u4 is provided with 5 node keys assigned to nodes 1, 2, 4, 9 and 19 respectively. That is to say, every receiver is provided with (log N+1) node keys where symbol N denotes the total number of receivers associated with leaves of the tree.

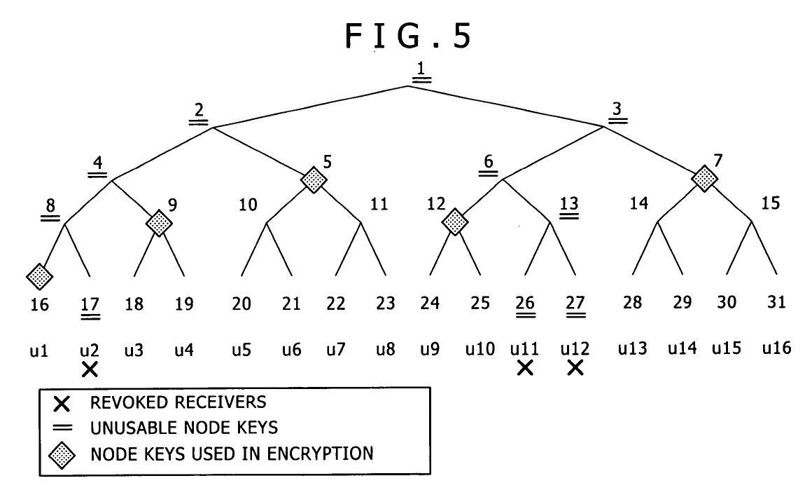

By referring to FIG. 5, the following description explains how to transmit secret information such as a content key for decrypting an encrypted content to receivers, which are not revoked, by using this setting. In this case, assume that the TC (trusted center) serves as the transmitter of the secret information and the receivers u2, u11 and u12 are each a revoked receiver. That is to say, the receivers u2, u11 and u12 are each revoked and treated like an invalid receiver. Thus, only receivers other than the receivers u2, u11 and u12 are capable of receiving the secrete information in a safe manner and carrying a decryption process based on cryptograms distributed by adoption of the broadcasting technique.

In a process carried out by the TC (trusted center) to distribute secret information to receivers, the TC (trusted center) generates a set of cryptograms, which are to be distributed by adoption of the broadcasting technique, without using node keys assigned to nodes on paths from leaves associated with the revoked receivers u2, u11 and u12 to the root as encryption keys.

If node keys assigned to leaves associated with the revoked receivers u2, u11 and u12 and node keys assigned to nodes on paths from these leaves to the root are used as encryption keys, the receivers u2, u11 and u12 will be capable of decrypting the secret information since the these receivers hold these node keys. Therefore, the TC (trusted center) generates a set of cryptograms without using node keys assigned to nodes on paths from leaves associated with the revoked receivers u2, u11 and u12 to the root as encryption keys.

If the nodes on the paths from leaves associated with the revoked receivers u2, u11 and u12 to the root and the paths are eliminated from the tree, more than one partial tree are left in the tree. In this example, partial trees such as a partial tree having the node 5 as the vertex and a partial tree having the node 12 as the vertex remain in the tree.

The TC (trusted center) serving as the transmitter of secret information encrypts the secret information by using node keys assigned to nodes closest to the vertexes of the remaining partial trees and transmits the encrypted secret information as a set of cryptograms to receivers. In the example shown in FIG. 5, the nodes closest to the vertexes of the remaining partial trees are nodes 5, 7, 9, 12 and 16. Assume for example that the secret information is a content key K_{c} to be used in a process to decrypt an encrypted content. In this case, the TC (trusted center) serving as the transmitter of secret information generates a set of cryptograms and provides the set of cryptograms to the receivers by distribution through a network or by storing the set of cryptograms in a recording medium. In the example, the set of cryptograms is represented by the following expression: E (NK₅, K_{c}) E (NK₇, K_{c}) E (NK₉, K_{c}) E (NK₁₂, K_{c}) E (NK₁₆, K_{c}) where symbols NK₅, NK₇, NK₉, NK₁₂ and NK₁₆ denote the node keys assigned to the nodes 5, 7, 9, 12 and 16 respectively. It is to be noted that, as described before, notation E (A, B) represents encrypted data obtained as a result of a process to encrypt data B by using a key A.

Only the revoked receivers u2, u11 and u12 are receivers incapable of decrypting the set of cryptograms, but the remaining receivers are capable of decrypting it. By generating such a set of cryptograms and distributing it, efficient and well protected secret information can be transmitted.

A receiver receiving the set of cryptograms decrypts only a cryptogram that the receiver is capable of decrypting by itself to obtain the content key K_{c} transmitted as secret information. That is to say, the receiver decrypts only a cryptogram encrypted by using a node key assigned to a node on a path from a leaf associated with the receiver to the root. In the example shown in the figure, the receiver u4 is capable decrypting the cryptogram E (NK₉, K_{c}) by using the node key NK₉ assigned to the node 9 since the receiver u4 holds the node key NK₉. It is thus obvious that a cryptogram decryptable by an unrevoked receiver surely is included in the set of cryptograms received by the receiver.

2: Overview of a Configuration for Reducing the Number of Node Keys by Applying a One-Way Hierarchical Tree to the CS Method

As is obvious from observation of the CS method described above, in the CS method, a leaf of a partial tree having a particular node i at the vertex is also a leaf of another partial tree having an ancestor node of the particular node i at the vertex of the other partial tree. An ancestor node of a specific node is defined as a higher level-layer node on a route from the specific node to the root of the tree.

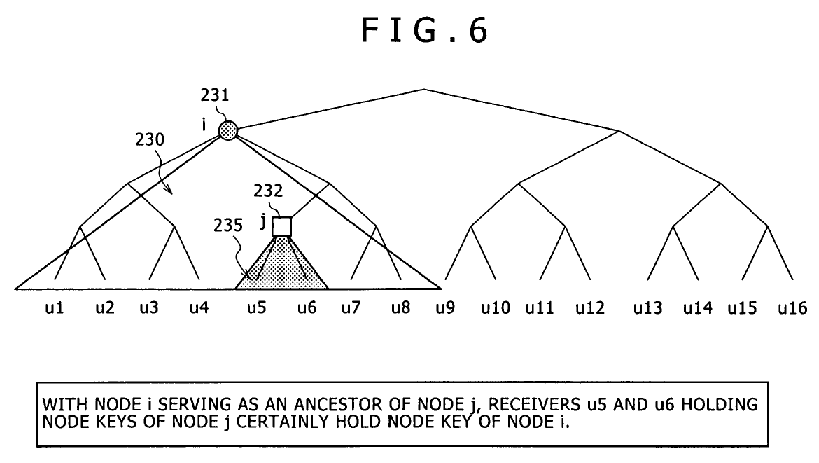

For example, as shown in FIG. 6, leaves included in a partial tree P 235 having a node j232 at the vertex as leaves associated with the receivers u5 and u6 are also leaves of another partial tree A 230 having a node i231 as an ancestor of the node j232 at the vertex of the other partial tree.

Thus, a receiver holding the node key assigned to a node also holds the node key assigned to an ancestor node of the node. In the example shown in FIG. 6, the receivers u5 and u6 each holding the node key assigned to a node j232 certainly hold the node key assigned to an ancestor node i231 of the node j232. However, the reverse does not necessarily hold true. That is to say, a receiver holding the node key assigned to the ancestor node i231 does not necessarily hold the node key assigned to the node j232.

As described above, the two-branch one-directional hierarchical tree has a property that a receiver holding the node key assigned to a particular node also holds the node key assigned to an ancestor node of the particular node but a receiver holding the node key assigned to the ancestor node does not necessarily have the node key assigned to the particular node.

This property can be realized by a node-key system in which every node key is set at such a value that, for example, from a node key set for a particular node, a node key for an ancestor node of the particular node can be computed. In this way, since it is not necessary to provide a plurality of node keys independent of each other, the number of node keys and, hence, the size of a memory employed in the receiver can be reduced.

In the node-key system cited above, however, it is necessary to make the node key of a node on a hierarchical layer at a lower level incomputable from the node key assigned to an ancestor node on an hierarchical layer at a higher level. The node on the hierarchical layer at a lower level is also referred to as an offspring node of the ancestor node on the hierarchical layer at a higher level. In the example shown in FIG. 6, the node i232 is an ancestor node of the offspring node j232. In this case, the receivers u5 and u6 holding the node key assigned to the offspring node j232 certainly hold the node key assigned to the ancestor node i231 too. However, the receivers u1 to u8 holding the node key assigned to the ancestor node i231 do not necessarily hold the node key assigned to the offspring node j232. In the configuration shown in FIG. 6, among the receivers u1 to u8, only the receivers u5 and u6 are allowed to hold the node key assigned to the offspring node j232. That is to say, the receivers u1 to u4 as well as the receivers u7 and u8 are not allowed to hold the node key assigned to the offspring node j232. In addition, in order to realize the node-key system cited above, the receivers u1 to u4 as well as the receivers u7 and u8 must not be capable of computing the node key assigned to the offspring node j232 from the node key assigned to the ancestor node i231.

In order to realize the property described above, the present invention provides a function for allowing y to be computed from x with ease but making reverse computation of x from y difficult. This function is referred to as a one-way function and expressed by y=F(x). By using this function to set the node key of each of nodes, a tree structure comprising the nodes can be constructed.

As described above, in this present invention, a one-way hierarchical tree is used. It is to be noted that the one-way hierarchical tree is not a general term, but a technical term for defining one property of a tree structure used for explaining the present invention.

The definition of a one-way hierarchical tree is explained as follows.

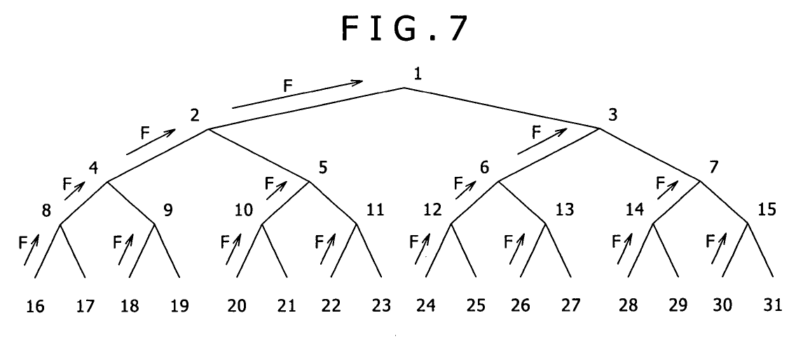

A one-way hierarchical tree is a complete 2-branch tree including N leaves like one shown in FIG. 7. In the one-way hierarchical tree, a node number of 1 is assigned to the node serving as the root on the highest-level hierarchical layer. Node numbers of 2, 3, . . . , and 2N−1 are assigned to nodes on the lower-level hierarchical layers in a breadth first order starting with the hierarchical layer directly below the root and starting with the left-most node on each of the lower-level hierarchical layers. Let xᵢ be a value for a node with a node number i where i=1, 2, . . . , and (2N−1). The value xᵢ has a size of C bits where C is typically 128 bits. In this case, the one-way hierarchical tree is a tree in which the equation xᵢ=F(x₂ᵢ) holds true for i=1, 2, . . . , and 2N−1. The value xᵢ for the node i where i=1, 2, . . . , and 2N−1 is a node key assigned to the node i.

In this case, the function F is a one-way function having an input of C bits and an output of C bits.

Examples of the function F are MD4, MD5 and SHA-1. The MD4 and MD5 functions each have an input with any arbitrary length and an output of 128 bits. On the other hand, the SHA-1 function has an input with any arbitrary length and an output of 160 bits. Thus, the MD4, MD5 and SHA-1 can be applied to the 2-branch one-way hierarchical tree defined above. It is to be noted that these typical functions are described in references such as “Handbook of Applied Cryptography” authored by A. J. Menezes, P. C. van Oorschot and S. A. Vanstone and published by CRC Pres in the year of 1966. It is also worth noting that these typical functions are also each referred to as a one-way function or a hash function.

A relation between the function F set for the node i of a 2-branch one-way hierarchical tree and the node-associated value xᵢ for the node i is expressed as a diagram of FIG. 7. In the structure of this 2-branch one-way hierarchical tree, the equation xᵢ=F(x₂ᵢ) holds true for i=1, 2, . . . , and 2N−1.

For example, the following equations hold true.
x₈=F(x₁₆)
x₄=F(x₈)
x₂=F(x₄)
x₁=F(x₂)

As described above, the node-associated value xᵢ for a node i of the 2-branch one-way hierarchical tree satisfies the equation xᵢ=F(x₂ᵢ)

In a 2-branch one-way hierarchical tree having N leaves, a typical algorithm used for constructing the one-way hierarchical tree is explained below. In this algorithm, an input and an output are set as follows.

The input includes N representing the number of leaves of the 2-branch one-way hierarchical tree and the one-way function F having a C-bit output.

The output is (2N−1) values xᵢ, x₂, . . . , and x_{2N-1} each having a length of C bits for all (2N−1) nodes composing the 2-branch one-way hierarchical tree. In this case, the (2N−1) nodes include leaves of the 2-branch one-way hierarchical tree.

The algorithm for finding the output described above on the basis of the input described above is described as follows.
1: Select N numbers x_{N}, x_{N+1} . . . and x_{2N-1}, which are independent of each other and each have a length of C bits.
2: Use a variable i as a counter. While decrementing the variable i by 1 from (2N−1) to 1, carry out the following processing.
2-1: If the variable i is even, compute F(xᵢ) by applying the function F to the value xᵢ and set the result of the computation in a C-bit value x_{i/2}.
3: Output (2N−1) C-bit values x₁, x₂ . . . , and x_{2N-1} and finish the processing.

The numbers xᵢ are each a number assigned to one of nodes i composing the 2-branch one-way hierarchical tree or the node-associated value mentioned before. Pay attention to the fact that the number of nodes composing a complete 2-brance one-way hierarchical tree having N leaves is 2N−1.

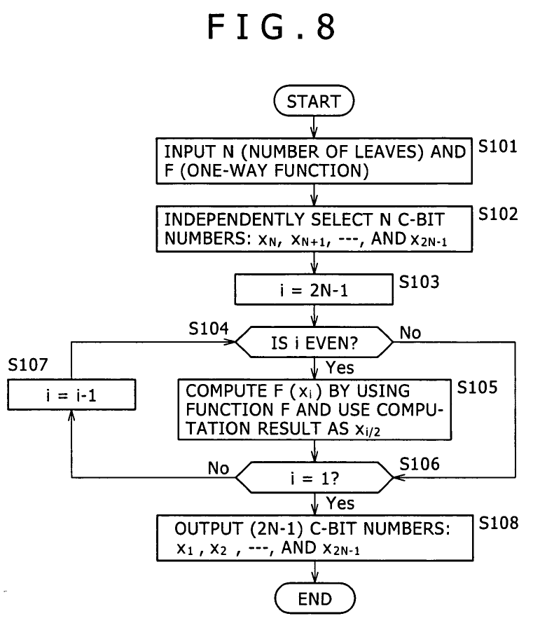

FIG. 8 shows a flowchart representing the algorithm described above. Each of steps composing the flowchart is explained as follows. As shown in the figure, the flowchart begins with a step S101 at which N representing the number of leaves of the 2-branch one-way hierarchical tree and the one-way function F having a C-bit output are entered.

Then, at the next step S102, N numbers x_{N}, x_{N+1} . . . , and x_{2N-1}, which are independent of each other and each have a length of C bits, are selected. Subsequently, at the next step S103, a variable i is initialized. To put it concretely, the variable i is set at an initial value of (2N−1). In the flowchart, this initialization is expressed as i=2N−1.

Then, at the next step S104, the value of the variable i is examined to determine whether or not the variable i is even. If the variable i is even, the flow of the algorithm goes on to a step S105. If the variable i is odd, on the other hand, the flow of the algorithm goes on to a step S106.

As described above, if the variable i is even, the flow of the algorithm goes on to the step S105 at which the value of F(xᵢ) is computed by applying the function F to the value xᵢ and the result of the computation is set in a C-bit value x_{i/2}.

Then, at the next step S106, the value of the variable i is examined to determine whether or not the variable i is equal to 1, that is, whether or not equation i=1 holds true. If equation i=1 does not hold true, the flow of the algorithm goes on to a step S107 at which the variable i is decremented by 1 in an update process i=i−1. Then, the flow of the algorithm goes back to the step S106 by way of the steps S104 and S105 to repeat the processing of the steps S104, S105 and S106.

If the determination result obtained at the step S106 reveals that equation i=1 holds true, on the other hand, the flow of the algorithm goes on to a step S108 at which the (2N−1) C-bit values xᵢ, x₂ . . . , and x_{2N-1} are output as a node-associated value xᵢ assigned to a node i where i=1 to (2N−1).

The (2N−1) C-bit values xᵢ, x₂ . . . , and x_{2N-1} are each used as a node key assigned to a node i where i=1 to (2N−1). Thus, the number of nodes including leaves is also 2N−1.

In the processing based on the above algorithm, node-associated values xᵢ for nodes i composing the 2-branch one-way hierarchical tree are determined. The node-associated values xᵢ are each used as a node key to complete the tree structure shown in FIG. 7. That is to say, the result of the processing is a tree structure comprising a node i with a node key xᵢ satisfying the equation xᵢ=F(x₂ᵢ) where i=1 to (2N−1).

In the typical processing to set the 2-branch one-way hierarchical tree described above, the one-way function F is applied to a node key assigned to a node on a lower-level hierarchical layer to compute a node key assigned to a node existing at a position on a higher-level hierarchical layer as a node shifted in a right-upward direction from the node on the lower-level hierarchical layer as shown in FIG. 7. It is to be noted, however, that the processing to set the 2-branch one-way hierarchical tree described above can also be implemented in a configuration wherein the one-way function F is applied to a node key assigned to a node on a lower-level hierarchical layer to compute a node key assigned to a node existing at a position on a higher-level hierarchical layer as a node shifted in a left-upward direction node on the lower-level hierarchical layer.

3: Processing to Distribute Cryptograms by Applying a One-Way Hierarchical Tree

The following description explains a process to distribute cryptograms to receivers on the basis of the structure of a 2-branch one-way hierarchical tree comprising nodes i each having a node key xᵢ found by carrying out the processing described above. It is to be noted that he process to distribute cryptograms to receivers is explained in sections arranged in the following order.
(1): Setup processing
(2): Information distribution processing
(3): Processing to receive and decrypt information
   (1): Setup Processing

The setup processing is carried out only once when the distribution encryption system is activated. Thereafter, the information distribution processing as well as the processing to receive and decrypt information are carried out every time information to be transmitted is generated. The information distribution processing as well as the processing to receive and decrypt information are carried out for example every time information-recording mediums such as DVDs each used for recording a new content are distributed to receivers or new information is distributed to receivers by way of a network. It is to be noted that the TC (trusted center) independent of an entity for carrying out the information distribution processing may perform the setup processing. As an alternative, the entity for carrying out the information distribution processing may perform the setup processing. As an example, the setup processing carried out by the TC (trusted center) is explained.

1-1: Step 1

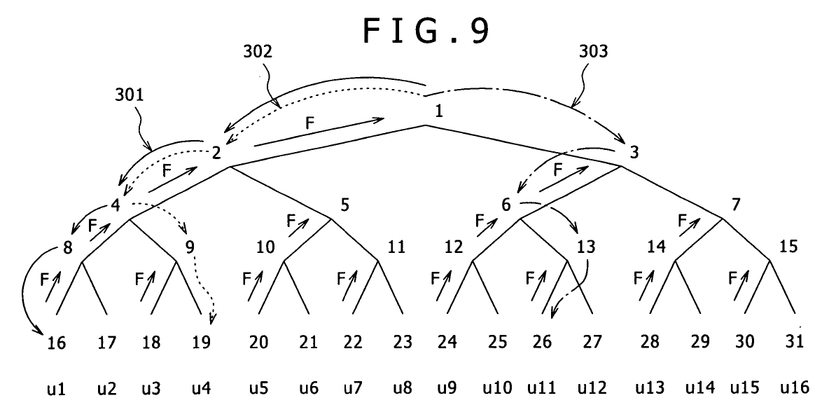

The TC (trusted center) defines a 2-branch one-way hierarchical tree having N leaves. A node number k where k=1, 2, . . . , and (2N−1) is assigned to each of nodes composing the 2-branch one-way hierarchical tree. In this case, however, a node number of 1 is assigned to a node located on the highest-level hierarchical layer of the 2-branch one-way hierarchical tree as a node to serve as the root of the tree. Node numbers of 2, 3 . . . , and (2N−1) are assigned to nodes on the lower-level hierarchical layers of the 2-branch one-way hierarchical tree in the breadth first order described earlier. The result of the assignment of the node numbers is shown in FIG. 9. As shown in the figure, the node number of 1, 2, . . . , and (2N−1) are assigned to the nodes composing the 2-branch one-way hierarchical tree.

Receivers um where m=1, 2, . . . , and N are associated with the leaves of the 2-branch one-way hierarchical tree. In addition, a one-way function F having an output of C bits is selected and revealed. In this case, C is any arbitrary number. An existing hash function can be used as the one-way function. Examples of the existing hash function are MD4, MD5 and SHA-1.

1-2: Step 2

The TC (trusted center) computes node-associated values xᵢ of nodes i composing a 2-branch one-way hierarchical tree with N leaves in accordance with the algorithm explained earlier by referring to the flowchart shown in FIG. 8. Then, the TC (trusted center) creates the 2-branch one-way hierarchical tree as a tree in which the computed node keys xᵢ are used as node keys assigned to the nodes i. In the process to create the 2-branch one-way hierarchical tree, the following inputs are used.
(a): N representing the number of leaves included in the 2-branch one-way hierarchical tree and
(b): the one-way function F having an output of C bits.

The result of the process to create the 2-branch one-way hierarchical tree is (2N−1) C-bit values xᵢ, x₂ . . . , and x_{2N-1} for all the nodes including the leaves in the 2-branch one-way hierarchical tree.

The TC (trusted center) takes the (2N−1) C-bit values xᵢ, x₂ . . . , and x_{2N-1} obtained as the result of the process to create the 2-branch one-way hierarchical tree in accordance with the algorithm explained earlier by referring to the flowchart shown in FIG. 8 as node keys NKᵢ assigned to the nodes i composing the tree created at step 1.

In the 2-branch one-way hierarchical tree shown in FIG. 9, straight-line arrows each shown along a one-way function F each indicate a direction from a node on a lower-level hierarchical layer to a node on a higher-level hierarchical layer, and the one-way function F is applied to a node key xᵢ assigned to the node on the lower-level hierarchical layer to compute a node key x_{i/2} assigned to the node on the higher-level hierarchical layer.

For example, for i=16, 8, 4 and 2, the one-way function F is applied to a node key xᵢ assigned to the node on the lower-level hierarchical layer to compute a node key x_{i/2} assigned to the node on the higher-level hierarchical layer as follows:
x₈=F(x₁₆)
x₄=F(x₈)
x₂=F(x₄)
x₁=F(x₂)

1-3: Step 3

The TC (trusted center) assigns node numbers to receivers um where m=1, 2, . . . , and N associated with leaves each serving as a terminal node of the 2-branch one-way hierarchical tree on the basis of the following rule. To put it concretely, as shown in FIG. 9, node numbers of 16 to 31 are assigned to the leaves of the 2-branch one-way hierarchical tree. In the 2-branch one-way hierarchical tree shown in FIG. 9, 16 receivers u1 to u16 are associated with nodes to which the node numbers of 16 to 31 are assigned respectively.

It is to be noted that notation path-m for a receiver um denotes a path from a leaf associated with the receiver um to the root and notation PathNodes-m denotes a set of nodes on path-m.

Examples of node sets PathNodes-m included in the 2-branch one-way hierarchical tree shown in FIG. 9 are given as follows:

PathNodes-1={1, 2, 4, 8, 16}

PathNodes-4={1, 2, 4, 9, 19}

PathNodes-11={1, 3, 6. 13, 26}

Solid lines 301 shown in FIG. 9 indicate path-1 of the receiver u1 and PathNodes-1={1, 2, 4, 8, 16} on path-1. Dashed lines 302 indicate path-4 of the receiver u4 and PathNodes-4={1, 2, 4, 9, 19} on path-4. Dotted lines 303 indicate path-11 of the receiver u11 and PathNodes-11={1, 3, 6, 13, 26} on path-4.

To each of receivers um associated with PathNodes-m, the TC (trusted center) gives node keys NKᵢ of nodes i that satisfy conditions (a) and (b) described as follows:
(a): Nodes i shall be included in PathNodes-m.
(b): Nodes 2i shall not be included in PathNodes-m.

The receiver um then stores the given node keys NKᵢ in a safe manner.

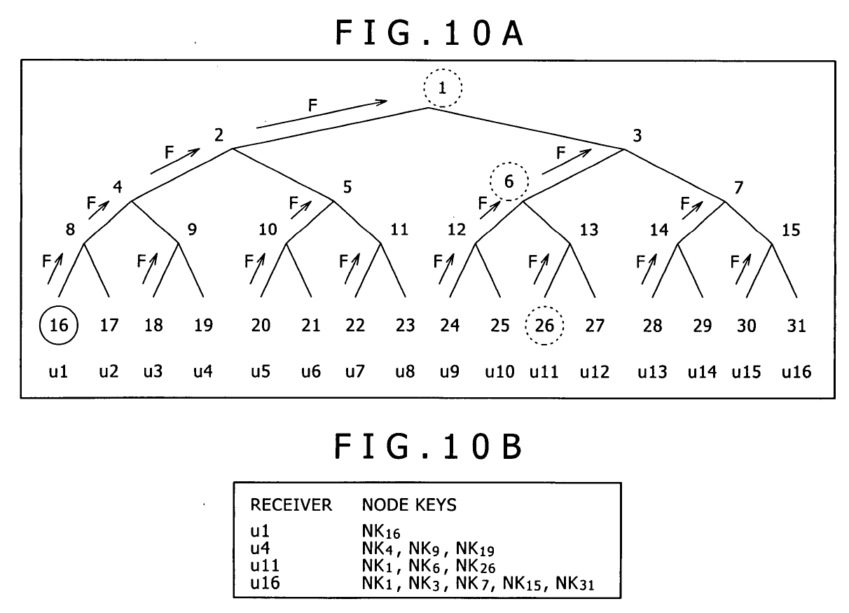

As shown in FIG. 10B, as an example, node keys NKᵢ are given to receivers as follows.

The node key NK₁₆ is given to the receiver u1.

The node keys NK₄, NK₉ and NK₁₉ are given to the receiver u4.

The node keys NK₁, NK₆ and NK₂₆ are given to the receiver u11.

The node keys NK₁, NK₃, NK₇, NK₁₅ and NK₃₁ are given to the receiver u16.

As an example, the reason why only the node key NK₁₆ is given to the receiver u1 is explained as follows.
(a): Nodes i shall be included in PathNodes-m.

Nodes i satisfying condition (a) for m=1 are nodes included in PathNodes-1, that is, nodes with node numbers included in {1, 2, 4, 8, 16}.
(b): Nodes 2i shall not be included in PathNodes-m where m=1.

Condition (b) indicates that, for the node number of 16, the node 32 (=2×16) is not included in PathNodes-4={1, 2, 4, 8, 16}. However,
for the node number of 1, the node 2 (=2×1) is included in PathNodes-1={1, 2, 4, 8, 16},
for the node number of 2, the node 4 (=2×2) is included in PathNodes-1={1, 2, 4, 8, 16},
for the node number of 4, the node 8 (=2×4) is included in PathNodes-1={1, 2, 4, 8, 16} and
for the node number of 8, the node 16 (=2×8) is included in PathNodes-1={1, 2, 4, 8, 16}.

Thus, the nodes with node numbers of 1, 2, 4 and 8 are disqualified. As a result, only the node 16 is qualified.

In other words, for the receiver u1 or m=1, only the node 16 satisfies the following conditions:
(a): Nodes i shall be included in PathNodes-m.
(b): Nodes 2i shall not be included in PathNodes-m.

Thus, only the node key NK₁₆ of the node 16 satisfying conditions (a) and (b) is given to the receiver u4.

As another example, the reason why the node keys NK₄, NK₉ and NK₁₉ are given to the receiver u4 is explained as follows.
(a): Nodes i shall be included in PathNodes-m.

Nodes i satisfying condition (a) for m=4 are nodes included in PathNodes-4, that is, nodes with node numbers included in {1, 2, 4, 9, 19}.
(b): Nodes 2i shall not be included in PathNodes-m.

Condition (b) indicates that, for node numbers of 4, 9 and 19, the nodes 8 (=2×4), 18 (=2×9) and 38 (=2×19) respectively are not included in PathNodes-4={1, 2, 4, 9, 19}. However, for the node number of 1, the node 2 (=2×1) is included in PathNodes-4={1, 2, 4, 9, 19}, and for the node number of 2, the node 4 (=2×2) is included in PathNodes-4={1, 2, 4, 9, 19}.

Thus, the nodes with node numbers of 1 and 2 are disqualified. As a result, only the nodes 4, 9 and 19 are qualified.

In other words, for the receiver u4 or m=4, only the nodes 4, 9 and 19 satisfy the following conditions:
(a): Nodes i shall be included in PathNodes-m.
(b): Nodes 2i shall not be included in PathNodes-m.

Thus, only the node keys NK₄, NK₉ and NK₁₉ of the nodes 4, 9 and 19 satisfying conditions (a) and (b) are given to the receiver u4.

In the same way, the remaining receivers um each associated with a leaf each receive only node keys of nodes satisfying following same conditions:
(a): Nodes i shall be included in PathNodes-m.
(b): Nodes 2i shall not be included in PathNodes-m.

That is to say, only node keys of nodes satisfying conditions (a) and (b) are given to each of the remaining receivers.

The process to give node keys to every receiver um associated with a leaf of a 2-branch one-way hierarchical tree is explained again by referring to the 2-branch one-way hierarchical tree shown in FIG. 10A. The node key of a leaf serving as a terminal node associated with a receiver is always given to the receiver. Then, if a path from the leaf to the root is traced upward by 1 level, the tracing can be carried out in the left-upward or right-upward direction. If the tracing toward a node on a hierarchical layer on the next higher level is carried out in the left-upward direction, the node key of the node is also given to the receiver um.

In the 2-branch one-way hierarchical tree shown in FIG. 10A, if path-1 of the receiver u1 is traced upward from the leaf associated with the receiver u1 to the root shown as the node 1 in the figure, the tracing will be carried out in the right-upward direction throughout all layers. Thus, only the node key NK₁₆ of the node 16 associated with the receiver u1 is given to the receiver u1 as explained above.

As for path-11 of the receiver u11 associated with the node 26, the tracing upward to the root is carried out as follows:

Node 26→node 13 is an upward tracing in the right direction.

Node 13→node 6 is an upward tracing in the left direction.

Node 6→node 3 is an upward tracing in the right direction.

Node 8→node 1 is an upward tracing in the right direction.

As is obvious from the above tracings, only the nodes 6 and 1 each end an upward tracing in the left direction. Thus, only node keys NK₆ and NK₁ of the nodes 6 and 1 respectively are given to the receiver u11 in addition to the node key NK₂₆ of the node 26, as described earlier. In the following description, the node associated with a receiver is also referred to as the self node of the receiver. In the case of the receiver u11, the node 26 is the self node and, in the case of the receiver u1, on the other hand, the node u16 is the self node.

As is obvious from the above description, the number of node keys given to a receiver um varies in dependence on the number of left-upward tracings in path-m of the receiver um. The number of nodes located at the end of a upward movement is log N where N is the number of leaves but not all such nodes are located at the end of a left-upward movement. Consider path-m of a receiver um of a complete 2-branch one-way hierarchical tree having N leaves. A bit expression of path-m can be represented by a bit string {0, 1}^{log N}. The bit string {0, 1}^{log N} is a string of bits of ‘0’ and ‘1’ where log N is the number bits in the string. Bits 0 and 1 represent an upward tracing in the right direction and an upward tracing in the left direction respectively. For N=16, the number of bits in the string of bits is 4 (=log N). Thus, path-m can be expressed by bit strings ranging from ‘0000’ to ‘1111’.

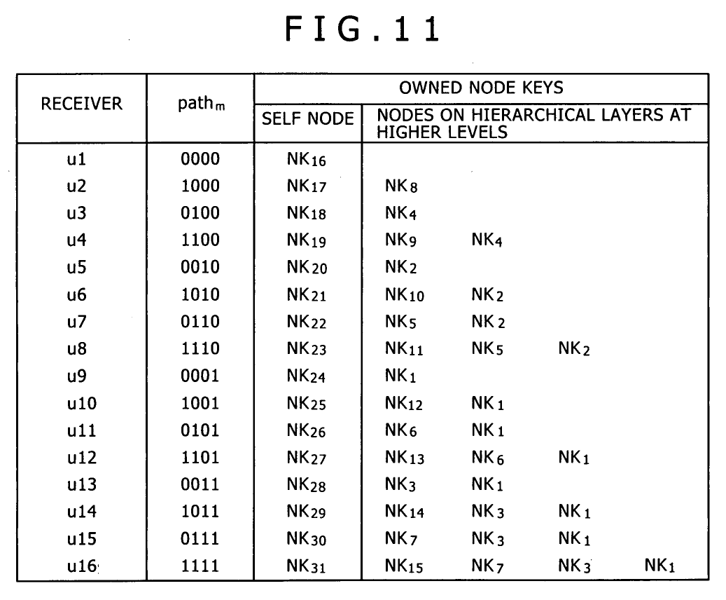

As an example, bit expressions each representing path-m for each of the 16 receivers u1 to u16 shown in FIG. 10 are shown in FIG. 11.

For example, path-1 from the receiver u1 to the root is expressed as ‘0000’ because of the following reasoning. Refer back to FIG. 10. As shown in the figure, path-1 from the receiver u1 to the root consists of 4 right-upward paths, i.e., a path 16→8, a path 8→4, a path 4→2 and a path 2→1. If a right-upward path is expressed by a 0 bit, path-1 from the receiver u1 to the root is thus expressed by ‘0000’.

As another example, path-2 from the receiver u2 to the root is expressed as ‘1000’ because of the following reasoning. Refer back to FIG. 10. As shown in the figure, path-2 from the receiver u2 to the root consists of 1 left-upward path , i.e. a path 17→8 and 3 right-upward paths, i.e., a path 8→4, a path 4→2 and a path 2→1. If a left-upward path is expressed by a 1 bit, path-2 from the receiver u2 to the root is thus expressed by ‘1000’.

The remaining paths, that is, path-m where m=3 to 16, of the receivers 3 to 16 shown in FIG. 10 can each be expressed by a string of bits in the same way.

FIG. 11 is a diagram showing a relation between the bit expressions of paths m for the 16 receivers u1 to u16 shown in FIG. 10 and node keys held by the receivers u1 to u16. As shown in FIG. 11, the bit expressions of paths m for the 16 receivers u1 to u16 are expressed by respectively 16 bit strings in the range 0000 to 1111.

A weight of path-m is defined as a 1 bit included in the bit string expressing path-m.

In the configuration of the present invention, in addition to the node key of the self node, the number of node keys given to a receiver is determined by the number of weights of path-m of the receiver, that is, the number of 1 bits included in the bit string expressing path-m. The node key of the self node is also referred to as a leaf key.

Given the configuration of the 2-branch one-way hierarchical tree shown in FIG. 10A, for example, in the configuration of expressing path-m of every receiver um as shown in FIG. 11 by a bit string, the receiver u1 with its path-1 expressed by a bit string of all 0s is provided with only the leaf key, which is the node key of the self node, and not provided with node keys of other nodes.

A receiver um with its path-m expressed by a bit string including only a 1 bit is provided with the node key of the self node and the node key of a node on the hierarchical layer at a higher level. The number of receivers um each provided with the node key of the self node and the node key of a node on the hierarchical layer at a higher level is log N. In the 2-branch one-way hierarchical tree shown in FIG. 10A, the receivers u2, u3, u5 and u9 are each a receiver with its path-m expressed by a bit string including only a 1 bit. For example, the receiver u2 is provide the hierarchical layers at higher levels with the node key NK₁₇ of the self node 17 and the node key NK₈ of the node 8 on the hierarchical layer at a higher level.

In general, a receiver is provided with the node key of the self node and j node keys of nodes on the hierarchical layers at higher levels where j=0, 1, . . . , and log N. The number of receivers each provided with the node key of the self node and j node keys of nodes on the hierarchical layers at higher levels is determined by Eq. 1 as follows.

$$( \begin{matrix}log N \\ j\end{matrix} ) \qquad ( 1 )$$

It is to be noted that the above equation is an equation representing a number as a function of j where j=0, 1, . . . , and log N.

To put it concretely, consider the 2-branch one-way hierarchical tree shown in FIG. 10A for which N=16. In this case, as described above, every receiver um is provided with its leaf key and the node keys of j nodes on the hierarchical layers at higher levels where j has a value in the range 0 to 4 (=log16).

For j=0, only the leaf key is given to the receiver um.

For j=1, in addition to the leaf key, the node key of 1 node on the hierarchical layer at a higher level is provided to the receiver. In this case, 4 receivers, i.e., the receivers u2, u3, u5 and u9, are each provided with its leaf key and the node key of 1 node on the hierarchical layer at a higher level.

For j=2, in addition to the leaf key, the node keys of 2 nodes on the hierarchical layers at higher levels are provided to the receiver. In this case, 6 receivers, i.e., the receivers u4, u6, u7, u10, u11 and u13, are each provided with its leaf key and the node keys of 2 nodes on the hierarchical layers at higher levels.

For j=3, in addition to the leaf key, the node keys of 3 nodes on the hierarchical layers at higher levels are provided to the receiver. In this case, 4 receivers, i.e., the receivers u8, u12, u14 and u15, are each provided with its leaf key and the node keys of 3 nodes on the hierarchical layers at higher levels.

For j=4, in addition to the leaf key, the node keys of 4 nodes on the hierarchical layers at higher levels are provided to the receiver. In this case, the only receiver u16 is provided with its leaf key and the node keys of 4 nodes on the hierarchical layers at higher levels.

It is to be noted that a receiver not provided with the node key of any node on a hierarchical layer at a higher level still holds its leaf key, which is the node key of a node associated with the receiver itself. This receiver is the receiver u1 corresponding to j=0 described above.

As described above, in the configuration for setting node keys for every node in accordance with the present invention, every receiver is provided with its leaf key, which is the node key of a node associated with the receiver itself, and j node keys of nodes on the hierarchical layers at higher levels. Thus, every receiver holds (j+1) node keys where j is the number of nodes i satisfying conditions (a) and (b) described above but not including the leave itself. Since the number of nodes existing on path-m but not including the leave itself is log N, j has a value in the range 0 to log N, inclusive.

As described earlier, in accordance with the CS (complete sub-tree) method, the number of node keys given to every receiver is log N+1 where symbol N denotes the number of receivers. In accordance with this method, on the other hand, the number of node keys given to every receiver is j+1.

Thus, {(log N+1)−(j+1)}=(log N−j) node keys can be eliminated from those used to be held by a receiver.

An eliminated node key from those traditionally stored in a receiver can be obtained by applying the one-way function F to a node key held by the receiver.

By the way, pay attention to the following equation:

$$( \begin{matrix}log N \\ j\end{matrix} ) = ( \begin{matrix}log N \\ log N - j\end{matrix} ) \qquad ( 2 )$$

That is to say, in a 2-branch one-way hierarchical tree with N receivers, the number of receivers for which j node keys can be eliminated is expressed by the following equation:

$$( \begin{matrix}log N \\ j\end{matrix} ) \qquad ( 3 )$$

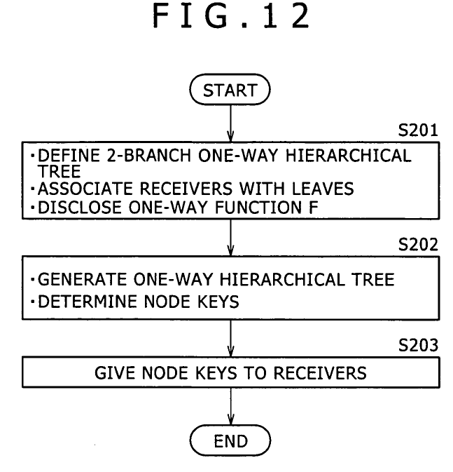

FIG. 12 shows a flowchart representing the setup processing described above. Steps of the flowchart shown in FIG. 12 are explained as follow.

As shown in the figure, the flowchart begins with a step S201 at which the TC (trusted center) defines a 2-branch one-way hierarchical tree having N leaves. A node number of 1 is assigned to the node on the hierarchical layer at the highest level to serve as the root of the 2-branch one-way hierarchical tree. Node numbers of 2, 3 . . . , and (2N−1) are assigned to nodes on the lower-level hierarchical layers of the 2-branch one-way hierarchical tree in the breadth first order described earlier. The result of the assignment of the node numbers is shown in FIG. 10A.

Then, the TC (trusted center) associates each of receivers um where m=1, 2, . . . , and N with one of the leaves of the 2-branch one-way hierarchical tree. In addition, the TC (trusted center) selects and reveals a one-way function F having an output of C bits. In this case, C is any arbitrary number. An existing hash function can be used as the one-way function F. Examples of the existing hash function are MD4, MD5 and SHA-1.

Then, at the next step S202, the TC (trusted center) computes node-associated values xᵢ of nodes i composing the 2-branch one-way hierarchical tree with N leaves in accordance with the algorithm explained earlier by referring to the flowchart shown in FIG. 8. Then, the TC (trusted center) creates the 2-branch one-way hierarchical tree as a tree in which the computed node keys xᵢ are each used as a node key assigned to a node i. In the process to create the 2-branch one-way hierarchical tree, the following inputs are used.
(a): N representing the number of leaves included in the 2-branch one-way hierarchical tree and
(b): the one-way function F having an output of C bits.

The result of the process to create the 2-branch one-way hierarchical tree is (2N−1) C-bit values x₁, x₂ . . . , and x_{2N-1} for all the nodes including the leaves in the 2-branch one-way hierarchical tree.

The TC (trusted center) takes the (2N−1) C-bit values x₁, x₂ . . . , and x_{2N-1} obtained as the result of the process to create the 2-branch one-way hierarchical tree as node keys NKᵢ each assigned to one of the nodes i composing the tree defined at the step S201.

Then, at the next step S203, TC (trusted center) assigns node numbers to receivers um where m=1, 2, . . . , and N associated with leaves each serving as a terminal node of the 2-branch one-way hierarchical tree on the basis of the following rule. To put it concretely, the TC (trusted center) provides each of receivers um node with keys NKᵢ of nodes i that satisfy conditions (a) and (b) described as follows:
(a): Nodes i shall be included in PathNodes-m of the receiver um.
(b): Nodes 2i shall not be included in same PathNodes-m.

As a result of the processing described above, every receiver is provided with (j+1) key nodes where j has a value in the range 0 to log N and N is the number of leaves.

(2): Information Distribution Processing

The TC (trusted center) distributes information or, strictly speaking, secret information, by transmitting one or more cryptograms by adoption of a broadcasting technique. Each of the cryptograms is obtained as a result of a process to encrypt the secret information by using a node key. A node key used in the encryption process is selected in accordance with the same method as the CS (complete sub-tree) method.

In the typical 2-branch one-way hierarchical tree shown in FIG. 5, for example, 5 cryptograms are transmitted. In the typical 2-branch one-way hierarchical tree shown in FIG. 5, the receivers u2, u11 and u12 are revoked receivers. That is to say, the receivers u2, u11 and u12 have each been revoked and treated like an invalid receiver. Thus, only the other receivers should be capable of receiving the secret information in a safe manner and hence capable of carrying out a decryption process based on the cryptograms transmitted by the TC (trusted center) by adoption of the broadcasting technique.

Prior to transmission of secret information, the information is encrypted by avoiding use of node keys assigned to nodes on paths from leaves associated with the revoked receivers u2, u11 and u12 to the root as encryption keys. If the nodes on paths from leaves associated with the revoked receivers u2, u11 and u12 to the root and the paths themselves are excluded from the 2-branch one-way hierarchical tree, one or more partial trees will be left in the remaining tree. For example, a partial tree having the node 5 at its vertex and a partial tree having the node 12 at its vertex are left in the remaining tree.

The TC (trusted center) serving as the transmitter of secret information encrypts the secret information by using node keys assigned to nodes closest to the vertexes of the remaining partial trees and transmits the encrypted secret information as a set of cryptograms to receivers. In the example shown in FIG. 5, the nodes closest to the vertexes of the remaining partial trees are nodes 5, 7, 9, 12 and 16. Assume for example that the secret information is a content key K_{c} to be used in a process to decrypt an encrypted content. In this case, the TC (trusted center) serving as the transmitter of secret information generates a set of cryptograms and provides the set of cryptograms to the receivers by distribution through a network or by storing the set of cryptograms in a recording medium. In the example, the set of cryptograms is represented by the following expression: E (NK₅, K_{c}) E (NK₇, K_{c}) E (NK₉, K_{c}) E (NK₁₂, K_{c}) E (NK₁₆, K_{c}) where symbols NK₅, NK₇, NK₉, NK₁₂ and NK₁₆ denote the node keys assigned to the nodes 5, 7, 9, 12 and 16 respectively. It is to be noted that, as described before, notation E (A, B) represents encrypted data obtained as a result of a process to encrypt data B by using a key A.

Only the revoked receivers u2, u11 and u11 are receivers incapable of decrypting the set of cryptograms, but the remaining receivers are capable of decrypting one of the cryptograms included in the set. By generating such a set of cryptograms and distributing it, efficient and well protected secret information can be transmitted.

As a technique for determining node keys to be used in the encryption process, it is possible to adopt a method similar to the CS (complete sub-tree) method or a technique of applying an expression tree.

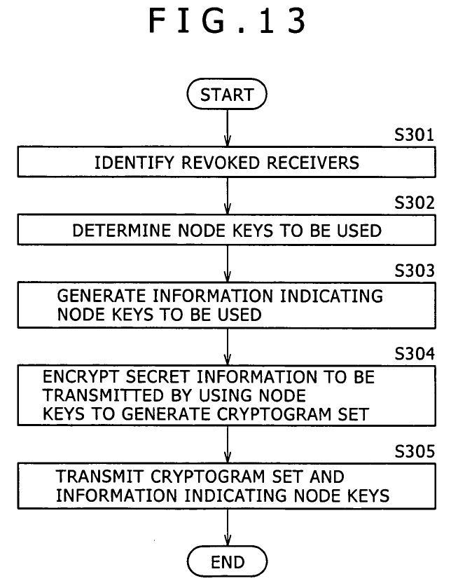

The procedure of the information distribution processing is explained by referring to a flowchart shown in FIG. 13. As shown in the figure, the flowchart begins with a step S301 at which the TC (trusted center) identifies revoked receivers in the information distribution processing.

Then, at the next step S302, the TC (trusted center) selects node keys to be used in a process to encrypt secret information, which is to be transmitted, in order to generate cryptograms. Subsequently, at the next step S303, the TC (trusted center) generates information suggesting node keys used in the process to encrypt secret information. This generated information will be used in receivers receiving a set of cryptograms as index data to select a particular cryptogram that can be decrypted by a particular receiver. The information suggesting node keys used in the process to encrypt secret information is typically tag information or expression codes. The tag information or expression codes indicate which node keys have been selected as node keys used in the process to encrypt secret information.

Then, at the next step S304, the TC (trusted center) encrypts the secret information, which is to be transmitted, by using the selected node keys. Subsequently, at the next step S305, the TC (trusted center) transmits a set of cryptograms obtained as a result of the process to encrypt the secret information along with the information hinting node keys used in the process through a broadcasting transmission channel. As an alternative, the TC (trusted center) distributes the set of cryptograms and the information by recording them on a recording medium. It is to be noted that the processing to distribute information is not necessarily carried out in the order described above.

It is also worth noting that, as the node keys to be used in a process to encrypt secret information, the TC (trusted center) may also select those computed and saved at the setup phase. As an alternative, only node keys of leaves are saved in the setup phase and node keys of nodes on hierarchical layers at higher levels are found by applying the one-way function F to the node keys of leaves.

It is to be noted that, if no receivers have been revoked, the node key NK₁ assigned to the root is used to encrypt the secret information. In this case, all receivers are capable of decrypting a cryptogram obtained as a result of the process to encrypt the secret information.

(3): Processing to Receive and Decrypt Information

Next, processing to receive and decrypt information is explained. The cryptograms described above are provided to receivers by transmission adopting the broadcasting method. As an alternative, the cryptograms are provided to receivers by storing the cryptograms on an information-recording medium. The cryptograms can be received by all receivers without regard to whether or not the receivers have been revoked. Since a revoked receiver does not hold node keys for decrypting the cryptograms, however, the revoked receiver is not capable of carrying out a decryption process to obtain the secret information.

An unrevoked receiver selects a cryptogram, which can be decrypted by itself, from the received set of cryptograms. This is because the node keys used for encrypting the cryptograms included in the received set include a leaf key held by the receiver or a higher level node key that can be found by applying the one-way function F to the leaf key.

The unrevoked receiver is thus capable of obtaining the secret information by decrypting the selected cryptogram by using the leaf key or the node key of a higher level node. The receiver selects a cryptogram, which can be decrypted by itself, by referring to the information suggesting node keys used in the encryption of the cryptograms.

In processing to extract a cryptogram, the receiver um extracts node numbers of node keys used in the process to encrypt the cryptograms from the information suggesting node keys, and collates the extracted node numbers with node numbers included in PathNodes-m of the receiver um to recognize a matching node number i. The information suggesting node keys shows node numbers of nodes, the node keys of which were used for encrypting the secret information to generate the cryptograms transmitted along with the information.

Then, the receiver um determines such a smallest k that the node number of 2^{k}i is included in PathNodes-m but the node number of 2^{k+1}i is not where i is the value of the recognized matching node number. This is because the receiver um holds the node key NK₂_{^{k}}ᵢ included in PathNodes-m as the node key of a node on a layer closest to the node having the matching node number i. By applying the one-way function F to the node key NK₂_{^{k}}ᵢ repeatedly k times, the receiver um is capable of finding the node key NKᵢ used as an encryption key in the process to encrypt the secret information to produce the cryptogram. Thus, the node key NKᵢ can be used as a decryption key for decrypting the cryptogram. It is to be noted that, if the smallest k is determined to be 0, the receiver um holds the node key NKᵢ (=NK₂_{⁰}ᵢ) itself.

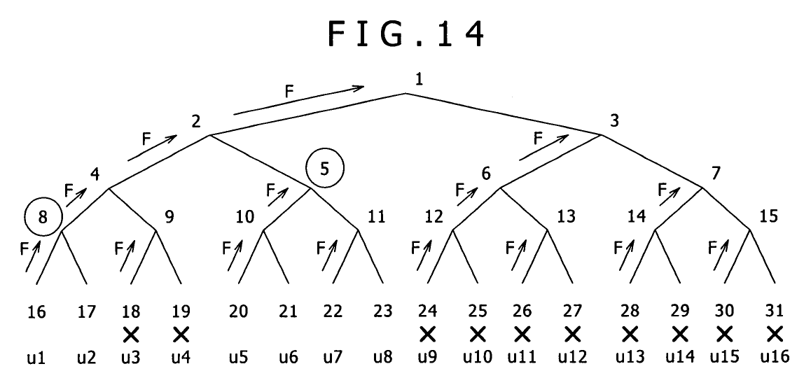

A concrete example is explained by referring to FIG. 14. As shown in FIG. 14, receivers u3, u4 and u9 to u16 have been revoked. Thus, only receivers u1, u2 and u5 to u8 are capable of decrypting a received cryptogram. Assume that the transmitted secret information is a content key K_{c}, which has been encrypted by using node keys NK₅ and NK₈ to generate the following cryptograms: E (NK₅, K_{c}) and E (NK₈, K_{c}). The cryptograms are distributed to the receivers by way of a network or by recording the cryptograms on a recording medium. It is to be noted that, as described before, notation E (A, B) represents encrypted data obtained as a result of a process to encrypt data B by using a key A.

As an example, operations carried out by the receiver u5 associated with a leaf having a node number of 20 are explained. First of all, the receiver u5 extracts the node numbers of 5 and 8 from the information suggesting node keys, and collates the node numbers of 5 and 8 with node numbers in PathNodes-5={1, 2, 5, 10, 20} of the receiver u5 to identify a matching node number i. A result of the collation reveals that the node number of 5 is detected in PathNodes-5 as a matching node number i.

Next, the receiver u5 determines such a smallest k that the node number of 2^{k}i is included in PathNodes-5={1, 2, 5, 10, 20} but the node number of 2^{k+1}i is not where i is the matching node number of 5. That is to say, for i=5, the receiver u5 determines such a smallest k that the node number of 2^{k}×5 is included in PathNodes-5={1, 2, 5, 10, 20} but the node number of 2^{k+1}×5 is not as follows:
For k=0, 2^{k}×5=2⁰×5=5 and 2^{k+1}×5=2⁰⁺¹×5=10
For k=1, 2^{k}×5=2¹×5=10 and 2^{k+1}×5=2¹⁺¹×5=20
For k=2, 2^{k}×5=2²×5=20 and 2^{k+1}×5=2²⁺¹×5=40

It is obvious that, for k=2, the node number of 20 is included in PathNodes-5={1, 2, 5, 10, 20} but the node number of 40 is not.

Thus, for the receiver u5 and i=5, the integer number of 2 is the smallest k satisfying a condition that the node number of 2^{k}i is included in PathNodes-5={1, 2, 5, 10, 20} but the node number of 2^{k+1}i is not. In this case, the receiver u5 certainly holds the node key NK₂_{^{k}}ᵢ (=NK₂₀ for k=2 and i=5) of its own and, by applying the one-way function F to NK₂₀ repeatedly 2 times, the receiver u5 is capable of acquiring NK₅ used for encrypting the cryptogram. To put it in detail, NK₅ is computed as follows:

NK₁₀=F(NK₂₀)

NK₅=F(NK₁₀)

As described above, the receiver u5 extracts the node numbers of 5 and 8 from the information suggesting node keys, and collates the node numbers of 5 and 8 with node numbers in PathNodes-5={1, 2, 5, 10, 20} of the receiver u5, identifying the node number of 5 as a matching node number i. Thus, the receiver u5 selects the cryptogram E (NK₅, K_{c}) from the set of cryptograms E (NK₅, K_{c}) and E (NK₈, K_{c}) and decrypts the selected cryptogram E (NK₅, K_{c}) by using the node key NK₅ to obtain the secret information, which is the content key K_{c}.

As another example, operations carried out by the receiver u6 associated with a leaf having a node number of 21 are explained. First of all, the receiver u6 extracts the node numbers of 5 and 8 from the information suggesting node keys, and collates the node numbers of 5 and 8 with node numbers in PathNodes-6={1, 2, 5, 10, 21} of the receiver u6 to identify a matching node number i. A result of the collation reveals that the node number of 5 is detected in PathNodes-6 as a matching node number i.

Next, the receiver u6 determines such a smallest k that the node number of 2^{k}i is included in PathNodes-6={1, 2, 5, 10, 21} but the node number of 2^{k+1}i is not where i is the matching node number of 5. That is to say, the receiver u6 determines such a smallest k that the node number of 2^{k}×5 is included in PathNodes-6={1, 2, 5, 10, 21} but the node number of 2^{k+1}×5 is not as follows:
For k=0, 2^{k}×5=2⁰×5=5 and 2^{k+1}×5=2⁰⁺¹×5=10
For k=1, 2^{k}×5=2¹×5=10 and 2^{k+1}×5=2¹⁺¹×5=20

It is obvious that, for k=1, the node number of 10 is included in PathNodes-6={1, 2, 5, 10, 21} but the node number or 20 is not.

Thus, for the receiver u6 and i=5, the integer number of 1 is the smallest k satisfying a condition that the node number of 2^{k}i is included in PathNodes-6={1, 2, 5, 10, 21} but the node number of 2^{k+1}i is not. In this case, the receiver u6 certainly holds the node key NK₂_{^{k}}ᵢ (=NK₁₀ for k=1 and i=5) and, by applying the one-way function F to NK₂₀ once, the receiver u6 is capable of acquiring NK₅ used for encrypting the cryptogram. To put it in detail, NK₅ is computed as follows:

NK₅=F(NK₁₀)

As described above, the receiver u6 extracts the node numbers of 5 and 8 from the information suggesting node keys, and collates the node numbers of 5 and 8 with node numbers in PathNodes-6={1, 2, 5, 10, 21} of the receiver u6, identifying the node number of 5 as a matching node number i. Thus, the receiver u6 selects the cryptogram E (NK₅, K_{c}) from the set of cryptograms E (NK₅, K_{c}) and E (NK₈, K_{c}) and decrypts the selected cryptogram E (NK₅, K_{c}) by using the node key NK₅ to obtain the secret information, which is the content key K_{c}.

As a further example, operations carried out by the receiver u7 associated with a leaf having a node number of 22 are explained. First of all, the receiver u7 extracts the node numbers of 5 and 8 from the information suggesting node keys, and collates the node numbers of 5 and 8 with node numbers in PathNodes-7={1, 2, 5, 11, 22} of the receiver u7 to identify a matching node number i. A result of the collation reveals that the node number of 5 is detected in PathNodes-7 as a matching node number i.

Next, the receiver u7 determines such a smallest k that the node number of 2^{k}i is included in PathNodes-7={1, 2, 5, 11, 22} but the node number of 2^{k+1}i is not where i is the matching node number of 5 That is to say, the receiver u7 determines such a smallest k that the node number of 2^{k}×5 is included in PathNodes-7={1, 2, 5, 11, 22} but the node number of 2^{k+1}×5 is not as follows:
For k=0, 2^{k}×5=(2⁰×5=20 and 2^{k+1}×5=2⁰⁺¹×5=10

It is obvious that, for k=0, the node number of 5 is included in PathNodes-7={1, 2, 5, 11, 22} but the node number of 10 is not.

Thus, for the receiver u7 and i=5, the integer number of 0 is the smallest k satisfying a condition that the node number of 2^{k}i is included in PathNodes-7={1, 2, 5, 11, 22} but the node number of 2^{k+1}i is not. As described above, for k=0, the receiver um certainly holds the node key NKᵢ (=NK₂_{^{k}}ᵢ). Thus, for i=5, the receiver u7 holds NK₅.

As described above, the receiver u7 extracts the node numbers of 5 and 8 from the information suggesting node keys, and collates the node numbers of 5 and 8 with node numbers in PathNodes-7={1, 2, 5, 11, 22} of the receiver u7, identifying the node number of 5 as a matching node number i. Thus, the receiver u7 selects the cryptogram E (NK₅, K_{c}) from the set of cryptograms E (NK₅, K_{c}) and E (NK₈, K_{c}) and decrypts the selected cryptogram E (NK₅, K_{c}) by using the node key NK₅ held therein to obtain the secret information, which is the content key K_{c}.

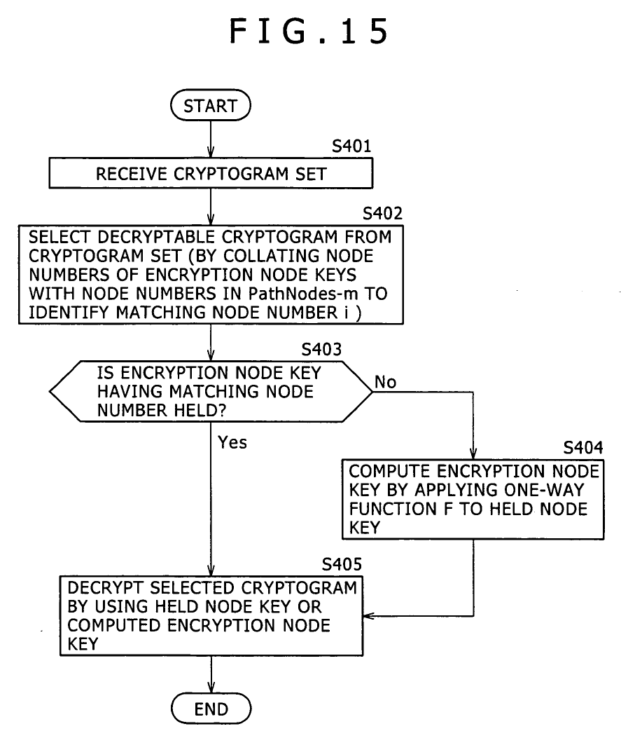

The processing carried out by the receiver um is explained by referring to a flowchart shown in FIG. 15 as follows. As shown in the figure, the flowchart begins with a step S401 at which the receiver um receives a set of cryptograms. The set of cryptograms is distributed to the receiver um by way of a network or by recording the cryptograms on a recording medium.

Then, at the next step S402, the receiver um selects a cryptogram from the received set of cryptograms by collating node numbers described in information received along with the set of cryptograms as information hinting encryption keys with node numbers included in PathNodes-m to recognize a matching node number. The matching node number is the node number of a node having an encryption key used for decrypting the selected cryptogram even though the receiver um itself does not hold the encryption key. If the receiver um itself does not hold the encryption key, the encryption key can be computed by applying the one-way function F to a node key recognized on the basis of the matching node number and PathNodes-m as a node key held by the receiver-um. No matching node number recognized in the collation implies that the receiver um is a revoked receiver.

Then, at the next step S403, the receiver um determines whether or not the receiver um itself holds the encryption key on the basis of the matching node number and PathNodes-m. If the receiver um itself holds the encryption key, the flow of the processing goes on to a step S405 at which the receiver um decrypts the selected cryptogram by using the held encryption key to obtain the secret information, which is a content key in this example.

If the determination result produced at the step S403 reveals that the receiver um itself does not hold the encryption key, on the other hand, the flow of the processing goes on to a step S404 at which the receiver urn computes the encryption key by applying the one-way function F to a node key recognized on the basis of the matching node number and PathNodes-m as a node key held by the receiver um. The encryption key is also a node key used for encrypting the secret information to generate the selected cryptogram. Then, the flow of the processing goes on to the step S405 at which the receiver um decrypts the selected cryptogram by using the computed encryption key to obtain the secret information, which is a content key in this example.

It is to be noted that, at the steps S402 to S405 described above, the receiver um carries out the following operations:
(a): First of all, the receiver um collates node numbers described in information received along with the set of cryptograms as information hinting encryption keys with node numbers included in PathNodes-m to recognize a matching node number i.
(b): Then, the receiver um determines such a smallest k that the node number of 2^{k}i is included in PathNodes-m but the node number of 2^{k+1}i is not where i is the value of the recognized matching node number.
(c): Finally, by applying the one-way function F to the node key of 2^{k}i repeatedly k times, the receiver um finds the node key NKᵢ used as an encryption key in the process to encrypt the secret information to produce the cryptogram. If the smallest k is determined to be 0, the receiver um holds the node key NKᵢ (=NK₂_{⁰}ᵢ) itself.

As described above, in accordance with the present invention, the 2-branch one-way hierarchical tree is set into a configuration in which, if necessary, a receiver applies the one-way function F to a node key held by the receiver itself to compute the node key of a node on a hierarchical layer at a higher level. Thus, the number of node keys to be held by every receiver can be reduced.

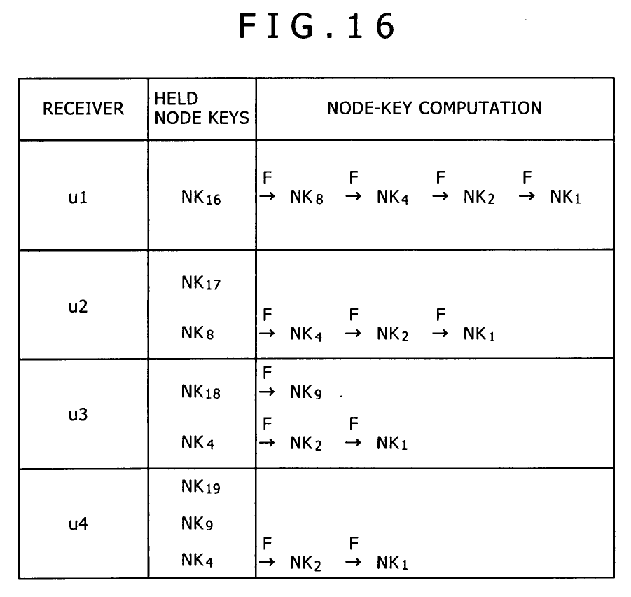

FIG. 16 is a typical table showing node keys held by the receivers u1 to u4 of the 2-branch one-way hierarchical tree shown in FIG. 10A and node keys computable from the held node keys as node keys of nodes on hierarchical layers at a higher levels. In the table of the figure, only the receivers u1 to u4 are shown as samples. However, every receiver um holds a minimum number of node keys that can be used for computing the node keys of all nodes included in PathNodes-m on path-m of its own.

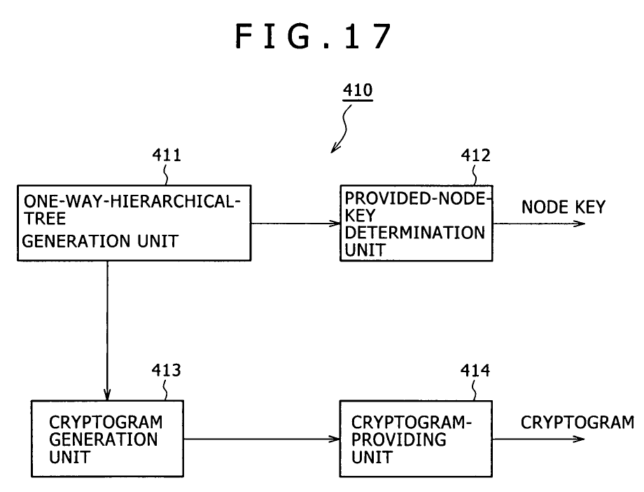

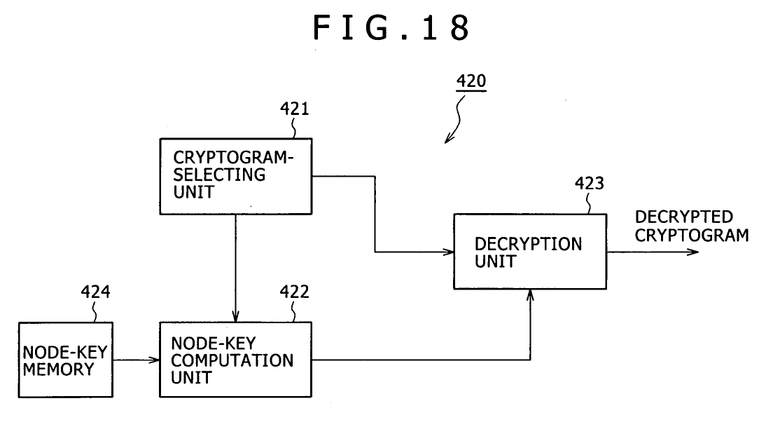

By referring to FIGS. 17 and 18, the following description explains the functional configuration of an information-processing apparatus for carrying out a process to determine node keys and a process to generate cryptograms by using the node keys and the functional configuration of the information-processing apparatus functioning as a receiver for carrying out a process to decrypt a cryptogram.

The description begins with an explanation of the functional configuration of an information-processing apparatus 410 for carrying out a process to determine node keys and a process to generate cryptograms by using the node keys with reference to FIG. 17. As shown in the figure, the information-processing apparatus 410 comprises one-way-hierarchical-tree generation unit 411, provided-node-key determination unit 412, cryptogram generation unit 413 and cryptogram-providing unit 414.

The information-processing apparatus 410 is an apparatus applying the broadcast encryption method based on a hierarchical tree configuration to carry out processing to provide cryptograms to only specially selected receivers capable of decrypting the cryptograms by excluding revoked receivers from targets of cryptogram distribution. The one-way-hierarchical-tree generation unit 411 is a unit for generating a 2-branch one-way hierarchical tree in which the node keys of nodes included in the 2-branch one-way hierarchical tree as nodes on hierarchical layers at higher levels are each set at a value computed by applying the one-way function F to at least one node key of a node on a hierarchical layer at a lower level.

To put it in detail, the one-way-hierarchical-tree generation unit 411 generates a 2-branch one-way hierarchical tree in which the node key of every node on a high-level hierarchical layer can be found by applying the one-way function F to at least one of the 2 node keys of the 2 nodes on a hierarchical layer immediately below the high-level hierarchical layer. Examples of the one-way function F are MD4, MD5 and SHA-1. In the case of a 2-branch one-way hierarchical tree having N terminal nodes each serving as a leaf, for example, the one-way-hierarchical-tree generation unit 411 executes the steps of: selecting N numbers x_{N}, x_{N+1} . . . , and x_{2N-1}; setting a variable i at an initial value of (2N−1) and then, while decrementing the variable i by 1 from the initial value to 1, carrying out repetitive processing starting with the initial value to compute x_{i/2} (=F(xᵢ)) by applying the one-way function F to the number xᵢ if the variable i is even; and using the values x₁, x₂ . . . , and x_{2N-1} obtained as results of the computation as node-associated values of all (2N−1) nodes composing the 2-branch one-way hierarchical tree including N terminal nodes.

The provided-node-key determination unit 412 is a unit for determining a minimum numbers of specific node keys to be provided to every receiver associated with any specific one of the terminal nodes in the 2-branch one-way hierarchical tree and providing the node keys to the receiver. The specific node keys are selected among node keys assigned to nodes on a path from the specific terminal node associated with the receiver to receive the specific node keys to the node provided on the hierarchical layer at the highest level to serve as the root. The specific node keys do not include a node key that can be found by applying the one-way function F to the node key of a node included on the path. Then, in the 2-branch one-way hierarchical tree where a node number of 1 is designated as a node number identifying the node serving as the root on the hierarchical layer at the highest level, node numbers of 2, 3, . . . , and 2N−1 are designated as node numbers identifying respectively nodes 2, 3, . . . , and 2N−1 on the hierarchical layers at lower levels in the breadth first order described earlier and node keys i are assigned to nodes i respectively, the provided-node-key determination unit 412 carries out a process of providing every receiver associated with a terminal node only with node keys i of nodes i located on a path from the terminal node to the root as nodes i that satisfy conditions (a) and (b) described as follows:
(a): nodes i shall be included in the path and
(b): nodes 2i shall not be included in the path.

The cryptogram generation unit 413 is a unit for carrying out an encryption process to generate cryptograms. The cryptogram generation unit 413 carries out the encryption process by selectively using node keys assigned to nodes composing the 2-branch one-way hierarchical tree created by the one-way-hierarchical-tree generation unit 411. The cryptogram-providing unit 414 is a unit for distributing cryptograms generated by the cryptogram generation unit 413 to receivers by way of a network or by recording the cryptograms on a recording medium.

By referring to FIG. 18, the following description explains the functional configuration of an information-processing apparatus 420 functioning as a receiver for carrying out a process to decrypt cryptograms.

As shown in the figure, the information-processing apparatus 420 functioning as a receiver for carrying out a process to decrypt cryptograms comprises cryptogram-selecting unit 421, node-key computation unit 422, decryption unit 423 and a node-key memory 424.

The cryptogram-selecting unit 421 is a unit for carrying out a process to select a cryptogram from cryptograms distributed by the cryptogram-providing unit 414. The selected cryptogram is a cryptogram generated by using a node key held in the node-key memory 424 or by using a higher-level node key computable from the held node key. To put it concretely, in the 2-branch one-way hierarchical tree where a node number of 1 is designated as a node number identifying the node serving as the root on the hierarchical layer at the highest level and node numbers of 2, 3, . . . , and 2N−1 are designated as node numbers identifying respectively nodes 2, 3, . . . , and 2N−1 on the hierarchical layers at lower levels in the breadth first order described earlier, the cryptogram-selecting unit 421 carries out a process to collate node numbers assigned to node keys used in the encryption process to generate the cryptograms with node numbers assigned to nodes included in a path from a terminal node associated with the receiver to the root in order to find a matching node number indicating a cryptogram to be selected.

The node-key computation unit 422 is a unit for computing a node key assigned to a node provided on a hierarchical layer at a higher level by applying the one-way function F to the held node key to find an encryption key for decrypting the selected cryptogram in case the selected cryptogram is a cryptogram generated by using the node key assigned to the node provided on the hierarchical layer at a higher level. Examples of the one-way function F are MD4, MD5 and SHA-1.

To put it in detail, the node-key computation unit 422 carries out the process to find a node key as follows. In the 2-branch one-way hierarchical tree where a node number of 1 is designated as a node number identifying the node serving as the root on the hierarchical layer at the highest level and node numbers of 2, 3, . . . , and 2N−1 are designated as node numbers identifying respectively nodes 2, 3, . . . , and 2N−1 on the hierarchical layers at lower levels in the breadth first order described before, the node-key computation unit 422 determines such a smallest k that the node number of 2^{k}i is included as a node number assigned to one of nodes included in a path from a terminal node associated with the receiver to the root but the node number of 2^{k+1}i is not where i is the value of the matching node number recognized by the cryptogram-selecting unit 421. Then, by applying the one-way function F repeatedly k times to the node key of NK₂_{^{k}}ᵢ stored in the node-key memory 424, the node-key computation unit 422 finds the node key NKᵢ used as an encryption key in the process to encrypt the secret information to produce the cryptogram.

The decryption unit 423 is a unit for carrying out processing to decrypt the cryptogram by using a node key held in the node-key memory 424 or a node key computed by the node-key computation unit 422 by applying the one-way function F to the node key held in the node-key memory 424.

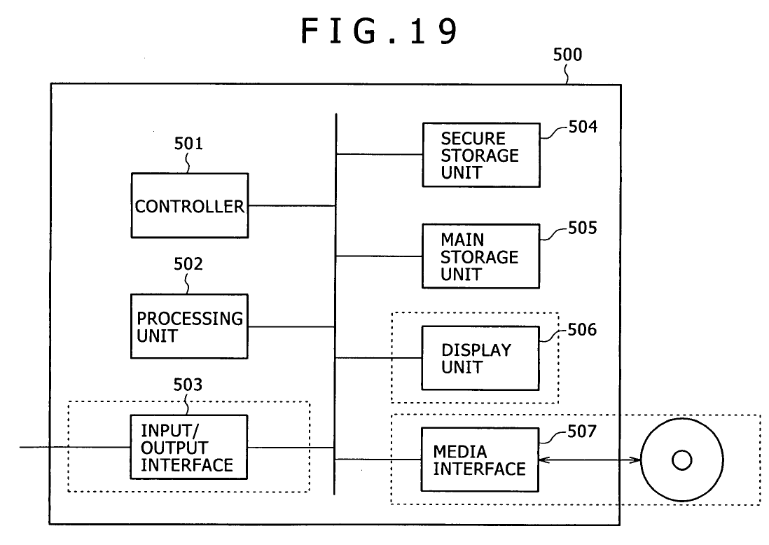

FIG. 19 is a diagram showing a typical hardware configuration of the information-processing apparatus 500 for carrying out a process to determine node keys and a process to generate cryptograms by using the node keys and the information-processing apparatus 500 functioning as a receiver for carrying out a process to decrypt cryptograms. Every block enclosed by a dotted line in the figure is optional. For example, a media interface 507 is a functional block employed only in the information-processing apparatus functioning as a receiver such as an optical-disk player. On the other hand, an input/output interface 503 is a functional block employed only in an information-processing apparatus if the information-processing apparatus exchanges information with other apparatus or receives a signal from an antenna.

If the information-processing apparatus 500 is an information-processing apparatus functioning as a receiver, a secure storage unit 504 is a component of importance. The secure storage unit 504 is a memory for safely storing node keys, which are received from the TC (trusted center) at a setup phase. It is to be noted that the one-way function F can be stored in the secure storage unit 504 or a main storage unit 505.

As shown in FIG. 19, the information-processing apparatus 500 for carrying out a process to generate cryptograms and the information-processing apparatus 500 functioning as a receiver for carrying out a process to decrypt cryptograms comprises a controller 501, a processing unit 502, the input/output interface 503 cited above, the secure storage unit 504 mentioned above, the main storage unit 505 cited above, a display unit 506 and the media interface 507 mentioned above.

The controller 501 includes a CPU for executing functions to serve as a control unit for carrying out data processing according to typically a computer program. The processing unit 502 is a component functioning as a dedicated processing unit as well as a dedicated encryption unit, which typically carry out an encryption-key generation process, a random-number generation process and an encryption process. The processing unit 502 also carries out a process to compute the node key of a node on a hierarchical layer at a higher level by applying the one-way function F.

The input/output interface 503 is an interface for carrying out data transmission/reception processes of inputting data from an input unit such as a keyboard and a mouse as well as outputting data to an external output apparatus by way of a network.

The secure storage unit 504 is a memory for storing data in a safe and confidential manner. Data stored in the secure storage unit 504 includes a variety of IDs and node keys generated at the setup phase.

It is to be noted that, if the information-processing apparatus 500 is an information-processing apparatus functioning as a receiver um, the node keys stored in the secure storage unit 504 are node keys, which are assigned to nodes included in PathNodes-m of the receiver um but cannot be generated by applying the one-way function F to the node key assigned to the terminal node associated with the receiver um.

The main storage unit 505 is a memory for storing typically a data-processing program executed by the controller 501. The main storage unit 505 is also used for example as a work area for storing processing parameters on a temporary basis during execution of programs. The main storage unit 505 can also be used for storing the one-way function F described above.

The secure storage unit 504 and the main storage unit 505 are each typically a RAM or a ROM. The display unit 506 is a component for displaying typically a content obtained as an output of a decryption process. The media interface 507 is a component for executing functions to read out data from media and write data onto the media. Examples of the media are a CD, a DVD and an MD.

### Second Embodiment

By referring to diagrams, the following description explains a second embodiment implementing the information-processing method, the decryption method, the information-processing apparatus and computer programs in detail.

It is to be noted that the second embodiment is explained in sections arranged in the following order:
1: Overview of an SD (Subset Difference) method
2: Configuration for reducing a label count of the SD method using a one-way hierarchical tree
3: Typical method of configuring a one-way hierarchical tree
4: Typical information distribution process using a one-way hierarchical tree
5: Overview of a basic LSD (Layered Subset Difference) method
6: Configuration for reducing a label count of the basic LSD method using a one-way hierarchical tree
7: Overview of a general LSD (Layered Subset Difference) method
8: Configuration for reducing a label count of the general LSD method using a one-way hierarchical tree
   1: Overview of SD (Subset Difference) Method

As described above, in accordance with the CS (Complete Sub-tree) method, a node of a hierarchical tree is used for expressing a set consisting of receivers associated with leaves of a partial tree having the node as its vertex. In accordance with the SD (Subset Difference) method, on the other hand, nodes i and j (where the node i is an ancestor node of the node j) are used to represent a difference set obtained by subtracting a set of leaves included in a partial tree having the node j at its vertex from a set of leaves included in a partial tree having the node i at its vertex.

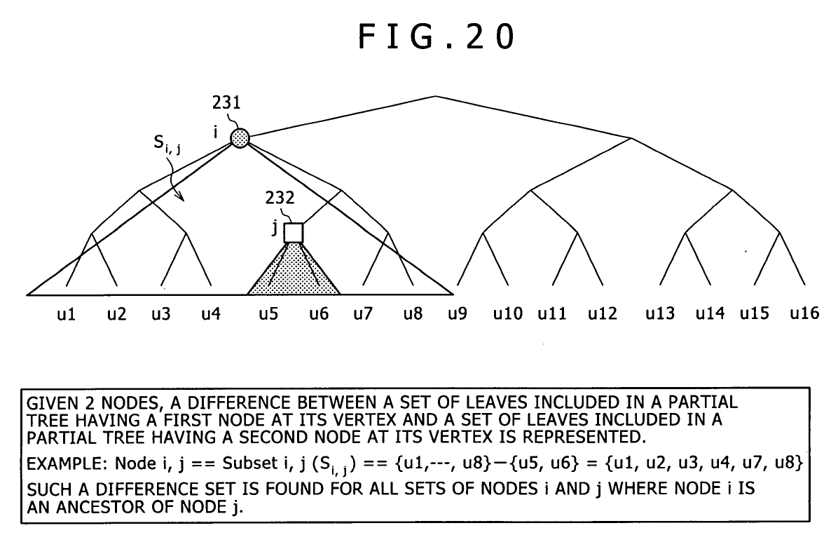

For example, nodes i231 and j232 shown in FIG. 20 are used to represent a defined set S_{i,j} obtained by subtracting a set consisting of receivers u5 and u6 from a set consisting of receivers u1 to u8 to result in a set consisting of receivers u1 to u4 and u7 to u8. Thus, S_{i,j} ={u1, u2, u3, u4, u7 and u8}. In this case, the node i231 is an ancestor node of the node j232. That is to say, the node i231 is not the same node as the node j232. Instead, the node i231 is a node provided on a path from the node j232 to the root. For every set of ancestor and offspring nodes i and j, the ancestor and offspring nodes i and j are used to define such a difference set Sᵢⱼ. An offspring node of a specific node is a node included in a partial tree having the specific node at its vertex. In the example shown in FIG. 20, the node j232 is an offspring node of the node i231.

The difference set S_{i,j}={u1, u2, u3, u4, u7 and u8} is also referred to as a subset S_{i,j} for which a subset key SK_{i,j} is set. A subset key SK_{i,j} is set as a key common to the subset S_{i,j}={u1, u2, u3, u4, u7 and u8}, which is obtained by subtracting the set consisting of receivers u5 and u6 from the set consisting of receivers u1 to u8 to result in a set consisting of receivers u1 to u4 and u7 to u8 as described above. By transmitting a cryptogram obtained as a result of a process to encrypt secret information by using the subset key SK_{i,j}, only the subset S_{i,j}={u1, u2, u3, u4, u7 and u8} is capable of decrypting the cryptogram so that the receivers u5 and u6 can be revoked.

With such setting, the number of sets to which a receiver can pertain is expressed by the following equation:

$${\sum }_{k = 1}^{log N} ( {2}^{k} - k ) = O ( N ) \qquad ( 4 )$$

Thus, if subset keys are assigned to their subsets independently of each other, it is necessary to safely hold the subset keys for O(N) subsets in a receiver pertaining to the subsets. However, the subset count O(N) increases dramatically as the receiver count N rises. In consequence, it is practically difficult to keep a large amount of such information in every receiver in a safe manner.

In order to solve the above problem, a technique described below is devised in the SD (Subset Difference) method. Much like the CS (Complete Sub-tree) method described earlier, the TC (trusted center) carries out processing such as an operation to define a 2-branch one-way hierarchical tree, an operation to define a subset, an operation to define a subset key and an operation to distribute secret information. In the following description, the subset S_{i,j} described above is also referred to as the subset of the node j with the node i used as a starting node.

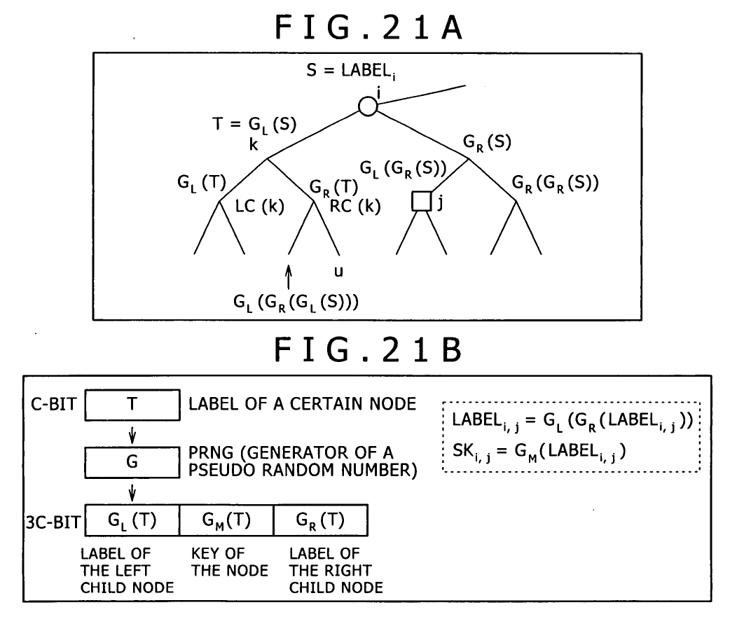

First of all, as shown in FIG. 21A, the TC (trusted center) pays attention to an internal node i and selects a value S with a length of C bits at random as LABELᵢ, which is a label of the node i. An internal node is a node other than a leaf. LABELᵢ is an initially selected random number for a node i. The TC (trusted center) gives LABELᵢ to a receiver, which then uses LABELᵢ for computing LABEL_{i,k} as follows.

Then, as shown in FIG. 21B, the selected value S (=LABELᵢ) is supplied to a pseudo-random-number generator G having an input of C bits and an output of 3C bits. The output having a length of 3C bits is delimited into C-bit portions starting from the left side (or the side of the most significant bit). The resulting 3 portions each having a length of C bits are referred to as G_{L}(S), G_{M}(S) and G_{R}(S) respectively. Then, as shown in FIG. 21A, G_{L}(S) is used as the label of a left-side child node k of the node i and G_{R}(S) is used as the label of a right-side child node of the node i. The label of a node is used to find the subset key of a subset for the node as described below. G_{M}(S) will be described later.

To put it in detail, by carrying out the processing shown in FIGS. 21A and 21B, G_{L}(S) is used as LABEL_{i,k} of the left-side child node k of the node i. LABEL_{i,k} is used for finding the subset key SK_{i,k} of a subset S_{i,k} for the left-side child node k with the node i serving as a starting node. As shown in FIGS. 21A and 21B, the left-side child node k is a child node on the left side. Let G_{L}(S)=LABEL_{i,k}=T. Then, G_{L}(S)=T is supplied to the pseudo-random-number generator G shown in FIG. 21B. By the same token, the 3C-bit output of the pseudo-random-number generator G is delimited into C-bit portions starting from the left side (or the side of the most significant bit). The resulting 3 portions each having a length of C bits are referred to as G_{L}(T), G_{M}(T) and G_{R}(T), which are used as follows:

G_{M}(T) or G_{M}(LABEL_{i,k}) is used as the subset key SK_{i,k} of the subset S_{i,k} for the node k itself with the node i used as a starting node. In this way, LABEL_{i,k} is used for finding the subset key SK_{i,k}.

G_{L}(T) is used as LABEL_{i,LC(k)} of a left-side child node LC(k) of the node k with the node i used as a starting node. As G_{L}(S) is used for finding the subset key SK_{i,k} of the subset S_{i,k}, G_{L}(T) is used for finding the subset key of the subset for the left-side child node LC(k) of the node k with the node i used as a starting node.

G_{R}(T) is used as LABEL_{i,RC(k)} of a right-side child node RC(k) of the node k with the node i used as a starting node. Much like G_{L}(T), G_{R}(T) is used for finding the subset key of a subset for the right-side child node RC(k) of the node k with the node i used as a starting node.

By repeating this processing, the label of each offspring node of the starting node i can be computed, and the label can be used for finding the subset key of a subset for the offspring node. It is to be noted that, in accordance with the definition described above, the set S_{i,i} is an empty set. Thus, when node i is used as a starting node, no subset key of a subset for the node i is necessary. It is therefore worth noting that, when LABELᵢ (=S) is supplied to the pseudo-random-number generator G, the pseudo-random-number generator G generates an output including a middle portion G_{M}(S), which is not used. That is to say, G_{M}(S) is the subset key of the empty subset S_{i,i}.

Much like G_{L}(S) described above, processing of G_{R}(S) is explained with reference to the example shown in FIG. 21A as follows. After initial LABELᵢ (=S) of the node i serving as a starting node is processed as described above, G_{R}(S) obtained as a result of the process is used for finding the subset key of a subset for the right-side child node of the node i with the node i serving as a starting node. That is to say, G_{R}(S) is further supplied to the pseudo-random-number generator G, which then outputs G_{L}(G_{R}(S)), G_{M}(G_{R}(S)) and G_{R}(G_{R}(S)). G_{M}(G_{R}(S)) is used as the subset key of a subset for the right-side child node of the node i with the node i serving as a starting node. G_{L}(G_{R}(S)) is used as LABEL_{i,j} of a left-side grandchild node j of the node i. LABEL_{i,j} of the left-side grandchild node j is used for finding the subset key SK_{i,j} of a subset S_{i,j} for the left-side grandchild node j with the node i used as a starting node. Thus, the processing using the pseudo-random-number generator G can be carried out to compute the label of each offspring node of a starting node i for any internal node i, and the label can be used for finding the subset key of a subset for the offspring node.

The TC (trusted center) carries out the processing described above at a setup time of the broadcast encryption system. The TC (trusted center) also determines the pseudo-random-number generator (or a pseudo-random-number function) G and discloses the determined pseudo-random-number generator G. Thus, a receiver given LABEL_{i,j} is capable of computing LABEL_{i,n} and the subset key SK_{i,n}. LABEL_{i,n} is a label of any node n serving as an offspring node of a node j with a node i used as a starting node. The subset key SK_{i,n} is a subset key of a subset of any offspring node n of the node j with the node i used at a starting node.

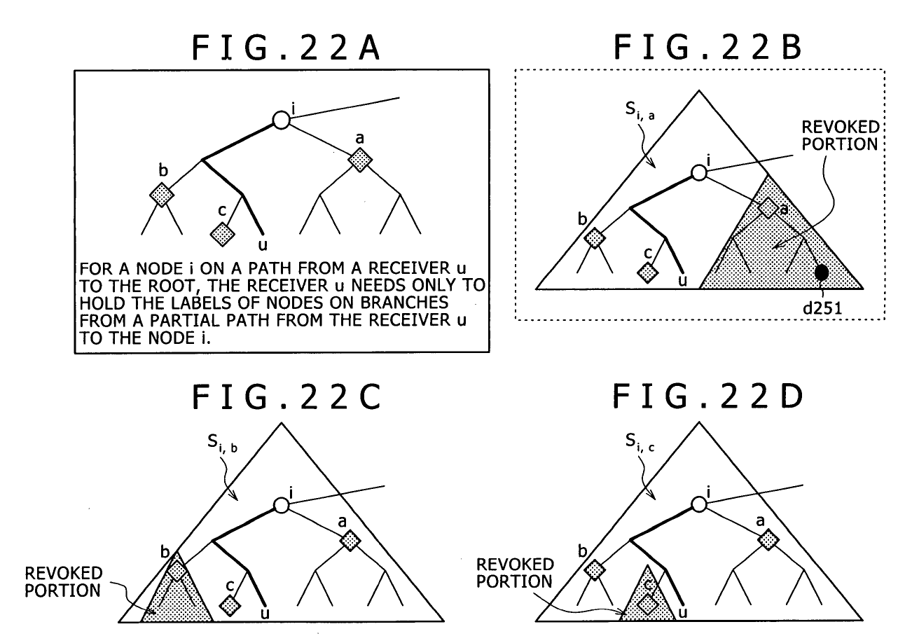

By referring to FIG. 22A, consider a receiver u, a path from a leaf associated with the receiver u to the root of the 2-branch one-way hierarchical tree, internal nodes i on the path and a partial path from the leaf to each of the nodes i. With the setting described above, for every internal node i on the path, the receiver u needs to hold the labels of subsets of off-path nodes a, b and c, which are direct-branch nodes from the partial path having the internal node i as a top end node. This is because the receiver u pertains to subsets S_{i,a}, S_{i,b} and S_{i,c}. LABEL_{i,a}, LABEL_{i,b} and LABEL_{i,c} for subsets S_{i,a}, S_{i,b} and S_{i,c} respectively are given by the TC (trusted center) to the receiver u. In the above description, LABEL_{i,a}, LABEL_{i,b} and LABEL_{i,c} for nodes a, b and c respectively are each the technical term LABELᵢ described above where i=a, b and c.

A subset key of a subset with the internal node i used as a starting node can be computed for nodes comprising the nodes a, b and c and their offspring nodes. Pay attention to the node i shown in FIG. 22A. Nodes a, b and c are the 3 nodes each serving as a direct-branch node from the partial path from the leaf associated with the receiver u to the node i. At a setup time of the broadcast encryption system, the TC (trusted center) gives the labels of the 3 nodes to the receiver u. The labels given by the the TC (trusted center) of the 3 nodes are LABEL_{i,a}, LABEL_{i,b} and LABEL_{i,c} used in the following description.

The receiver u is capable of finding a subset key SK_{i,a} of the subset S_{i,a} from processing carried out by the pseudo random number generator G as processing based on the LABEL_{i,a} of the node a. That is to say:

SK_{i,a}=G_{M}(LABEL_{i,a})

As shown in FIG. 22B, the subset S_{i,a} is a subset obtained by revoking receivers included in a partial tree having the node a at its vertex. Thus, the subset S_{i,a} is a subset including leaves of a partial tree having the node i at its vertex except leaves of the partial tree having the node a at its vertex. The leaves of the subset S_{i,a} are leaves associated with receivers each treated as a target of information distribution.

In addition, the receiver u is capable of finding a subset key SK_{i,b} of the subset S_{i,b} from processing carried out by the pseudo random number generator G as processing based on the LABEL_{i,b} of the node b. That is to say:

SK_{i,b}=G_{M}(LABEL_{i,b})

As shown in FIG. 22C, the subset S_{i,b} is a subset obtained by revoking receivers included in a partial tree having the node b at its vertex. Thus, the subset S_{i,b} is a subset including leaves of the partial tree having the node i at its vertex except leaves of the partial tree having the node b at its vertex. The leaves of the subset S_{i,b} are leaves associated with receivers each treated as a target of information distribution.

In addition, the receiver u is capable of finding a subset key SK_{i,c} of the subset S_{i,c} from processing carried out by the pseudo random number generator G as processing based on the LABEL_{i,c} of the node c. That is to say:

SK_{i,c}=G_{M}(LABEL_{i,c})

As shown in FIG. 22D, the subset S_{i,c} is a subset obtained by revoking receivers accociated with leaves c included in a partial tree having the node c at its vertex. Thus, the subset S_{i,c} is a subset including leaves of the partial tree having the node i at its vertex except the leaves c of the partial tree having the node c at its vertex. The leaves of the subset S_{i,c} are leaves associated with receivers each treated as a target of information distribution.

Since the leaf associated with the receiver u pertains to the subsets S_{i,a}, S_{i,b} and S_{i,c}, the receiver u needs to hold LABEL_{i,a}, LABEL_{i,b} and LABEL_{i,c} given by the TC (trusted center) as labels for computing necessary subset keys of subsets used in PRNG.

In a 2-branch one-way hierarchical tree having a node i as its starting node, in addition to the 3 subsets S_{i,a}, S_{i,b} and S_{i,c}, there is a variety of other subsets, which each exclude leaves each associated with a revoked receiver other than the receiver u. For example, only a receiver associated with a leaf d251 shown in FIG. 22B is revoked. Thus, if only a receiver associated with the leave d251 is revoked, naturally, the subset key SK_{i,d} of the subset S_{i,d} is required in PRNG not including the revoked receiver. As described above, however, a subset key for each of nodes including leaves can be found from processing carried out by the pseudo random number generator G as processing based on the label of a node on a hierarchical layer at a higher level. Thus, the receiver u is capable of finding the subset key SK_{i,d} of a subset S_{i,d} obtained by revoking a receiver associated with the leaf d251 on the basis of the label LABEL_{i,a} owned by the receiver u as the label of the node a.

The subset key of each other subset can be found in the same way. Thus, considering a receiver u, a path from a leaf associated with the receiver u to the root of the 2-branch one-way hierarchical tree, internal nodes i on the path and a partial path from the leaf to each of the nodes i with reference to FIG. 22A, for any internal node i on the path, the receiver u needs to hold the labels of off-path nodes a, b and c, which are direct-branch nodes from the partial path having the internal node i as a starting node, as described above.

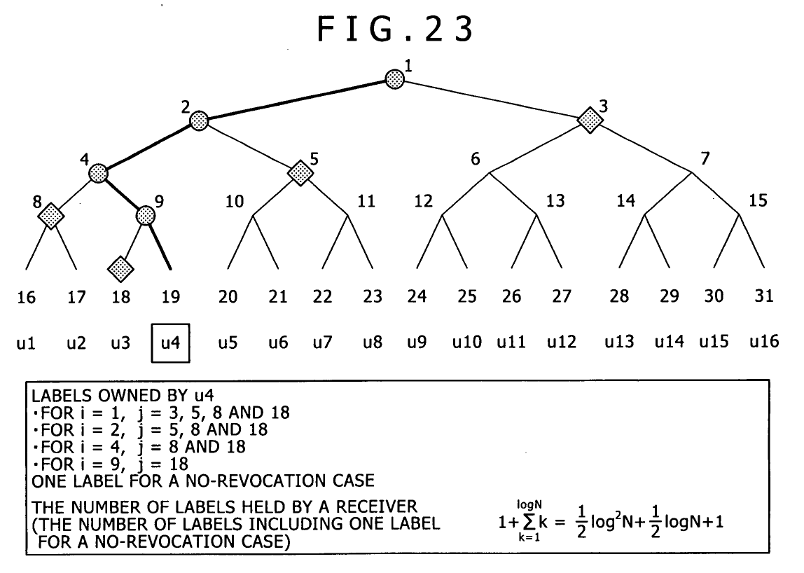

FIG. 23 is a diagram showing labels that must be owned by each receiver in a 2-branch one-way hierarchical tree with a total receiver count N of 16. Consider a receiver u4 as well as each of internal nodes 1, 2, 4 and 9 on a path from a node 19 associated with the receiver u4 to the node 1, which serves as the root at the vertex of the 2-branch one-way hierarchical tree, as a starting node i. In this case, there are 4 direct-branch nodes i.e., the internal nodes 3, 5, 8 and 18, from the path from the node 19 to the node 1 with the node 1 taken as the starting node. Thus, the receiver u4 needs to hold 4 labels listed as follows:

LABEL_{1,3}

LABEL_{1,5}

LABEL_{1,8}

LABEL_{1,18}

This is because the receiver u4 pertains to subsets S_{1,3}, S_{1,5}, S_{1,8} and S_{1,18} so that, by holding the above labels, the receiver u4 is capable of computing subset keys SK_{1,3}, SK_{1,5}, SK_{1,8} and SK_{1,18}.

By the same token, with the node 2 taken as the starting node, the receiver u4 needs to hold 3 labels listed as follows:

LABEL_{2,5}

LABEL_{2,8}

LABEL_{2,18}

In the same way, with the node 4 taken as the starting node, the receiver u4 needs to hold 2 labels listed as follows:

LABEL_{4,8}

LABEL_{4,18}

Likewise, with the node 9 taken as the starting node, the receiver u4 needs to hold 1 label, i.e., LABEL_{9,18}.

For a special case in which no receiver is revoked, the only one existing set includes all receivers including the receiver u4. This only one existing set is expressed by a subset S_{1,φ}. For this special case, the receiver u4 also holds one label named LABEL_{1,φ}.

That is to say,. in the 2-branch one-way hierarchical tree shown in FIG. 23, as also described briefly in FIG. 23, labels held by the receiver u4 are summarized as follows:
For i=1, j=3, 5, 8 and 18 to give 4 labels.
For i=2, j=5, 8 and 18 to give 3 labels.
For i=4, j=8 and 18 to give 2 labels.
For i=9, j=18 to give 1 label.
   In addition, the receiver u4 also holds one label for a no-revocation case, in which no receivers are revoked, to give a total of 11 labels.

For the sake of explanation uniformity, the receiver u4 holds one label (that is, LABEL_{1,φ}) for a no-revocation case, in which no receivers are revoked. However, the receiver u4 may also directly hold a subset key SK_{1,φ} for the subset S_{1,φ} as a substitute for the one label for a no-revocation case, in which no receivers are revoked.

As described above, for every internal node on a path from any leaf to the root, the receiver associated with the leaf needs to hold as many labels as layers to go through from the leaf to the internal node in addition to one special level. With symbol N denoting the number of leaves each associated with a receiver, the number of labels held by every receiver can be computed from the following equation:

$$1 + {\sum }_{k = 1}^{log N} k = \frac{1}{2} {log}^{2} N + \frac{1}{2} log N + 1 \qquad ( 5 )$$

Thus, for N=16 as is the case with the example described above, every receiver holds a total of 11 labels.

Every receiver holds as many labels as indicated by the above equation and is capable of generating a required subset key by using a pseudo random number generator G disclosed by the TC (trusted center). The receiver must hold the labels in a safe manner.

2: Configuration for Reducing a Label Count of the SD Method Using a One-Way Hierarchical Tree

The following description explains a configuration for reducing the number of labels in the SD (Subset Difference) method using a one-way hierarchical tree provided by the present invention. By observation of the SD (Subset Difference) method, the following things are known.

Label LABEL_{i,j} may be:
(A): a label received by the receiver directly from the TC (trusted center) or
(B): derived by the receiver by using a pseudo random number generator G from another label.

However, LABEL_{i,j} where subscript i denotes the node number of a parent node while subscript j denotes the node number of a child node is never derived by the receiver by using a pseudo random number generator G from another label as a label of category (B), but always a label received by the receiver directly from the TC (trusted center) as a label of category (A). Nodes i and j are said to be parent and child nodes respectively if the node i exists on a hierarchical layer directly above the hierarchical layer on which the node j exists. In this case, the hierarchical layers of the nodes are said to be separated away from each other by a distance of 1.

LABEL_{i,j} for parent and child nodes i and j never exists as a label of category B because, in order for a receiver to derive LABEL_{i,j} by using a pseudo random number generator G from another label, it is necessary to know the other label, which is LABEL_{i,k} of a node k serving as an ancestor node of the node j. If nodes i and j are parent and child nodes respectively, however, the node k serving as the ancestor node of the node j as well as the offspring node of the node i does not exist and, in addition, LABELᵢ for deriving LABEL_{i,j} is actually not given to any receiver.

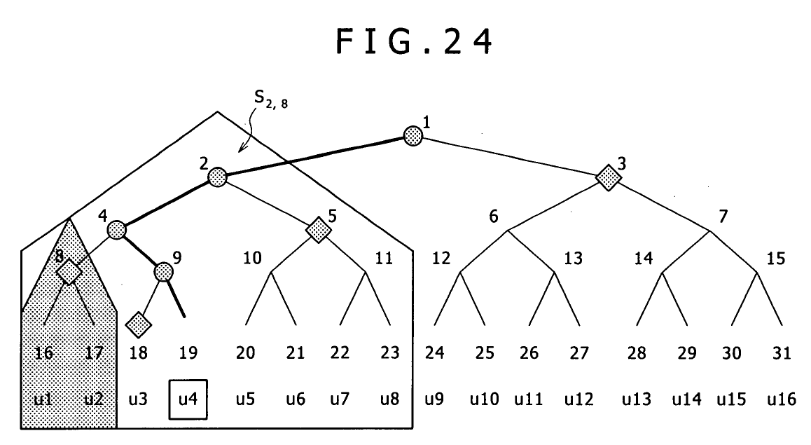

Categories (A) and (B) cited above are exemplified by referring to a typical configuration shown in FIG. 24. The TC (trusted center) directly gives LABEL_{2,8} to the receiver u4 but not to the receiver u5. The receiver u5 computes G_{L}(LABEL_{2,4}) by using the pseudo random number generator G from LABEL_{2,4} received from the TC (trusted center) and uses G_{L}(LABEL_{2,4}) as derived LABEL_{2,8}. That is to say, LABEL_{2,8}, where subscripts 2 and 8 are not node numbers of parent and child nodes, can be a label directly received by a receiver from the TC (trusted center) or derived by a receiver. On the other hand, LABEL_{2,4}, where subscripts 2 and 4 are node numbers of parent and child nodes respectively, is a label directly received by a receiver from the TC (trusted center).

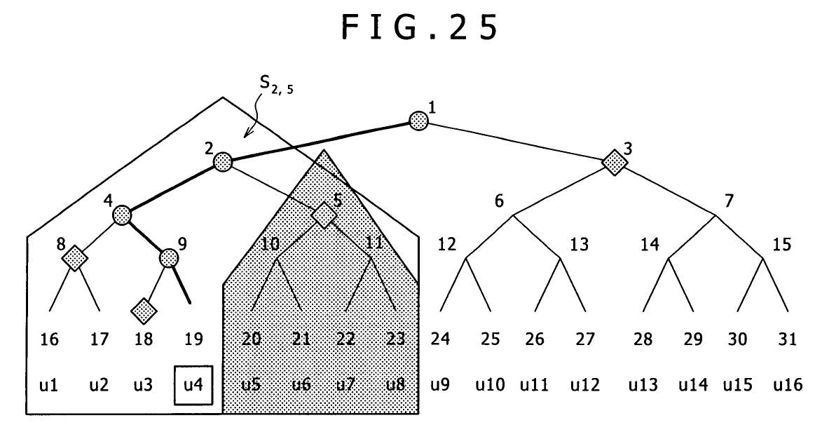

As shown in FIG. 25, on the other hand, the TC (trusted center) directly gives LABEL_{2,5}, where subscripts 2 and 5 are node numbers of parent and child nodes respectively, to receivers u1, u2, u3 and u4 pertaining to as a subset S_{2,5}. Since other receivers do not pertain to the subset S_{2,5}, they do not receive LABEL_{2,5} and are not capable of deriving LABEL_{2,5}. That is to say, LABEL_{2,5}, where subscripts 2 and 5 are node numbers of parent and child nodes respectively, is a label that can only be received by a receiver directly from the TC (trusted center) and cannot be derived a receiver by using the pseudo random number generator G.

In addition, it is also known that, in accordance with the SD method, receivers pertaining to a subset S_{j,n} also pertain to a subset S_{i,k} where subscript i indicates a node i serving as a parent node of child nodes j and k indicated by subscripts j and k respectively and the child node j is the parent node of a node n other than the nodes i and k.

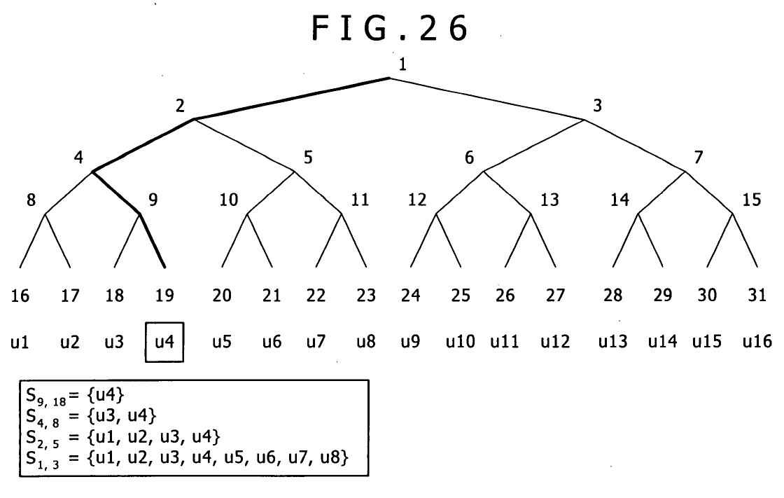

As shown in FIG. 26, for example, the receiver u4 pertaining to a subset S_{9,18} also pertains to subsets S_{4,8}, S_{2,5} and S_{1,3}. That is to say,

S_{9,18}={u4}

S_{4,8}={u3, u4}

S_{2,5}={u1, u2, u3, u4}

S_{1,3}={u1, u2, u3, u4, u5, u6, u7, u8}

In addition, as a receiver other than the receiver u4, the receiver u3 pertaining to the subset S_{4,8} also pertains to the subsets S_{2,5} and S_{1,3}.

In accordance with the present invention, the number of labels that should be held by a receiver can be reduced by applying a tree, that is, a key tree structure applying a one-way function F to parent-child LABEL_{i,j} and LABEL_{1,φ}. Parent-child LABEL_{i,j} has subscripts i and j denoting the node numbers of parent and child nodes respectively. LABEL_{1,φ} is the label of a subset S_{1,φ} including all receivers for this special case, in which no receiver is revoked.

In the SD (subset difference) method described above, for every receiver, it is possible to reduce the number of labels, which should be held by the receiver, as follows. For each internal node on a path from a leaf associate with the receiver to the root, the receiver holds parent-child LABEL_{i,j} where subscript i denotes the node number of a parent node while subscript j denotes a child node. There are (log N) internal nodes on such a path. As will be described later, some of the parent-child labels can be computed from another value by applying typically the one-way function F to the other value as described above. By setting the key tree structure in this way, the number of labels, which should be held by the receiver, can be reduced as follows.

As described earlier by referring to FIG. 23, 11 labels held by the receiver u4 in a safety manner are listed as follows:
For i=1, j=3, 5, 8 and 18 to give 4 labels, i.e.:

LABEL_{1,3}

LABEL_{1,5}

LABEL_{1,8}

LABEL_{1,18}
For i=2, j=5, 8 and 18 to give 3 labels, i.e.:

LABEL_{2,5}

LABEL_{2,8}

LABEL_{2,18}
For i=4, j=8 and 18 to give 2 labels, i.e.:

LABEL_{4,8}

LABEL_{4,18}
For i=9, j=18 to give 1 label i.e.:

LABEL_{9,18}

In addition, the receiver u4 also holds one label LABEL_{1,φ} for a no-revocation case, in which no receivers are revoked, to give a total of 11 labels. In the configuration provided by the present invention, however, the labels listed below are each a parent-child label wherein the first and subscripts denote the node numbers of parent and child nodes:

LABEL_{1,3}

LABEL_{2,5}

LABEL_{4,8}

LABEL_{9,18}

In addition, the labels held by the receiver u4 also include LABEL_{1,φ} for a no-revocation case, in which no receivers are revoked. The receiver u4 must hold the parent-child labels and LABEL_{1,φ} for a no-revocation case, in which no receivers are revoked, in a safety manner. By applying the one-way hierarchical tree explained below, however, the number of labels held by a receiver as labels for parent-child nodes can be reduced.

3: Typical Method of Configuring a One-Way Hierarchical Tree

The following description explains an information distribution configuration based on a hierarchical tree structure using a 2-branch one-way hierarchical tree provided by the present invention. It is to be noted that the 2-branch one-way hierarchical tree is not a general term, but a technical term for defining one property of a tree structure used for explaining the present invention.

The definition of a 2-branch one-way hierarchical tree is explained as follows.

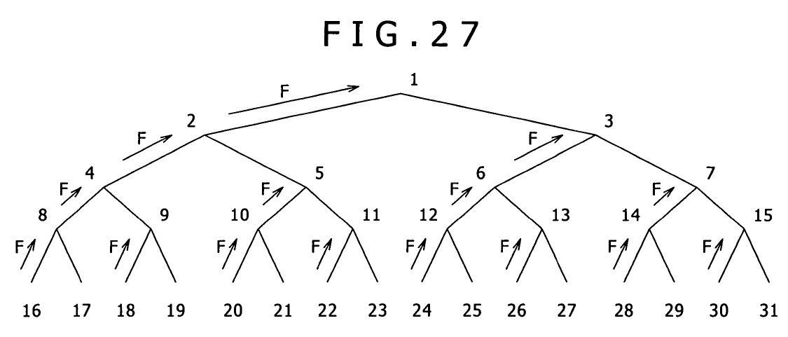

A 2-branch one-way hierarchical tree is a complete 2-branch tree including N leaves like one shown in FIG. 27. In the 2-branch one-way hierarchical tree, a node number of 1 is assigned to the node serving as the root on the hierarchical layer at the highest level. On the other hand, node numbers of 2, 3, . . . , and 2N−1 are assigned to nodes on hierarchical layers at lower levels in a breadth first order starting with the hierarchical layer directly below the root and starting with the left-most node on each of the hierarchical layers at lower levels in the so-called breadth first order. Let xᵢ be a value for a node with a node number i where i=1, 2, . . . , and (2N−1). The value xᵢ has a size of C bits where C is typically 128. In this case, the 2-branch one-way hierarchical tree is a tree in which the equation xᵢ=F(x₂ᵢ) holds true for i=1, 2, . . . , and (N−1). The value xᵢ for the node i where i=1, 2, . . . , and (2N−1) is a node key assigned to the node i.

In this case, the function F is a one-way function F having an input of C bits and an output of C bits.

Examples of the one-way function F are MD4, MD5 and SHA-1. The MD4 and MD5 functions each have an input with any arbitrary length and an output of 128 bits. On the other hand, the SHA-1 function has an input with any arbitrary length and an output of 160 bits. Thus, the MD4, MD5 and SHA-1 functions can be applied to the 2-branch one-way hierarchical tree defined above. It is to be noted that these typical functions are described in references such as “Handbook of Applied Cryptography” authored by A. J. Menezes, P. C. van Oorschot and S. A. Vanstone and published by CRC Pres in the year of 1996. It is also worth noting that these typical functions are also each referred to as a one-way function F or a hash function.

A relation between the one-way function F set for the node i of a 2-branch one-way hierarchical tree and the node-associated value xᵢ for the node i is expressed as a diagram of FIG. 27. In the structure of this 2-branch one-way hierarchical tree, the equation xᵢ=F(x₂ᵢ) holds true for i=1, 2, , . . . , and 2N−1.

For example, the following equations hold true.
x₈=F(x₁₆)
x₄=F(x₈)
x₂=F(x₄)
x₁=F(x₂)

As described above, the node-associated value xᵢ for a node i of the 2-branch one-way hierarchical tree satisfies the equation xᵢ=F(x₂ᵢ)

In a 2-branch one-way hierarchical tree having N leaves, a typical algorithm used for constructing the tree is explained below. In this algorithm, an input and an output are set as follows.

The input includes a value N representing the number of leaves of the 2-branch one-way hierarchical tree and the one-way function F having a C-bit output.

The output is (2N−1) values x₁, x₂, . . . , and x_{2N-1} each having a length of C bits for all (2N−1) nodes composing the 2-branch one-way hierarchical tree. In this case, the (2N−1) nodes include leaves on the hierarchical layer on the lowest level of the 2-branch one-way hierarchical tree.

The algorithm for finding the output described above on the basis of the input described above is described as follows.
1: Select N values x_{N}, x_{N+1} . . . , and x_{2N-1}, which are independent of each other and each have a length of C bits.
2: Use a variable i as a counter. While decrementing the variable i by 1 from (2N−1) to 1, carry out the following processing.
2-1: If the variable i is even, compute F(xᵢ) by applying the one-way function F to the value xᵢ and set the result of the computation in a C-bit number x_{i/2}.
3: Output (2N−1) C-bit values x₁, x₂, . . . , and x_{2N-1} and finish the processing.

The values xᵢ are each a number assigned to one of nodes composing the 2-branch one-way hierarchical tree or the node-associated value mentioned before. Pay attention to the fact that the number of nodes composing a complete 2-branch one-way hierarchical tree having N leaves is 2N−1.

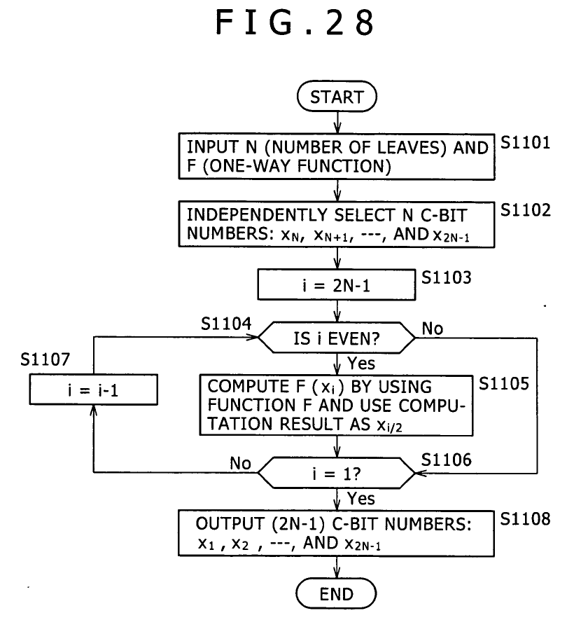

FIG. 28 shows a flowchart representing the algorithm described above. Each of steps composing the flowchart is explained as follows. As shown in the figure, the flowchart begins with a step S1101 at which N representing the number of leaves of the 2-branch one-way hierarchical tree and the one-way function F having a C-bit output are input.

Then, at the next step S1102, N values x_{N}, x_{N+1} . . . , and x_{2N+1}, which are independent of each other and each have a length of C bits, are selected. Subsequently, at the next step S1103, a variable i is initialized. To put it concretely, the variable i is set at an initial value of (2N−1). In the flowchart, this initialization is expressed as i=2N−1.

Then, at the next step S1104, the value of the variable i is examined to determine whether or not the variable i is even. If the variable i is even, the flow of the algorithm goes on to a step S1105. If the variable i is odd, on the other hand, the flow of the algorithm goes on to a step S1106.

As described above, if the variable i is even, the flow of the algorithm goes on to the step S1105 at which the value of F(xᵢ) is computed by applying the one-way function F to the value xᵢ and the result of the computation is set in a C-bit value x_{i/2}.

Then, at the next step S1106, the value of the variable i is examined to determine whether or not the variable i is equal to 1, that is, whether or not equation i=1 holds true. If equation i=1 does not hold true, the flow of the algorithm goes on to a step S1107 at which the variable i is decremented by 1 in an update process i=i−1. Then, the flow of the algorithm goes back to the step S1106 by way of the steps S1104 and S1105 to repeat the processing of the steps S1104, S1105 and S1106.

If the determination result obtained at the step S1106 reveals that equation i=1 holds true, on the other hand, the flow of the algorithm goes on to a step S1108 at which the (2N−1) C-bit values xᵢ, x₂, . . . , and x_{2N-1} are output as a node-associated value xᵢ assigned to a node i where i=1 to (2N−1).

The (2N−1) C-bit values xᵢ, x₂, . . . , and x_{2N-1} are each used as a node key assigned to a node i where i=1 to (2N−1). Thus, the number of nodes including leaves is also 2N−1.

In the processing based on the above algorithm, node-associated values xᵢ for nodes i composing the 2-branch one-way hierarchical tree are determined. The node-associated values xᵢ are each used as a label to complete the tree structure.

In the typical processing to set the 2-branch one-way hierarchical tree described above, the one-way function F is applied to a node-associated value assigned to a node on a hierarchical layer at a lower level to compute a node-associated value assigned to a node existing at a position on a hierarchical layer at a higher level as a node shifted in a right-upward direction from the node on the hierarchical layer at a lower level as shown in FIG. 27. It is to be noted, however, that the processing to set the 2-branch one-way hierarchical tree described above can also be implemented in a configuration wherein the one-way function F is applied to a node-associated value assigned to a node on a hierarchical layer at a lower level to compute a node-associated value assigned to a node existing at a position on a hierarchical layer at a higher level as a node shifted in a left-upward direction node on the hierarchical layer at a lower level.

4: Typical Information Distribution Process Using a One-Way Hierarchical Tree

The following description explains a process to distribute cryptograms to receivers on the basis of the structure of a 2-branch one-way hierarchical tree comprising nodes each having a node-associated value found by carrying out the processing described above. The process to distribute cryptograms to receivers is explained in sections arranged in the following order.
(4-1): Setup processing
(4-2): Information distribution processing
(4-3): Processing to receive and decrypt information
   (4-1): Setup Processing

The setup processing is carried out only once when the distribution encryption system is activated. Thereafter, the information distribution processing as well as the processing to receive and decrypt information are carried out every time information to be transmitted is generated. The information distribution processing as well as the processing to receive and decrypt information are carried out for example every time information-recording mediums such as DVDs each used for recording a new content are distributed to receivers or new information is distributed to receivers by way of a network. It is to be noted that the TC (trusted center) independent of an entity for carrying out the information distribution processing may perform the setup processing. As an alternative, the entity for carrying out the information distribution processing may perform the setup processing.

The setup processing is carried out by execution of steps 1 to 4 described as follows.

a: Step 1

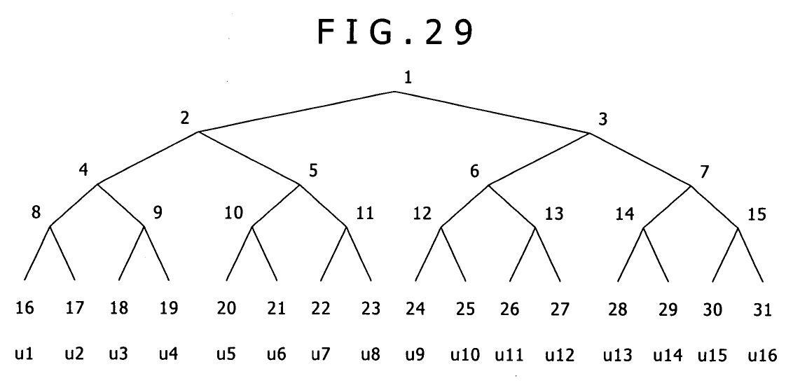

The TC (trusted center) defines a 2-branch one-way hierarchical tree having N leaves. A node number k where k=1, 2, . . . , and (2N−1) is assigned to each of nodes composing the 2-branch one-way hierarchical tree. In this case, however, a node number of 1 is assigned to a node located on the hierarchical layer at the highest level of the 2-branch one-way hierarchical tree. The node located on the hierarchical layer at the highest level serves as the root of the tree. On the other hand, node numbers of 2, 3 . . . , and (2N−1) are assigned to nodes on the lower-level hierarchical layers of the 2-branch one-way hierarchical tree in the breadth first order described earlier. The result of the assignment of the node numbers y is shown in FIG. 29. As shown in the figure, the node numbers y of 1, 2, . . . , and (2N−1) are assigned to the nodes composing the 2-branch one-way hierarchical tree.

Receivers um where m=1, 2, . . . , and N are associated with the leaves of the 2-branch one-way hierarchical tree. In the example shown in FIG. 29, the 16 receivers u1 to u16 are associated with the leaves indicated by the node numbers y of 16 to 31 respectively.

In addition, the TC (trusted center) selects a one-way function F having an output of C bits and reveals the selected function F. In this case, C is any arbitrary number. An existing hash function can be used as the one-way function F. Examples of the existing hash function are MD4, MD5 and SHA-1.

Next, a subset S_{i,j} of ancestor-offspring nodes i and j with the node i being an ancestor node of the node j is defined for each of internal nodes i where i=1, 2, . . . , and (N−1). Subsets S_{i,j} with the node i being the parent node of the node j are each referred to as a first special subset SS_{i,j}. In the 2-branch one-way hierarchical tree, each of nodes except the root has only one parent node. It is thus necessary to keep in mind that there is only one first special subset SS_{i,j} for each of subscripts j where j=2, 3 . . . , and (2N−1). A second special subset SS_{1,φ} including all receivers is defined to be used as a subset for a no-revocation case in which no receiver is revoked.

b: Step 2

The TC (trusted center) computes node-associated values xᵢ of nodes i composing a 2-branch one-way hierarchical tree with N leaves in accordance with the algorithm explained earlier by referring to the flowchart shown in FIG. 28. Then, the TC (trusted center) creates the 2-branch one-way hierarchical tree as a tree in which the computed node-associated values xᵢ are used as labels assigned to nodes i. In the process to create the 2-branch one-way hierarchical tree, the following inputs are used.
(a): N representing the number of leaves included in the 2-branch one-way hierarchical tree and
(b): the one-way function F having an output of C bits.

The result of the process to create the 2-branch one-way hierarchical tree is (2N−1) C-bit values xᵢ, x₂, . . . , and x_{2N-1} for all the nodes including the leaves in the 2-branch one-way hierarchical tree.

As described above, the TC (trusted center) computes node-associated values xᵢ of nodes i composing a 2-branch one-way hierarchical tree with N leaves in accordance with the algorithm explained earlier by referring to the flowchart shown in FIG. 28 in order to create the 2-branch one-way hierarchical tree as a tree in which the computed node-associated values xᵢ are used as labels assigned to nodes i. In the process to create the 2-branch one-way hierarchical tree, the following inputs are used.

N representing the number of leaves included in the 2-branch one-way hierarchical tree; and

the one-way function F having an output of C bits.

The output of the process to create the 2-branch one-way hierarchical tree is (2N−1) C-bit values xᵢ, x₂, . . . , and x_{2N-1} for all the nodes including the leaves in the 2-branch one-way hierarchical tree.

The TC (trusted center) selects xᵢ from the (2N−1) C-bit values xᵢ, x₂, . . . , and x_{2N-1} and uses xᵢ as the label of the second special subset SS_{1,φ}, which is a subset including all receivers. The second special subset SS_{1,φ} is used for a no-revocation case, in which no receivers are revoked. That is to say,

LABEL_{1,φ}=x₁ (that is, x₁ is used as LABEL_{1,φ})

On the other hand, LABEL_{i,j} for each first special subset SS_{i,j} defined as a subset S_{i,j} of ancestor-offspring nodes i and j with the node i being the ancestor node of the node j where j=2, 3, . . . , and (2N−1) is determined as follows. As described above, the output of the process to create the 2-branch one-way hierarchical tree is (2N−1) C-bit values x₁, x₂, . . . , and x_{2N-1} for the nodes 1 to (2N−1), and the value x₁ for the node 1 serving as the root is used as LABEL_{1,φ}. That is to say, the use of the values x_{y} for nodes y where y=2, 3, . . . , and (2N−1) is not determined yet. The values x_{y} for nodes y where y=2, 3, . . . , and (2N−1) are used as follows. Let P(y) be a node number assigned to the parent node P(y) of the node y and S(y) be a node number assigned to the sister node S(y) of the node y. The sister node S(y) of the node y is defined as a node sharing the same parent node P(y) as the node y. Thus, LABEL_{P(y),S(y)} is the label of a first special subset SS_{P(y),S(y)} of parent-sister nodes with the node P(y) serving as the parent node and the node S(y) serving as the sister node S(y). In this case, for y=2, 3, . . . , and (2N−1), the values x_{y} for nodes y are used as follows.

LABEL_{P(y),S(y)}=x_{y} (that is, x_{y} is used as LABEL_{P(y),S(y)})

It is to be noted that, in this specification, generally symbol P(i) is the node number of the parent node of a node indicated by the node number i, symbol S(i) is the the node number of the sister node of the node indicated by the node number i and a sister node S(i) of the node i is defined as a node sharing the same parent node P(i) as the node i.

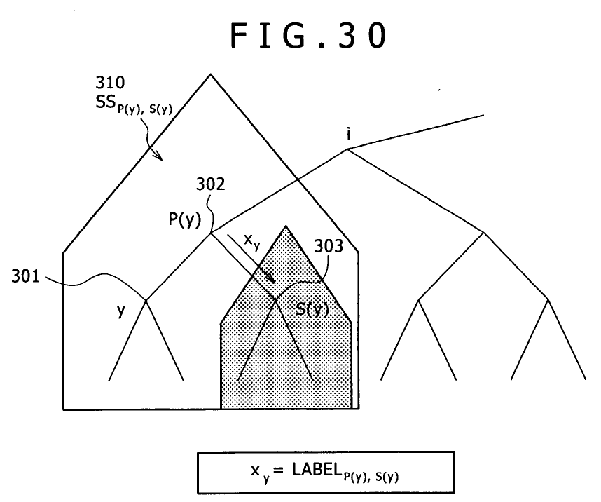

FIG. 30 is a diagram showing a concrete example of the assignment of the values x_{y}, In the example shown in FIG. 30, the value x_{y} has been computed for the node y301. As described earlier, the value xᵢ has been computed for a node i where i=1, 2, 3, . . . , and (2N−1) in accordance with the algorithm explained earlier by referring to the flowchart shown in FIG. 28. The computed value xᵢ satisfies the following equation:
x_{i/2}=F(xᵢ)

In the example shown in FIG. 30, the parent node of the node y301 is the node P(y)302 and the sister node of the node y301 is the node S(y)303. As described above, the first special subset SS_{P(y),S(y)} is a first special subset of parent-sister nodes with the node P(y) serving as the parent node and the node S(y) serving as the sister node S(y). Thus, in the example shown in FIG. 30, the first special subset SS_{P(y),S(y)} of parent-sister nodes with the node P(y)302 serving as the parent node and the node S(y)303 serving as the sister node S(y) is the subset SS_{P(y)302S(y)303}.

As described above, the value x_{y} for nodes y is used as follows:

LABEL_{P(y),S(y)}=x_{y} (that is, x_{y} is used as LABEL_{P(y),S(y)})

where LABEL_{P(y),S(y)} is the label of the first special subset SS_{P(y),S(y)}.

In the example shown in FIG. 30, the value x_{y301} is used as follows:

LABEL_{P(y)302S(y)303}=x_{y301} (that is, x_{y301} is used as LABEL_{P(y)302S(y)303})

where LABEL_{P(y)302S(y)303} is the subset key SK_{(y)302S(y)303} of the first special subset SS_{P(y)302S(y)303}.

In general, LABEL_{i,j} used in the following description is used for computing the subset key SK_{i,j} of a subset S_{i,j} of a node j with a node i serving as a start node as described earlier.

The processing described above can be summarized as follows. x₁ of the (2N−1) C-bit values x₁, x₂, . . . , and x_{2N-1} computed for the nodes 1 to (2N−1) in accordance with the algorithm explained earlier by referring to the flowchart shown in FIG. 28 is used as LABEL_{1,φ}, which is the label of the second special subset SS_{1,φ} including all receivers and used for a no-revocation case with no receivers revoked. The remaining values x_{y} for nodes y are each used as LABEL_{P(y)S(y)}, which is the label of parent-sister nodes with the nodes P(y) and S(y) serving as respectively the parent and sister nodes of the node y where y=2, 3, . . . , and (2N−1). That is to say,

LABEL_{1,φ}=x₁
For y=1, 2, . . . , and (N−1),

LABEL_{y,2y}=x_{2y+1} and

LABEL_{y,2y+1}=x_{2y}

Every node except the root is a sister node of the other node sharing the same parent node as the sister node. Thus, as described above, each value x_{y} is used as the label for a parent node and a sister node, which can be any node included in the 2-branch one-way hierarchical tree. The following description explains concrete assignment of values x_{y} to labels of nodes included in the 2-branch one-way hierarchical tree.

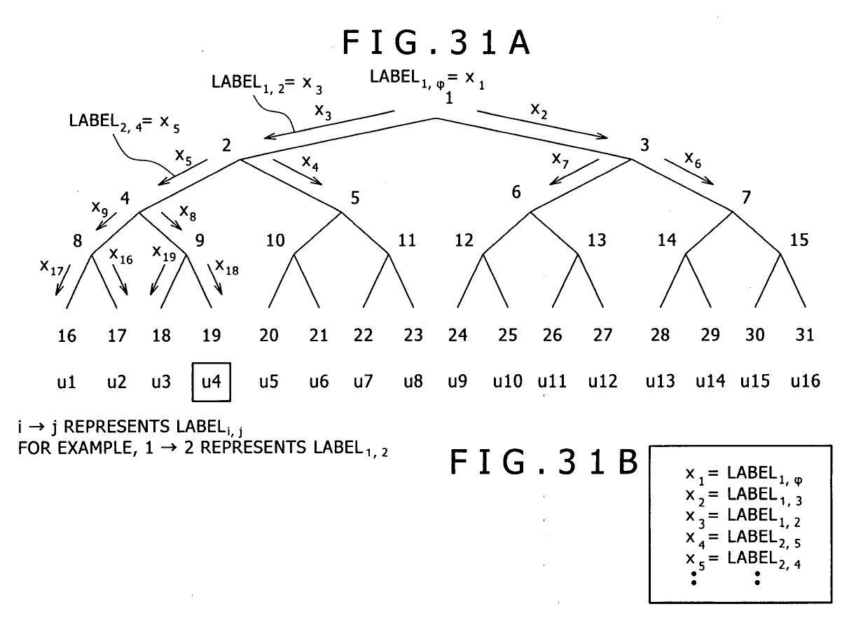

FIG. 31A shows:
(a): LABEL_{1,φ} of the second special subset SS_{1,φ} for the entire tree including all receivers and used for a no-revocation case in which no receiver is revoked.
(b): Relations between LABEL_{i,j} for the first special subset SS_{i,j} of every parent-child nodes i and j with the nodes i and j being respectively the parent and sister nodes of a node j where j=2, 3, . . . , and (2N−1) and the (2N−1) C-bit values xⱼ, i.e., x₂, x₃, . . . , and x_{2N-1} computed for the nodes 2 to (2N−1) in accordance with the algorithm explained earlier by referring to the flowchart shown in FIG. 28.

As shown in FIG. 31B, the (2N−1) C-bit values x₁, x₂, . . . and x_{2N-1} are used as labels as follows:

x₁ used as LABEL_{1,φ}

x₂ used as LABEL_{1,3}

x₃ used as LABEL_{1,2}

x₄ used as LABEL_{2,5}

x₅ used as LABEL_{2,4}

.

.

.

x₃₀ used as LABEL_{15,31}

x₃₁ used as LABEL_{15,30}

As described above, at the step 2, the TC (trusted center):
(a): uses the value x₁ of the (2N−1) C-bit values x₁, x₂, . . . , and x_{2N-1} computed for the nodes 1 to (2N−1) in accordance with the algorithm explained earlier by referring to the flowchart shown in FIG. 28 as LABEL_{1,φ}, which is the label of the second special subset SS_{1,φ} for the entire tree including all receivers and used for a no-revocation case, that is, a case with no receivers revoked.
(b): determines relations between LABEL_{i,j} for every first special subset SS_{i,j} of parent-sister nodes i and j with the nodes i and j being respectively the parent and sister nodes of the node j and the 2(N−1) C-bit values xⱼ (i.e., the values x₂, x₃, . . . , and x_{2N+1}) and then uses the value xⱼ as LABEL_{i,j} where j=2, 3, . . . , and (2N−1)

c: Step 3

Then, the TC (trusted center) supplies LABEL_{i,j} of the first special subset SS_{i,j} of parent-sister nodes i and j with the nodes i and j being respectively the parent and sister nodes of a node y to the pseudo random number generator G in order to find LABEL_{i,LC(j)} of the child node on the left side and LABEL_{i,RC(j)} of the child node on the right side with the node i used as a starting node.

That is to say, with C-bit LABEL_{i,j} of the first special subset SS_{i,j} supplied to the pseudo random number generator G, the pseudo random number generator G outputs a 3C-bit pseudo random number including C-bit G_{L}(LABEL_{i,j}) on the most significant-bit side of the pseudo random number. C-bit G_{L}(LABEL_{i,j}) is used for generating LABEL_{i,LC(j)} of a subset S_{i,LC(j)} for the child node LC(j) on the left side of the node j with the node i used as a starting node. Since the node LC(j) is a grandchild node of the node i, this subset S_{i,LC(j)} is not a special subset though. By the same token, with C-bit LABEL_{i,j} of the first special subset SS_{i,j} supplied to the pseudo random number generator G, the pseudo-random number generator G outputs a 3C-bit pseudo random number including C-bit G_{R}(LABEL_{i,j}) on the least significant-bit side of the pseudo random number. C-bit G_{R}(LABEL_{i,j}) is used for generating LABEL_{i,RC(j)} of a subset S_{i,RC(j)} for the child node RC(j) on the right side of the node j with the node i used as a starting node. Since the node RC(j) is a grandchild node of the node i, this subset S_{i,RC(j)} is not a special subset either. The above processing to set labels is summarized as follows:

LABEL_{i,LC(j)}=G_{L}(LABEL_{i,j})

LABEL_{i,RC(j)}=G_{R}(LABEL_{i,j})

Thereafter, LABEL_{i,LC(j)} and LABEL_{i,RC(j)} are each supplied to the pseudo random number generator G in an repetitive manner to find labels of all offspring nodes of the node j. These repetitive operations are carried out for the label of each special subset SS_{i,j} to find labels of all subset S_{i,j} defined at the step 1.

(d): Step 4

Next, the TC (trusted center) determines labels to be given to a receiver um. That is to say, the TC (trusted center) determines labels to be held and utilized by the receiver um.

First of all, labels to be given to the receiver um are selected as tentatively selected labels. As described before, for every internal node i on a path (referred to as path-m) from the leaf associated with the receiver um to the root, the tentatively selected labels are LABEL_{i,j} of a subset S_{i,j} with an internal node i used as a starting minuend node and a node j serving as a subtrahend node, which is a direct-branch node from a partial path from the leaf to the internal node i on the path. The tentatively selected labels also include LABEL_{1,φ} of the second special subset SS_{1,φ} described above.

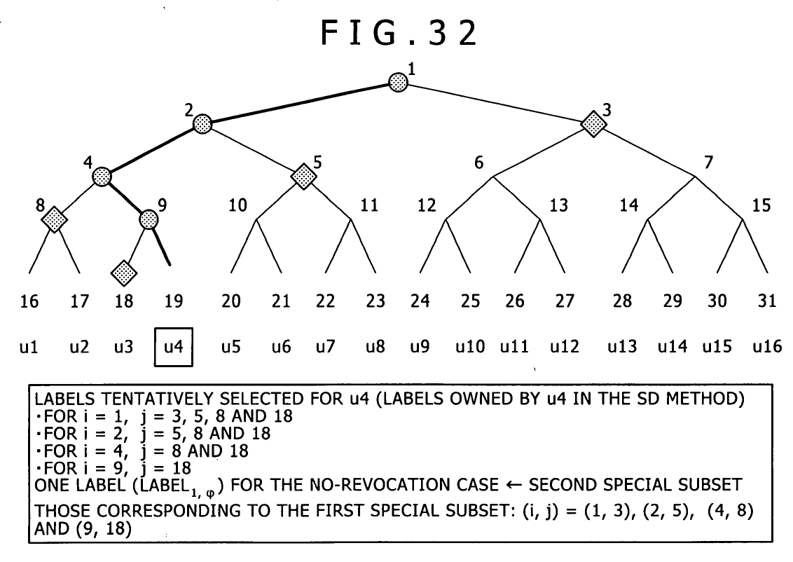

The processing to select labels to be given to a receiver from the tentatively selected labels is explained by referring to FIG. 32 and subsequent figures. For example, 11 tentatively selected labels to be provided to the receiver u4 associated with a leaf indicated by a node number of 19 shown in FIG. 32 are listed as follows:

LABEL_{1,3}

LABEL_{1,5}

LABEL_{1,8}

LABEL_{1,18}

LABEL_{2,5}

LABEL_{2,8}

LABEL_{2,18}

LABEL_{4,8}

LABEL_{4,18}

LABEL_{9,18}

LABEL_{1,φ}

The TC (trusted center) then reselects labels to be provided to the receiver u4 from the tentatively selected labels on the above list as follows.

The above list of tentatively selected labels includes 4 labels of first special subsets SS_{i,j}. The 4 labels of first special subsets are listed as follows:

LABEL_{1,3}

LABEL_{2,5}

LABEL_{4,8}

LABEL_{9,18}

As described earlier, a first special subset SS_{i,j} is a subset of a parent node i and a child node j of the parent node i.

The TC (trusted center) determines labels to be provided to a receiver um associated with a leaf serving as a terminal node in the 2-branch one-way hierarchical tree where m=1, 2, . . . , and N in accordance with the following rules.

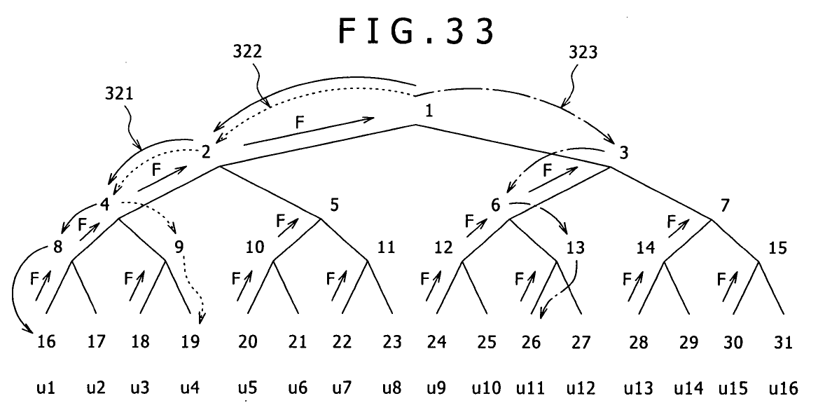

In the case of a 2-branch one-way hierarchical tree like one shown in FIG. 33, for example, 16 receivers u1 to u16 are associated with leaves indicated by node numbers y of 16 to 31 respectively.

A path from a leaf associated with a receiver um to the root is referred to as path-m of the receiver um. A set of nodes y on path-m of a receiver um is referred to as PathNodes-m of the receiver um.

In the example shown in FIG. 33:

PathNodes-1={1, 2, 4, 8, 16}

PathNodes-4={1, 2, 4, 9, 19}

PathNodes-11={1, 3, 6, 13, 26}

Solid lines 321 shown in FIG. 33 indicate path-1 of the receiver u1 and its PathNodes-1={1, 2, 4, 8, 16} on path-1. Dashed lines 322 indicate path-4 of the receiver u4 and its PathNodes-4={1, 2, 4, 9, 19} on path-4. Dotted lines 323 indicate path-11 of the receiver u11 and PathNodes-11={1, 3, 6, 13, 26} on path-4.

The TC (trusted center) reselects labels from tentatively selected labels explained above by referring to FIG. 32 for every receiver um, and confirms the reselected labels to be finally given to the receiver um. The reselected labels are tentatively selected labels satisfying conditions (a) or (b) described as follows:
(a): A reselected label is a tentatively selected label (LABEL_{i,j}), which shall be neither a label corresponding to the subset key of a first special subset SS_{i,j} nor a label corresponding the subset key of the second special subset SS_{1,φ}. As described earlier, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked.
(b): A reselected label is a tentatively selected label, which shall be a label corresponding to the subset key of a first special subset SS_{i,j} or the subset key of the second special subset SS_{1,φ}. As described earlier, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked. However, the tentatively selected label satisfying condition (b) must satisfy the following sub-conditions:
(b1): nodes y shall be included in PathNodes-m, and
(b2): nodes 2y shall not be included in PathNodes-m,
   where symbol y is the number of a node and a value x_{y} is used as the tentatively selected LABEL_{P(y),S(y)} as explained earlier by referring to FIGS. 31A and 31B.

Tentatively selected labels satisfying condition
(a) and tentatively selected labels satisfying condition
(b) are given to the receiver um.

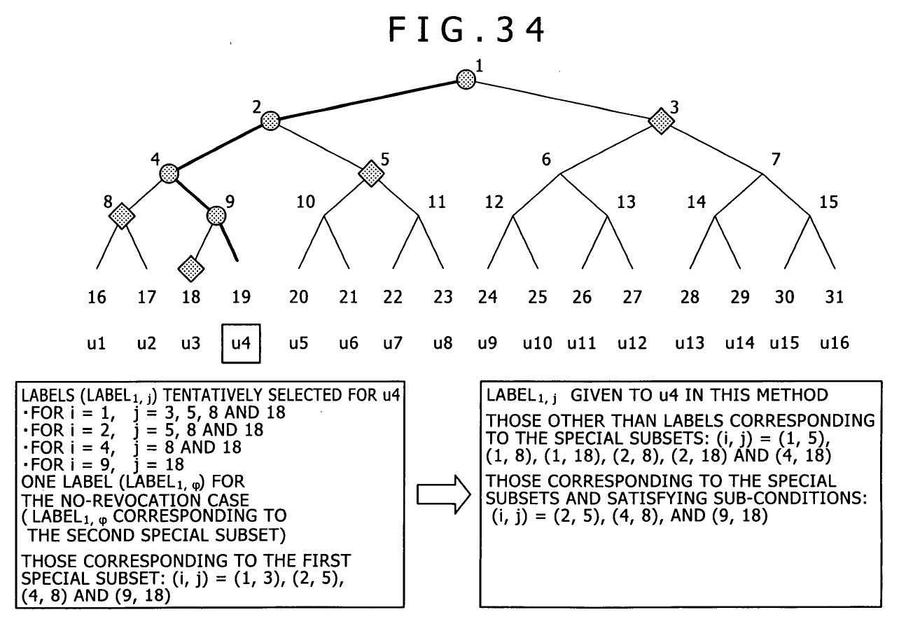

An example of a concrete process to select tentatively selected labels as labels to be given to the receiver u4 is explained by referring to FIG. 34 as follows. The receiver u4 associated with a leaf indicated by a node number of 19 in the 2-branch one-way hierarchical tree shown in FIG. 34 is chosen as a recipient of the tentatively selected labels to be reselected in this process. As described above, the tentatively selected labels are 11 labels on the following list:

LABEL_{1,3}

LABEL_{1,5}

LABEL_{1,8}

LABEL_{1,18}

LABEL_{2,5}

LABEL_{2,8}

LABEL_{2,18}

LABEL_{4,8}

LABEL_{4,18}

LABEL_{9,18}

LABEL_{1,φ}

The above list of tentatively selected labels is searched for labels satisfying condition (a). As described earlier, condition (a) states that a reselected label is a tentatively selected label, which shall be neither a label corresponding to the subset key of a first special subset SS_{i,j} nor a label corresponding to the subset key of the second special subset SS_{1,φ}. As described before, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked. In this case, labels satisfying condition (a) are listed as follows:

LABEL_{1,5}

LABEL_{1,8}

LABEL_{1,18}

LABEL_{2,8}

LABEL_{2,18}

LABEL_{4,18}

The 6 labels on the above list are thus selected as labels to be given to the receiver u4.

The list of tentatively selected labels is further searched for those satisfying condition (b), which states that the tentatively selected label shall be a label corresponding to the subset key of a first special subset SS_{i,j} or the subset key of the second special subset SS_{1,φ} and must satisfy the following sub-conditions:
(b1): nodes y shall be included in PathNodes-m and
(b2): nodes 2y shall not be included in PathNodes-m,
   where symbol y is the number of a node and a value x_{y} is used as the tentatively selected LABEL_{P(y),S(y)} as explained earlier by referring to FIGS. 31A and 31B.

As described above, FIG. 31A shows:
(a): LABEL_{1,φ} of the second special subset SS_{1,φ} for the entire tree including all receivers and used for a no-revocation case in which no receiver is revoked.
(b): Relations between LABEL_{P(y),S(y)} for the first special subset SS_{P(y),S(y)} of every parent-child nodes P(y) and S(y) with the nodes P(y) and S(y) being respectively the parent and sister nodes of a node y where y=2, 3, and (2N−1) and the (2N−1) C-bit values x_{y}, i.e., x₂, x₃, . . . , and x_{2N-1} computed for the nodes 2 to (2N−1) in accordance with the algorithm explained earlier by referring to the flowchart shown in FIG. 28.

As shown in FIG. 31B, the (2N−1) C-bit values x₁, x₂, . . . , and x_{2N-1} are used as labels as follows:

x₁ used as LABEL_{1,φ}

x₂ used as LABEL_{1,3}

x₃ used as LABEL_{1,2}

x₄ used as LABEL_{2,5}

x₅ used as LABEL_{2,4}

.

.

.

x₃₀ used as LABEL_{15,31}

x₃₁ used as LABEL_{15,30}

In the 2-branch one-way hierarchical tree shown in FIG. 34, path-4 from a leaf identified by a node number of 19 to the roof is a path 322 shown in FIG. 33 for the receiver u4 associated with the leaf. This path corresponds to PathNodes-4={1, 2, 4, 9, 19}.

Node numbers y each satisfying the following sub-conditions are then searched for.
(b1): Nodes y shall be included in PathNodes-m
(b2): Nodes 2y shall not be included in PathNodes-m.

In the case of the receiver u4, PathNodes-m is PathNodes-4={1, 2, 4, 9, 19} cited above. Node numbers y each satisfying sub-condition (b1) are node numbers 1, 2, 4, 9 and 19 included in PathNodes-4. Node numbers y satisfying sub-condition (b2) stating that node numbers 2y shall not be included in PathNodes-4 are 4, 9 and 19. That is to say, node numbers 1 and 2 are excluded because they do not satisfy sub-condition (b2). This is because, for y=1, the node number of 2y (=2×1=2) is included in PathNodes-4={1, 2, 4, 9, 19} and, by the same token, for y=2, the node number of 2y (=2×2=4) is also included in PathNodes-4={1, 2, 4, 9, 19}.

In the case of the receiver u4, the following sub-conditions must be satisfied:
(b1): Nodes y shall be included in PathNodes-m
(b2): Nodes 2y shall not be included in PathNodes-m.

Thus, only nodes 4, 9 and 19 having node numbers of 4, 9 and 19 satisfy above sub-conditions (b1) and (b2).

As described above, the node numbers y of 4, 9 and 19 satisfy sub-conditions (b1) and (b2). The node numbers y of 4, 9 and 19 correspond to respectively values x₄, x₉ and x₁₉, which are used as labels as follows:

x₄ used as LABEL_{2,5}

x₉ used as LABEL_{4,8} and

x₁₉ used as LABEL_{9,18}

Thus, satisfying condition (b), the labels listed above are determined as labels to be given to the receiver u4.

As a result, the receiver u4 is provided with 6 labels each satisfying condition (a) and 3 labels each satisfying condition (b). As described above, the 6 labels each satisfying condition (a) are listed as follows:

LABEL_{1,5}

LABEL_{1,8}

LABEL_{1,18}

LABEL_{2,8}

LABEL_{2,18}

LABEL_{4,18}

On the other hand, the 3 labels each satisfying condition (b) are listed as follows:

LABEL_{2,5} set at x₄,

LABEL_{4,8} set at x₉ and

LABEL_{9,18} set at x₁₉.

Thus, the receiver u4 is provided with a total of 9 labels.

Traditionally, in accordance with the original SD method, a receiver um is provided with the so-called tentatively selected labels each named LABEL_{i,j} corresponding to the subset key of a subset S_{i,j} of a node j with any specific internal node i used as a starting node. The node j is a direct-branch node from a partial path from a leaf associated with the receiver um to the specific internal node i located on-path-m, which is a path from the leaf to the root. The tentatively selected labels provided to the receiver um also includes LABEL_{i,φ} corresponding to the subset key of the second special subset SS_{1,φ}. In the case of the receiver u4, as explained earlier by referring to FIG. 32, the tentatively selected labels given to the receiver u4 are the 11 labels on the following list:

LABEL_{1,3}

LABEL_{1,5}

LABEL_{1,8}

LABEL_{1,18}

LABEL_{2,5}

LABEL_{2,8}

LABEL_{2,18}

LABEL_{4,8}

LABEL_{4,18}

LABEL_{9,18}

LABEL_{1,φ}

In accordance with the method provided by the present invention, however, as described above, labels given to the receiver u4 can be reduced to 9 labels satisfying condition (a) or (b). The 6 labels each satisfying condition (a) are listed below:

LABEL_{1,5}

LABEL_{1,8}

LABEL_{1,18}

LABEL_{2,8}

LABEL_{2,18}

LABEL_{4,18}

On the other hand, the 3 labels each satisfying condition (b) are listed as follows:

LABEL_{2,5} set at x₄,

LABEL_{4,8} set at x₉ and

LABEL_{9,18} set at x₁₉.

In accordance with the method provided by the present invention, 2 labels, i.e., LABEL_{1,3} and LABEL_{1,φ}, are excluded from the list of labels tentatively selected for the receiver u4 as described above. This is because, LABEL_{1,3} and LABEL_{1,φ} are labels for special subsets SS_{1,3} and SS_{1,φ} which naturally do not satisfy condition a. As described above, however, these labels for the special subsets do not satisfy condition b either. Nevertheless, the receiver u4 is capable of finding the values of LABEL_{1,3} and LABEL_{1,φ} from the value of another labels given to the receiver u4. To put it in detail, LABEL_{1,3} and LABEL_{1,φ} have the values x₂ and x₁ respectively as described above. By the way, the receiver u4 holds the value x₄ of LABEL_{2,5} given to the receiver u4. Thus, the receiver u4 is capable of finding the values x₂ and x₁ of LABEL_{1,3} and LABEL_{1,φ} respectively from the value x₄ of LABEL_{2,5} given to the receiver u4 by using the following equation based on the algorithm explained earlier by referring to the flowchart shown in FIG. 28. As described above, the equation is used to find (2N−1) C-bit values xᵢ, x₂, . . . , and x_{2N-1} for their respective nodes.
x_{i/2}=F(xᵢ)

Thus, the receiver u4 is capable of finding the values x₂ and x₁ of LABEL_{1,3} and LABEL_{1,φ} respectively from the value x₄ of LABEL_{2,5} given to the receiver u4 by using the following equations:
LABEL_{1,3}=x₂=F(x₄)
LABEL_{1,φ}=xᵢ=F(x₂)

Details of the above processing will be described later.

In the case of the receiver u1 associated with a node number or 16 in the 2-branch one-way hierarchical tree shown in FIG. 34, on the other hand, the tentatively selected labels given to the receiver u1 are 11 labels on the following list:

LABEL_{1,3}

LABEL_{1,5}

LABEL_{1,9}

LABEL_{1,17}

LABEL_{2,5}

LABEL_{2,9}

LABEL_{2,17}

LABEL_{4,9}

LABEL_{4,17}

LABEL_{8,17}

LABEL_{1,φ}

First of all, the above list of tentatively selected labels is searched for labels satisfying condition (a). As described earlier, condition (a) states that a reselected label is a tentatively selected label, which shall be neither a label corresponding to the subset key of a first special subset SS_{i,j} nor a label corresponding to the subset key of the second special subset SS_{1,φ}. As described before, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked. In this case, 6 labels satisfying condition (a) are listed as follows:

LABEL_{1,5}

LABEL_{1,9}

LABEL_{1,17}

LABEL_{2,9}

LABEL_{2,17}

LABEL_{4,17}

The 6 labels on the above list are thus selected as labels to be given to the receiver u4.

The list of tentatively selected labels is further searched for those satisfying condition (b), which states that the tentatively selected label shall be a label corresponding to the subset key of a first special subset SS_{i,j} or the subset key of the second special subset SS_{1,φ} and must satisfy the following sub-conditions:
(b1): nodes y shall be included in PathNodes-m and
(b2): nodes 2y shall not be included in PathNodes-m,
   where symbol y is the number of a node and a value x_{y} is used as the tentatively selected LABEL_{P(y),S(y)} as explained earlier by referring to FIG. 31.

In the 2-branch one-way hierarchical tree shown in FIG. 34, path-1 from a leaf identified by a node number of 16 to the roof is a path 321 shown in FIG. 33 for the receiver u1 associated with the leaf. This path corresponds to PathNodes-1={1, 2, 4, 8, 16}.

Node numbers y each satisfying the following sub-conditions are then searched for.
(b1): Nodes y shall be included in PathNodes-m
(b2): Nodes 2y shall not be included in PathNodes-m.

In this case, only the node number y of 16 satisfies the above sub-conditions.

By the way, the value x₁₆ corresponding to the node number y of 16 is used as LABEL_{8,17}. Thus, satisfying condition (b), the LABEL_{8,17} is determined as a label to be given to the receiver u1.

As a result, the receiver u1 is provided with 6 labels each satisfying condition (a) and 1 label satisfying condition (b). As described above, the 6 labels each satisfying condition (a) are listed as follows:

LABEL_{1,5}

LABEL_{1,9}

LABEL_{1,17}

LABEL_{2,9}

LABEL_{2,17}

LABEL_{4,17}

On the other hand, the label satisfying condition (b) is LABEL_{8,17} set at x₁₆.

Thus, the receiver u1 is-provided with a total of 7 labels.

Traditionally, in accordance with the original SD method, a receiver urn is provided with the so-called tentatively selected labels each named LABEL_{i,j} corresponding to the subset key of a subset S_{i,j} of a node j with any specific internal node i used as a starting node. The node j is a direct-branch node from a partial path from a leaf associated with the receiver um to the specific internal node i located on path-m, which is a path from the leaf to the root. The tentatively selected labels provided to the receiver um also includes LABEL_{1,φ} corresponding to the subset key of the second special subset SS_{1,φ}. In the case of the receiver u1, as explained earlier by referring to FIG. 32, the tentatively selected labels given to the receiver u1 are the 11 labels on the following list:

LABEL_{1,3}

LABEL_{1,5}

LABEL_{1,9}

LABEL_{1,17}

LABEL_{2,5}

LABEL_{2,9}

LABEL_{2,17}

LABEL_{4,9}

LABEL_{4,17}

LABEL_{8,17}

LABEL_{1,φ}

In accordance with the method provided by the present invention, however, as described above, labels given to the receiver u1 can be reduced to only 7 labels satisfying condition (a) or (b).

That is to say, in accordance with the method provided by the present invention, 4 labels are excluded from the list of tentatively selected labels to be given to the receiver u1 as described above. The 4 labels are listed as follows:

LABEL_{4,9}

LABEL_{2,5}

LABEL_{1,3}

LABEL_{1,φ}

This is because, the above are labels for special subsets which naturally do not satisfy condition a. As described above, however, these labels for the special subsets do not satisfy condition b either. Nevertheless, the receiver u1 is capable of finding the values of the labels on the above list from the value of another label given to the receiver u1. To put it in detail, the labels on the above list have-the following values as described above:

LABEL_{4,9}=x₈,

LABEL_{2,5}=x₄,

LABEL_{1,3}=x₂ and

LABEL_{1,φ}=x₁

By the way, the receiver u1 holds the value x₁₆ of LABEL_{8,17} given to the receiver u1. Thus, the receiver u1 is capable of finding the values x₈, x₄, x₂ and x₁ of the labels on the above list from the value x₁₆ of LABEL_{8,17} given to the receiver u1 by using the following equation based on the algorithm explained earlier by referring to the flowchart shown in FIG. 28 . As described above, the equation is used to find (2N−1) C-bit values xᵢ, x₂, . . . , and x_{2N-1} for their respective nodes.
x_{i/2}=F(xᵢ)

Thus, the receiver u1 is capable of finding the values x₈, x₄, x₂ and x₁ of the labels on the above list from the value x₁₆ of LABEL_{8,17} given to the receiver u1 by using the following equations:
LABEL_{4,9}=x₈=F(x₁₆)
LABEL_{2,5}=x₄=F(x₈)
LABEL_{1,3}=x₂=F(x₄)
LABEL_{1,φ}=x₁=F(x₂)

It is to be noted that the number of tentatively selected labels and the number of tentatively selected labels other than those used for computing the subset keys of the special subsets do not vary from receiver to receiver. That is to say, the number of tentatively selected labels and the number of tentatively selected labels other than those used for computing the subset keys of the special subsets are uniform for all values of subscript m of the receiver number um. In the case of a 2-branch one-way hierarchical tree having 16 leaves each associated with one of 16 receivers as shown in FIG. 34, the number of tentatively selected labels is 11 and the number of tentatively selected labels other than those used for computing the subset keys of the special subsets is 6 without regard to the receiver um.

As described above, in the processing to give labels to a receiver um in accordance with the method provided by the present invention, a label used for computing a subset key of a special subset and has a value x_{y} of a leaf y associated with the receiver um is always given to the receiver. For example, the LABEL_{9,18} having the value x₁₉ is always given to the receiver u4 and LABEL_{8,17} having the value x₁₆ is always given to the receiver u1. Assume that a root from the leaf to the root is traced in an upward direction layer after layer. In this case, the upward movement from a layer to the layer at the next higher level can be made in the left-upward or right-upward movement. The label used for finding the subset key of a subset for a node at the end of the left-upward movement is also given to the receiver um.

As is obvious from the above description, the number of labels given to a receiver urn as labels each used for finding the subset key of a special subset changes in accordance with the number of nodes, which are each located at the end of a left-upward movement and included in path-m of the receiver um. The number of nodes located at the end of a upward movement is log N where N is the number of leaves but not all such nodes are located at the end of a left-upward movement. Consider path-m of a receiver um of a complete 2-branch one-way hierarchical tree having N leaves. A bit expression of path-m can be represented by a bit string {0, 1}^{log N}. The bit string {0, 1}^{log N} is a string of bits of ‘0’ and ‘1’ where log N is the number bits in the string. Bits 0 and 1 represent an upward tracing in the right direction and an upward tracing in the left direction respectively. For N=16, the number of bits in the string of bits is 4 (=log N). Thus, path-m can be expressed by bit strings ranging from ‘0000’ to ‘1111’.

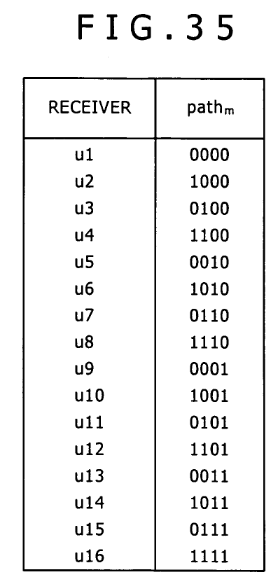

As an example, bit expressions each representing path-m for each of the 16 receivers u1 to u16 shown in FIG. 33 are shown in FIG. 35.

For example, path-1 from the receiver u1 to the root is expressed as ‘0000’ because of the following reasoning. Refer back to FIG. 33. As shown in the figure, path-1 from the receiver u1 to the root consists of 4 right-upward paths, i.e., a path 16→8, a path 8→4, a path 4→2 and a path 2→1. If a right-upward path is expressed by a 0 bit, path-1 from the receiver u1 to the root is thus expressed by ‘0000’.

As another example, path-2 from the receiver u2 to the root is expressed as ‘1000’ because of the following reasoning. Refer back to FIG. 33. As shown in the figure, path-2 from the receiver u2 to the root consists of 1 left-upward path , i.e. a path 17→8 and 3 right-upward paths, i.e., a path 8→4, a path 4→2 and a path 2→1. If a left-upward path is expressed by a 1 bit, path-2 from the receiver u2 to the root is thus expressed by ‘1000’.

The remaining paths, that is, path-m where m=3 to 16, of the receivers 3 to 16 shown in FIG. 33 can each be expressed by a string of bits in the same way.

FIG. 35 is a diagram showing a relation between the bit expressions of paths m for the 16 receivers u1 to u16 shown in FIG. 33 and labels held by the receivers u1 to u16 as labels each used for finding the subset key of a special subset. As shown in FIG. 35, the bit expressions of paths m for the 16 receivers u1 to u16 are expressed by respectively 16 bit strings in the range 0000 to 1111.

A weight of path-m is defined as a 1 bit included in the bit string expressing path-m.

In the configuration of the present invention, as described above, final labels given to a receiver um are labels each not used for finding the subset key of a special subset in conformity with condition (a) described above and labels reselected in conformity with condition (b) described above from those each used for computing the subset key of a special subset. The labels reselected in conformity with condition (b) described above from those each used for finding the subset key of a special subset includes the following labels.

As described above, a label having a value equal to X_{y}, that is, LABEL_{P(y),S(y)}=x_{y}, where subscript y is the node number of a leaf (also referred to as a terminal node) associated with a receiver um is always given to the receiver um. In general, notation P(i) denotes the node number of a node serving-as the parent node of a node i whereas notation S(i) denotes the node number of a node serving as the sister node of the node i.

In addition to LABEL_{P(y),S(y)} described above, a receiver um is provided with as many labels as weights in path-m of the receiver um as labels reselected from those each used for finding the subset key of a special subset in conformity with condition (b) described above. The weights in path-m of the receiver um are each a 1 bit included in the bit string expressing path-m as described above. Since the label having a value equal to X_{y}, that is, LABEL_{P(y),S(y)}=x_{y}, where subscript y is the node number of a leaf (also referred to as a terminal node) associated with the receiver um cannot be found from another value, it is necessary to keep in mind that this label is always given directly to the receiver um and stored in the receiver um.

As an example, consider the configuration of a 2-branch one-way hierarchical tree shown in FIG. 33 and refer to FIG. 35, which is a diagram showing receivers um each associated with the bit expression of path-m of the receiver um. As shown in FIG. 35, the receiver u1 is associated with a bit expression of all zeros. In this case, the receiver u1 is given only LABEL_{8,17} (=x₁₆, which is a value assigned to a terminal node indicated by a node number of 16 as a leaf associated with the receiver u1). The receiver u1 is not provided with other levels except LABEL_{8,17}.

There are (log N) receivers each associated with a bit expression including only one 1 bit. For N=16, there are thus 4 such receivers, i.e., the receivers u2, u3, u5 and u9. Such receivers are each provided with a label in addition to the label having a value equal to X_{y}, that is, LABEL_{P(y),S(y)}=x_{y}, where subscript y is the node number of a leaf associated with the receiver. A leaf associated with a receiver um is also referred to as a self node.

In general, the number of receivers each provided with j labels, where j=0, 1, . . . , and log N, in addition to the label having a value equal to X_{y}, that is, LABEL_{P(y),S(y)}=x_{y}, where subscript y is the node number of a leaf associated with the receiver, is expressed by the following equation:

$$( \begin{matrix}log N \\ j\end{matrix} ) \qquad ( 6 )$$

It is to be noted that the above equation is an equation representing a number as a function of j where j=0, 1, . . . , and log N.

To put it concretely, consider the 2-branch one-way hierarchical tree shown in FIG. 33 for which N=16. In this case, as described above, every receiver um is provided with is as many labels as j weights where j has a value in the range 0 to 4 (=log 16) in addition to the label having a value equal to X_{y}, that is, LABEL_{P(y),S(y)}=x_{y}, where subscript y is the node number of a leaf associated with the receiver.

For j=0, only the label having a value equal to X_{y}, that is, LABEL_{P(y),S(y)}=x_{y}, where subscript y is the node number of a leaf associated with the receiver itself is given to the receiver um.

For j=1, in addition to the label having a value equal to X_{y}, that is, LABEL_{P(y),S(y)}=x_{y}, where subscript y is the node number of a leaf associated with the receiver itself, another label is provided to the receiver. In this case, 4 receivers, i.e., the receivers u2, u3, u5 and u9, are each provided with LABEL_{P(y),S(y)} and the other label.

For j=2, in addition to the label having a value equal to X_{y}. that is, LABEL_{P(y),S(y)}=x_{y}, where subscript y is the node number of a leaf associated with the receiver itself, 2 other labels are provided to the receiver. In this case, 6 receivers, i.e., the receivers u4, u6, u7, u10, u11 and u13, are each provided with LABEL_{P(y),S(y)} and the other labels.

For j=3, in addition to the label having a value equal to X_{y}, that is, LABEL_{P(y),S(y)}=x_{y}, where subscript y is the node number of a leaf associated with the receiver itself, 3 other labels are provided to the receiver. In this case, 4 receivers, i.e., the receivers u8, u12, u14 and u15, are each provided with LABEL_{P(y),S(y)} and the other labels.

For j=4, in addition to the label having a value equal to X_{y}, that is, LABEL_{P(y),S(y)}=x_{y}, where subscript y is the node number of a leaf associated with the receiver itself, 4 other labels are provided to the receiver. In this case, the only receiver u16 is provided with LABEL_{P(y),S(y)} and the other labels.

It is to be noted that a receiver is always provided with the label having a value equal to X_{y}, that is, LABEL_{P(y),S(y)}=x_{y}, where subscript y is the node number of a leaf associated with the receiver itself. This receiver provided with only the label having a value equal to X_{y}, that is, LABEL_{P(y),S(y)}=x_{y}, where subscript y is the node number of a leaf associated with the receiver itself is the receiver u1 corresponding to j=0 described above.

As described above, in the configuration for setting labels for every node in accordance with the present invention, as labels reselected from those each used for finding the subset key of a special subset in conformity with condition (b) described above, every receiver associated with a leaf is provided with j labels in addition to the label having a value equal to X_{y}, that is, LABEL_{P(y),S(y)}=x_{y}, where subscript y is the node number of the leaf serving as the self node of the receiver. That is to say, every receiver needs only to hold (j+1) labels, that are reselected from those each used for finding the subset key of a special subset in conformity with condition (b) described above where j is the number of nodes i satisfying sub-conditions (b1) and (b2) described above but not including the leave itself. Since the number of nodes existing on path-m but not including the leave itself is log N, j has a value in the range 0 to log N, inclusive.

As described earlier, in accordance with the conventional SD (subset difference) method, the number of labels each used for finding the subset key of a special subset to be given to every receiver is log N+1 where symbol N denotes the number of receivers.

The number of labels each used for finding the subset key of a special subset to be given to a receiver in the SD method is computed as follows. For a receiver, the number of first special subsets S_{i,j} with nodes i and j serving as parent and child nodes respectively is the same as the number of internal nodes existing on a path from a leaf associated with the receiver to the root. This is because each of the special subsets S_{i,j} is a special subset with an internal node on the path serving as the parent node i and the other child node of the internal node serving as the child node j. By the other child node of an internal node, the child node existing outside the path as a child of the parent node is meant.

Thus, the number of labels each used for finding the subset key of a first special subset to be given to a receiver in the SD method is log N. In addition, as explained earlier, the second special subset S_{1,φ} is used for a no-revocation case in which no receivers are revoked. Thus, LABEL_{1,φ} used for finding the subset key SK_{1,φ} of the second special subset S_{1,φ} is also given to every receiver. That is to say, each receiver always holds LABEl_{1,φ}. As a result, the number of labels each used for finding the subset key of a first special subset or the second special subset S_{1,φ} to be given to a receiver in the SD method is log N+1.

In accordance with this method, on the other hand, the number of labels given to a receiver as labels each used for finding the subset key of a special subset every receiver in a 2-branch one-way hierarchical tree with N laves is j+1 as described above.

Thus, by adopting the method provided by the present invention, the number of labels each used for finding the subset key of a first special subset or the second special subset S_{1,φ} to be given to a receiver can be reduced by (log N+1)−(j+1)=log N−j.

However, the value of each label eliminated from those supposed to be given to a receiver can be found from the value held by the receiver by applying the one-way function F.

By the way, pay attention to the following equation:

$$( \begin{matrix}log N \\ j\end{matrix} ) = ( \begin{matrix}log N \\ log N - j\end{matrix} ) \qquad ( 7 )$$

That is to say, in a 2-branch hierarchical tree with N receivers, the number of receivers for which j labels can be eliminated is expressed by the following equation:

$$( \begin{matrix}log N \\ j\end{matrix} ) \qquad ( 8 )$$

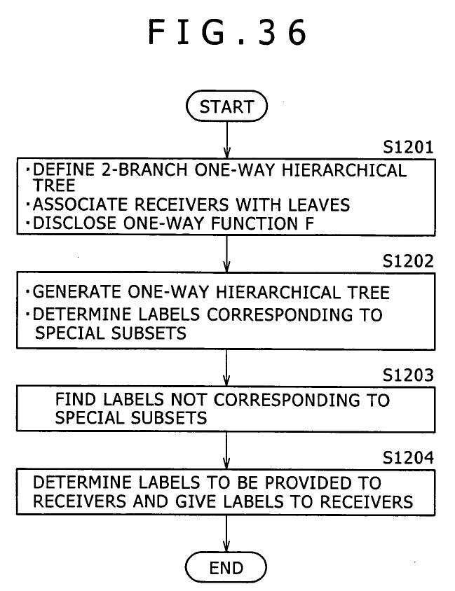

FIG. 36 shows a flowchart representing the setup processing described above. Steps of the flowchart shown in FIG. 36 are explained as follow.

As shown in the figure, the flowchart begins with a step S1201 at which the TC (trusted center) defines a 2-branch one-way hierarchical tree having N leaves. A node number of 1 is assigned to the node on the hierarchical layer at the highest level to serve as the root of the 2-branch one-way hierarchical tree. On the other hand, node numbers of 2, 3, . . . , and (2N−1) are assigned to nodes on the lower-level hierarchical layers of the 2-branch hierarchical tree in the breadth first order described earlier. The result of the assignment of the node numbers is shown in FIGS. 33 and 34.

Then, the TC (trusted center) associates each of receivers um where m=1, 2, . . . , and N with one of the leaves of the 2-branch hierarchical tree. In addition, the TC (trusted center) selects and reveals a one-way function F having an output of C bits. In this case, C is any arbitrary number. An existing hash function can be used as the one-way function F. Examples of the existing hash function are MD4, MD5 and SHA-1.

Subsequently, the TC (trusted center) defines subsets in the 2-branch one-way hierarchical tree having N leaves. As explained earlier by referring to FIG. 20, a subset S_{i,j} of leaves for a node j with a node i used as a staring point in a 2-branch one-way hierarchical tree is defined as a difference leaf set obtained by subtracting a partial tree having the node j at its vertex from a partial tree having the node i serving as an ancestor node of the node j at its vertex.

Then, at the next step S1202, the TC (trusted center) computes node-associated values xᵢ of nodes i composing the 2-branch one-way hierarchical tree with N leaves in accordance with the algorithm explained earlier by referring to the flowchart shown in FIG. 28. In the process to compute the node-associated values xᵢ of nodes i composing the 2-branch one-way hierarchical tree, the following inputs are used.
(a): N representing the number of leaves included in the 2-branch one-way hierarchical tree and
(b): the one-way function F having an output of C bits.

The result of the process is (2N−1) C-bit values xᵢ, x₂, . . . , and x_{2N-1} for all the nodes including the leaves in the 2-branch one-way hierarchical tree.

The TC (trusted center) takes each of the (2N−1) C-bit values xᵢ, x₂, . . . , and x_{2N-1} obtained as the result of the above process as the label to be used for computing the-subset key of one of the subsets defined at the step S1201.

To put it in detail, xᵢ of the (2N−1) C-bit values xᵢ, x₂, . . . , and x_{2N-1} obtained as the result of the above process based on the algorithm explained earlier by referring the flowchart shown in FIG. 28 is used as LABEL_{1,φ} to be used for computing the subset key of the second special subset SS_{1,φ} for a no-revocation case in which no receivers are revoked. On the other hand, the other values xⱼ, i.e., x₂, x₃, . . . , and x_{2N-1} are each used as LABEL_{P(i),S(j)} of a first special subset SS_{i,j} where j=2, 3, . . . , and (2N−1). As described above, a first special subset SS_{i,j} is a subset of a node j serving as a child node of a parent node i with the node i used as a starting node. To put it more concretely,

LABEL_{1,φ}=x₁

LABEL_{y,2y}=x_{2y+1}

LABEL_{y,2y+1}=x_{2y}

The above list is generalization of a concrete list shown in FIG. 31A.

Then, at the next step S1203, labels each not used for finding the subset key of a special subset are found. In this case, the TC (trusted center) supplies LABEL_{i,j} of a first special subset SS_{i,j} of a node j serving as a child node of a parent-node i with the node i used as a starting node to the pseudo random number generator G to find LABEL_{i,LC(j)} and LABEL_{i,RC(j)} of the child nodes of the node j with the node i used as a starting node.

The TC (trusted center) supplies C-bit LABEL_{i,j} to the pseudo random number generator G. The 3C-bit output of the pseudo-random-number generator G is delimited into 3 C-bit portions starting from the left side (or the side of the most significant bit). The resulting 3 portions each having a length of C bits are referred to as respectively G_{L}(LABEL_{i,j}) on the left side, G_{M}(LABEL_{i,j}) in the middle and G_{R}(LABEL_{i,j}) on the right side, which are used as follows:

G_{L}(LABEL_{i,j}) is used as LABEL_{i,LC(j)} to be used for finding the subset key SK_{i,LC(j)} of the subset S_{i,LC(j)} for a left-side child node LC(j) of the node j with the node i used as a starting node. This subset S_{i,LC(j)} is thus not a special subset because the left-side child node LC(j) is a grandchild node of the node i.

G_{R}(LABEL_{i,j}) is used as LABEL_{i,RC(j)} to be used for finding the subset key SK_{i,RC(j)} of the subset S_{i,RC(j)} for the right-side child node RC(j) of the node with the node i used as a starting node. This subset S_{i,RC(j)} is thus not a special subset either because the left-side child node RC(j) is a grandchild node of the node i.

The above 2 operations can be expressed by the following statements:

LABEL_{i,LC(j)}=G_{L}(LABEL_{i,j}) and

LABEL_{i,RC(j)}=G_{R}(LABEL_{i,j}).

Then, by supplying LABEL_{i,LC(j)} and LABEL_{i,RC(j)} to the pseudo random number generator G, labels of grandchild nodes of the node j can be found. These operations are carried out repeatedly to find labels of all offspring nodes of the node j with the node i used as a starting node from LABEL_{i,j}. The operations to find labels of all offsprings nodes from LABEL_{i,j} are carried out for LABEL_{i,j} of each all special subsets SS_{i,j} defined at the step S120.

Then, at the next step S1204, the TC (trusted center) determines labels to be given to every receiver um, that is, labels to be held by each receiver. The TC (trusted center) determines labels to be given to every receiver um in the way described earlier. That is to say, as explained before, first of all, labels to be given to the receiver um are selected as tentatively selected labels. The tentatively selected labels are LABEL_{i,j} of every subset S_{i,j} with an internal node i used as a starting minuend node and a node j serving as a subtrahend node, which is a direct-branch node from a partial path from a leaf associated with the receiver um to the internal node i on a path (referred to as path-m) from the leaf to the root. The tentatively selected labels also include LABEL_{1,φ} of the second special subset SS_{1,φ}, which is the subset of the entire 2-branch one-way hierarchical tree including all receivers.

Then, the TC (trusted center) reselects labels to be provided eventually to the receiver um from the tentatively selected labels. The reselected labels are tentatively selected labels satisfying conditions (a) or (b) described as follows:
(a): Reselected LABEL_{i,j} is a tentatively selected label, which shall be neither a label corresponding to the subset key of a first special subset SS_{i,j} nor a label corresponding to the subset key of the second special subset SS_{1,φ}. As described earlier, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked.
(b): A reselected label is a tentatively selected label, which shall be a label corresponding to the subset key of a first special subset SS_{i,j} or the subset key of the second special subset SS_{1,φ}. As described earlier, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked. However, the tentatively selected label satisfying condition (b) must satisfy the following sub-conditions:
(b1): nodes y shall be included in PathNodes-m and
(b2): nodes 2y shall not be included in PathNodes-m,
   where symbol y is the number of a node y whose associated value x_{y} is used as tentatively selected LABEL_{P(y),S(y)} where subscript P(y) is the node number of the parent node of the node indicated by the node number y and subscript S(y) is the node number of a sister node of the node indicated by the node number y as explained earlier by referring to FIG. 31.

Tentatively selected labels satisfying condition (a) and tentatively selected labels satisfying condition (b) are given to the receiver um.

(4-2): Information Distribution Processing

The following description explains details of secret-information transmission processing carried out after the setup processing described above. The TC (trusted center) distributes information or, strictly speaking, secret information, to receivers by transmitting one or more cryptograms by adoption of the broadcasting technique. Each of the cryptograms is a result of a process to encrypt the secret information by using one subset key. For example, secret information is transmitted from the TC (trusted center) as a set of cryptograms each obtained as a result of a process to encrypt the secret information by using one of different subset keys provided for the secret information. That is to say, the same secret information is encrypted by using different subset keys to generate different cryptograms composing the cryptogram set.

Assume for example that the secret information to be transmitted is a content key K_{c} for decrypting an encrypted content. In this case, a result of a process to encrypt the content key K_{c} is a set of cryptograms resulting from encryption of the content key K_{c} by using different subset keys. For example, let the set of cryptograms be represented by the following expression:

E (SK_{a,b},K_{c}), E (SK_{c,d},K_{c}), E (SK_{e,f},K_{c})

The set of cryptograms is then distributed to receivers by way of a network or by storing it on a recording medium. It is to be noted that, as described before, notation E (A,B) represents encrypted data obtained as a result of a process to encrypt data B by using a key A. The set of cryptograms given as the above example is obtained as a result of a process to encrypt the content key K_{c} by using 3 different subset keys SK_{a,b}, SK_{c,d} and SK_{e,f}.

The subset keys SK_{a,b}, SK_{c,d} and SK_{e,f} are each a subset key of a subset selected by the TC (trusted center) in order to designate specific apparatus as revoked apparatus.

By using labels held in the remaining receivers, the remaining receivers other than the revoked receivers are each capable of generating one of the subset keys used in the TC (trusted center) to encrypt the content key K_{c} in producing the set of cryptograms. The held labels can be an immediate label for directly generating a required subset key or an intermediate label for indirectly generating a required subset key. Thus, a properly selected receiver other than the revoked receivers is capable of decrypting one of the cryptograms included in the set of cryptograms given below to obtain the content key K_{c}:

E (SK_{a,b},K_{c}), E (SK_{c,d},K_{c}), E (SK_{e,f},K_{c})

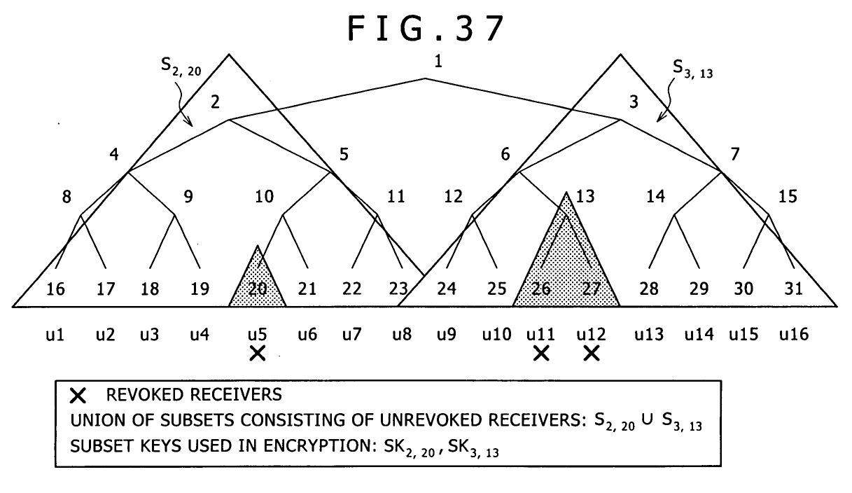

In a 2-branch one-way hierarchical tree having N (=16) leaves each associated with a receiver as shown in FIG. 37, receivers u5, u11 and u12 are revoked, leaving 2 subsets, i.e. subsets S_{2,20} and S_{3,13} shown in the FIG. 37.

Thus, unrevoked receivers are included in one of the 2 subsets S_{2,20} and S_{3,13} while the revoked receivers u5, u11 and u12 are included in neither of the subsets. Therefore, by encrypting of the secret information by using the subset keys of the subsets S_{2,20} and S_{3,13} and transmitting a cryptogram set obtained as a result of the encryption to the receivers, only the unrevoked receivers are capable of decrypting the cryptograms to obtain the secret key.

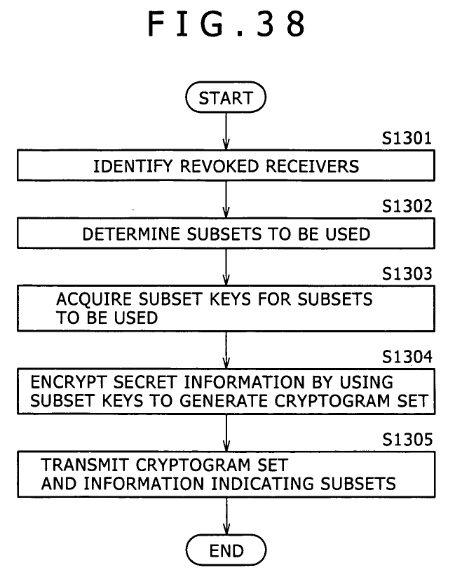

A processing procedure of the process to distribute information is explained by referring to a flowchart shown in FIG. 38. Steps of the flowchart shown in FIG. 38 are explained as follows.

As shown in the figure, the flowchart begins with a step S1301 at which the TC (trusted center) recognizes revoked receivers, which are each not entitled to distributed secret information. It is to be noted that every receiver is associated with a leaf of the 2-branch one-way hierarchical tree.

Then, at the next step S1302, on the basis of the positions of leaves associated with the identified revoked receivers in the 2-branch one-way hierarchical tree, the TC (trusted center) determines subsets used as a target of the distribution of the secret information. In the case of the 2-branch one-way hierarchical tree shown in FIG. 37, for example, the receivers u5, u11 and u12 are revoked receivers as described earlier. In this case, the TC (trusted center) recognizes the 2 subsets S_{2,20} and S_{3,13} as remaining partial trees.

Then, at the next step S1303, the TC (trusted center) selects the subset keys of the recognized subsets. The TC (trusted center) holds a subset key for every subset from the beginning. For example, the TC (trusted center) selects the subset keys SK_{2,20} and SK_{3,13} of the 2 recognized subsets S_{2,20} and S_{3,13} in the 2-branch one-way hierarchical tree shown in FIG. 37.

Then, at the next step S1304, the TC (trusted center) encrypts the secret information by using the subset keys SK_{2,20} and SK_{3,13} selected at the step S1303 in order to generate a set of cryptograms. In the case of the example shown in FIG. 37, for example, the TC (trusted center) encrypts the secret information such as a content key K_{c} by using the subset keys SK_{2,20} and SK_{3,13} to generate the following set of cryptograms:

E (SK_{2,20},K_{c}), E (SK_{3,13},K_{c})

Then, at the next step S1305, the TC (trusted center) transmits the cryptogram set generated at the step S1304 to receivers by adoption of the broadcasting technique. Only receivers other than the revoked receivers are capable of decrypting one of the cryptograms. That is to say, the revoked receivers are not capable of decrypting any one of the cryptograms. As a result, the secret information can be distributed in a safe manner.

It is to be noted that a set of cryptograms can be distributed to receivers along with information indicating subsets having their subset keys used for decrypting the secret information. Then, by referring to the information indicating such subsets, every receiver is capable of determining a subset key used for encrypting the secret information as a subset key that the receiver itself is capable of generating. A method embracing this scheme is disclosed in documents such as Japanese Patent Laid-open No. 2001-352322. The disclosed method has a configuration in which the information indicating subsets having their subset keys subset keys used for decrypting the secret information is implemented as key-specifying codes.

It is to be noted that the TC (trusted center) may also use a key created and saved at a setup phase as a subset key for encrypting the secret information. As an alternative, the TC (trusted center) may generate a subset key for encrypting the secret information by supplying a label created and saved at a setup phase for every subset to the pseudo random number generator G. It is also worth noting that, in the case of a no-revocation case wherein no receivers are revoked, the TC (trusted center) encrypts the secret key by using the subset key SK_{1,φ} of the second special subset SS_{1,φ}.

(4-3): Processing to Receive and Decrypt Information

Since every unrevoked receiver pertains to either of the subsets, the receiver is capable of decrypting one of the cryptograms by using a subset key of the subset, to which the receiver pertains, to obtain the secret information. The receiver is capable of identifying a cryptogram that the receiver should decrypt by referring to the aforementioned information specifying subsets. After the receiver identifies the cryptogram that the receiver should decrypt, the receiver computes a subset key for decrypting the cryptogram directly from an immediate label held by the receiver or indirectly from or an intermediate label also held by the receiver. Finally, the receiver decrypts one of the cryptograms by using the computed subset key. A method of computing a subset key for decrypting a cryptogram is explained as follows.

First of all, the receiver um examines a subset S_{i,j} specified in the aforementioned subset-specifying information to recognize a relation between a node j associated with the subset S_{i,j} corresponding to a subset key SK_{i,j} to be used for decrypting a cryptogram and a label held by the receiver um in determination process (A) or (B) described as follows.
(A): Determine whether or not the node j is an offspring node of a node k whose LABEL_{i,k} is held by the receiver. In this determination process, the receiver um may also determine whether or not j=k, that is, whether or not LABEL_{i,k} held by the receiver is LABEL_{i,j} to be used for decrypting a cryptogram.
(B): Determine that the node j is a child node k of the node i or an offspring node of the child node k, and the node k is located outside a path from a leaf n associated with the receiver to the root (that is, the node k is the sister node of the child node of the node i) but the receiver does not hold LABEL_{i,k}. That is to say, in this determination process, the receiver um determines that the node j is such a child node k (that is, a sister node) or an offspring node of such a child node k and the child node k is the child node associated with a first special subset SS_{i,k}, which is one of subsets whose labels are given to the receiver um in accordance with the SD method, but LABEL_{i,k} is not held by the receiver.

It is to be noted that, if the subset key SK_{1,φ} of the second special subset SS_{1,φ} for a no-revocation case in which no receivers are revoked has been used for encrypting the secret information and the receiver um holds LABEL_{1,φ}, the relation between the node j associated with the subset S_{i,j} specified in the aforementioned subset-specifying information and a label held by the receiver um is a relation confirmed in determination process (A). If the receiver um does not hold LABEL_{1,φ}, on the other hand, the relation between the node j associated with the subset S_{i,j} specified in the aforementioned subset-specifying information and a label held by the receiver um is a relation confirmed in determination process (B). It is also worth noting that, if the relation between the node j associated with the subset S_{i,j} specified in the aforementioned subset-specifying information and a label held by the receiver um is a relation confirmed in determination process (B) because the receiver um does not hold LABEL_{1,φ}, the receiver um computes LABEL_{1,φ} by applying the one-way function F to a label held by the receiver urn as the label of a special subset.

In the case of determination process (B), if the node j is the node k, the subset key SK_{i,j} to be used for decrypting a cryptogram is computed from LABEL_{i,k}, which is LABEL_{i,j} itself, by using the pseudo random number generator G. If the node j is an offspring of the node k, the subset key SK_{i,j} to be used for decrypting a cryptogram is computed by using the pseudo random number generator G from LABEL_{i,j}, which is computed by using the pseudo random number generator G from LABEL_{i,k}. In either case, the value of LABEL_{i,k} must be found as a value for computing the subset key SK_{i,j} as follows.

First of all, the receiver um recognizes the value of subscript j in the subset S_{i,j} specified in the subset-specifying information as the node number of a node in the 2-branch one-way hierarchical tree in order to determine LABEL_{i,k}, the value of which must be determined. Assume that the value of subscript j is y. Then, the receiver um finds the minimum of such values of n that 2ⁿy is a node number included in PathNodes-m but (2ⁿ⁺¹y) is not. For such a minimum, the receiver um certainly holds LABEL_{i,2}_{ⁿ}_{y} of the node with a node number of 2ⁿy. Refer to the following equation:
x₂_{ⁿ}_{y} (9)

Ii is to be noted that, if n=0 holds true, the receiver um holds immediate LABEL_{i,y} itself, which is determined to be LABEL_{i,k} held by the receiver um in determination process (A). Thus, the minimum of values of n is determined only for n>0.

The following equation expresses the value of the label held by the receiver um as the label for the node with a node number of 2ⁿy.
x₂_{ⁿ}_{y} (10)

By applying the one-directivity F to a label having the value, which is expressed by the above equation, repeatedly n times, the receiver is capable of finding LABEL_{i,k}, which is equal to the value x_{y}, for the node y.

After LABEL_{i,k} for the subset S_{i,k} is found, required LABEL_{i,j} for the subset S_{i,j} specified in the subset-specifying information can be computed by using the pseudo random number generator G as explained earlier by referring to FIG. 21. Then, the subset key SK_{i,j} can be found by supplying LABEL_{i,j} to the pseudo random number generator G as follows:

SK_{i,j}=G_{M}(LABEL_{i,j})

The subset key SK_{i,j} is a key required for decrypting the cryptogram.

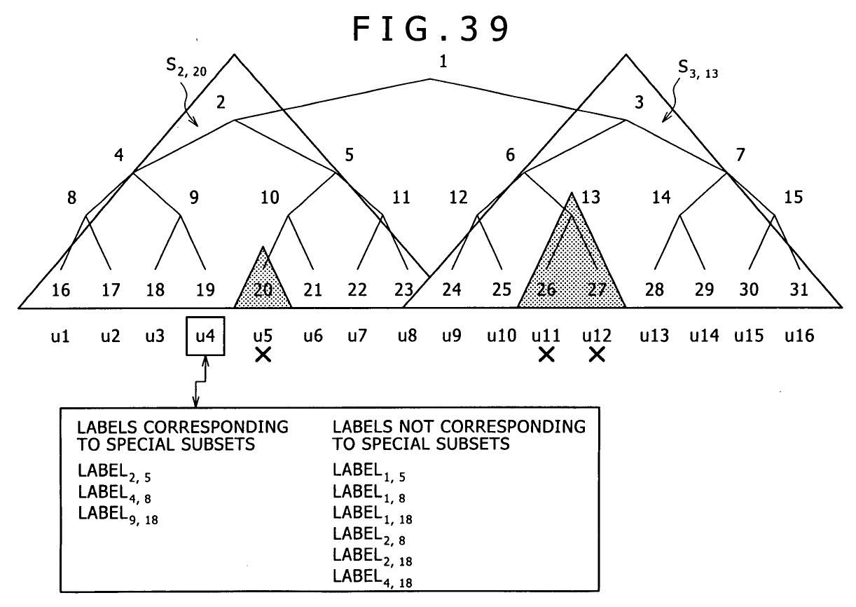

To put it concretely, the processing to find the subset key is explained by referring to FIG. 39. As shown in FIG. 39, the receivers u5, u11 and u12 are revoked, and cryptograms encrypted by using subset keys for subsets S_{2,20} and S_{3,13} are distributed to receivers by adoption of the broadcasting technique.

First of all, processing carried out by the receiver u4 associated with a leaf identified by a node number of 19 is explained. The receiver u4 is provided with the following 3 labels listed below as labels each associated with a special subset:

LABEL_{2,5}

LABEL_{4,8}

LABEL_{9,18}

In addition, the receiver u4 is also provided with the following 6 labels listed below as labels each not associated with a special subset:

LABEL_{1,5}

LABEL_{1,8}

LABEL_{1,18}

LABEL_{2,8}

LABEL_{2,18}

LABEL_{4,18}

Thus, the receiver u4 is provided with a total of 9 labels.

Since the subset S_{2,20} is specified in the subset-specifying information, in determination process (A), the receiver u4 determines that the node 20 is an offspring of the node 5, whose LABEL_{2,5} is held by the receiver u4. Thus, by supplying LABEL_{2,5} to the pseudo random number generator G repeatedly n times, where n=3 in this case, the receiver u4 is capable of finding LABEL2,20 for computing the subset key SK_{2,20}.

As described above, in accordance with the conventional SD method, the receiver u4 is provided with 11 labels listed below:

LABEL_{1,3}

LABEL_{2,5}

LABEL_{4,8}

LABEL_{9,18}

LABEL_{1,5}

LABEL_{1,8}

LABEL_{1,18}

LABEL_{2,8}

LABEL_{2,18}

LABEL_{4,18}

LABEL_{1,φ}

In accordance with the method provided by the present invention, however, the number of labels given to the receiver u4 can be reduced to 9. The 9 labels are 6 labels each not associated with a special subset and 3 labels each associated with a special subset. The 6 labels listed below as labels each not associated with a special subset:

LABEL_{1,5}

LABEL_{1,8}

LABEL_{1,18}

LABEL_{2,8}

LABEL_{2,18}

LABEL_{4,18}

On the other hand, the 3 labels listed below as labels each associated with a special subset:

LABEL_{2,5} having the value x₄,

LABEL_{4,8} having the value x₉ and

LABEL_{9,18} having the value x₁₆.

Thus, LABEL_{1,3} having the value x₂ and LABEL_{1,φ} having the value x₁ are eliminated from the list of labels given to the receiver u4 in accordance with the conventional SD method.

As described before, however, the (2N−1) C-bit values x₁, x₂, . . . , and x_{2N-1} to be used as values of labels for nodes can be computed by applying the algorithm explained earlier by referring to the flowchart shown in FIG. 28 in accordance with the following equation:
x_{i/2}=F(xᵢ)

Since the receiver u4 holds the value x₄ as LABEL_{2,5}, the values x₂ and x₁ of eliminated LABEL_{1,3} and LABEL_{1,φ} respectively can be derived from the value x₄ as follows.

To put it concretely, from the value x₄ as LABEL_{2,5}, the receiver u4 is capable of computing the value x₂ of LABEL_{1,3} and the value x₁ of LABEL_{1,φ} as follows:

x₂ of LABEL_{1,3}=F(x₄) and

x₁ of LABEL_{1,φ}=F(x₂)

Thus, the receiver u4 holds fewer labels than those held in accordance with the conventional SD method. However, the receiver u4 is capable of utilizing as many labels as those held in accordance with the conventional SD method for computation of a subset key to be used for decrypting a cryptogram.

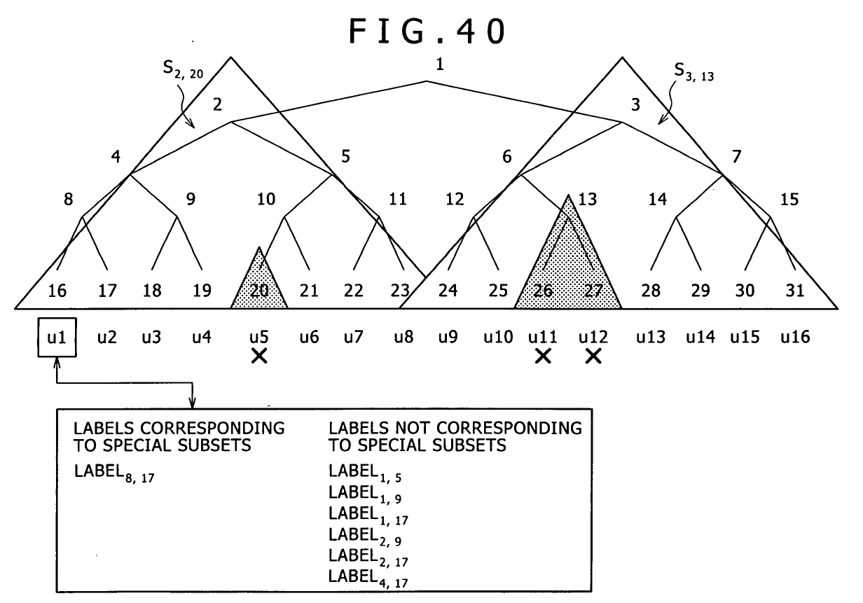

Next, processing carried out by the receiver u1 associated with a leaf identified by a node number of 16 is explained. As shown in FIG. 40, the receiver u1 is provided with LABEL_{8,17} as a label associated with a special subset. In addition, the receiver u1 is also provided with the following 6 labels listed below as labels each not associated with a special subset:

LABEL_{1,5}

LABEL_{1,9}

LABEL_{1,17}

LABEL_{2,9}

LABEL_{2,17}

LABEL_{4,17}

Thus, the receiver u4 is provided with a total of 7 labels.

Since the subset S_{2,20} is specified in the subset-specifying information, in determination process (B), the receiver u1 determines that the node j (=20) is an offspring of the node k, whose LABEL2,k is not held by the receiver u4. As described above, in determination process (B), the receiver u1 determines that the node j is the child node k of the node i or an offspring node of the child node k and the node k is located outside a path from a leaf associated with the receiver u1 to the root (that is, the node k is the sister node of the child node of the node i) but the receiver u1 does not hold LABEL_{i,k}. That is to say, in this determination process, the receiver u1 determines that the node j is such a child node k (that is, a sister node) or an offspring node of such a child node k and the child node k is the child node associated with a first special subset SS_{i,k}, which is one of subsets whose labels given to the receiver u1 in accordance with the conventional SD method, but LABEL_{i,k} is not held by the receiver.

To put it concretely, in determination process (B), the receiver u1 determines that the node 20 associated with the subset S_{2,20} is an offspring node of the sister node k borne to the node i (=2) since the node k is located outside a path from a leaf associated with the receiver u1 to the root but LABEL_{2,k} is not held in the receiver u1. Thus, LABEL_{2,5} must be computed from LABEL_{8,17} for the following reason.

As described above, in accordance with the conventional SD method, the receiver u1 is provided with 11 labels listed below:

LABEL_{1,3}

LABEL_{1,5}

LABEL_{1,9}

LABEL_{1,17}

LABEL_{2,5}

LABEL_{2,9}

LABEL_{2,17}

LABEL_{4,9}

LABEL_{4,17}

LABEL_{8,17}

LABEL_{1,φ}

In accordance with the method provided by the present invention, however, the number of labels given to the receiver u1 can be reduced to the 7 labels described above.

In accordance with the method provided by the present invention, 4 labels can thus eliminated from the receiver u1. The 4 eliminated labels are listed as follows:

LABEL_{4,9}

LABEL_{2,5}

LABEL_{1,3}

LABEL_{1,φ}

However,, the receiver u1 is capable of finding the values of the eliminated labels from a value of a label given to the receiver u1. This is because, as described before, the (N−1) C-bit values x₁, x₂, . . . , and x_{2N-1} to be used as values of labels for nodes can be computed by applying the algorithm explained earlier by referring to the flowchart shown in FIG. 28 in accordance with the following equation:
x_{i/2}=F(xᵢ)
By the way, the value x₁₆ is held in the receiver u1 as LABEL_{8,17} whereas values x_{y} are used as the eliminated labels as follows:

x₈ as LABEL_{4,9},

x₄ as LABEL_{2,5},

x₂ as LABEL_{1,3} and

x₁ as LABEL_{1,φ}

Thus, the receiver u1 is capable of finding the values x₈, x₄, x₂ and x₁ of the eliminated labels from the value x₁₆ held as LABEL_{8,17} as follows.

x₈ of LABEL_{4,9}=F(x₁₆),

x₄ of LABEL_{2,5}=F(x₈),

x₂ of LABEL_{1,3}=F(x₄) and

x₁ of LABEL_{1,φ}=F(x₂)

In an example shown in FIG. 40, the value x₄ of LABEL_{2,5} must be found from the value x₁₆ of LABEL_{8,17} held in the receiver u1. Thus, by applying the one-way function F to the value x₁₆ repeatedly twice, the receiver u1 is capable of finding LABEL_{2,5}.

Then, the receiver u1 supplies LABEL_{2,5} to the pseudo random number generator G repeatedly 3 times to find the subset SK_{2,20} to be used for decrypting the cryptogram.

The above processing is carried out in the same way for a no-revocation case in which no receivers are revoked and the subset key SK_{1,φ} of the second special subset SS_{1,φ} is used for encrypting the secret information. In this case, the receiver may hold LABEL_{1,φ} so that the subset key SK_{1,φ} can be found, or the receiver may not hold LABEL_{1,φ} but holds a label usable for finding LABEL_{1,φ} by applying the one-way function F repeatedly as many times as required so that, eventually, the subset key SK_{1,φ} can also be found as well. By the same token, the subset key SK_{1,φ} can be found by supplying LABEL_{1,φ} to the pseudo random number generator G as follows:

SK_{1,φ}=G_{M}(LABEL_{1,φ})

It is to be noted that the value x_{y} of another label cannot be found from the value x₁ of LABEL_{1,φ}. Thus, rather than holding the value x₁ of LABEL_{1,φ}, the subset key SK_{1,φ} of the subset S_{1,φ} can be held specially in place of LABEL_{1,φ}. In this case, the pseudo random number generator G is not used for finding for the subset key SK_{1,φ} from the value x₁ of LABEL_{1,φ} for a no-revocation case in which no receivers are revoked. Thus, the processing load can be reduced.

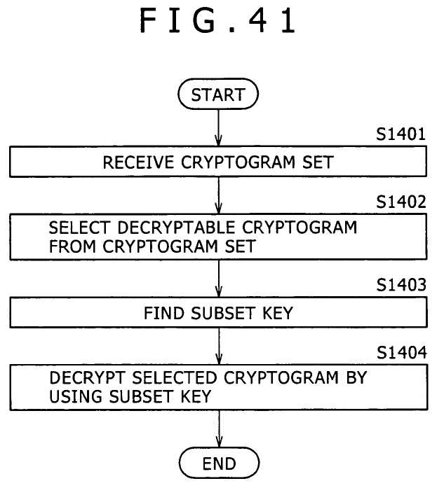

By referring to a flowchart shown in FIG. 41, the following description explains a procedure of processing carried out by a receiver um to obtain a subset key from a received cryptogram and use the subset key to decrypt the cryptogram.

As shown in the figure, the flowchart begins with a step S1401 at which the receiver um receives a set of cryptograms. The set of cryptograms is distributed to receivers including the receiver um by way of a network or by recording the cryptograms on a recording medium. Then, at the next step S1402, the receiver um selects a cryptogram from the received set of cryptograms by typically referring to information received along with the set of cryptograms as information specifying subsets. The selected cryptogram is a cryptogram that can be decrypted by using a subset key producible by the receiver um. The receiver um selects a cryptogram associated with a subset specified in the subset-specifying information in accordance with determination process (A) or (B) described earlier. No cryptogram selected in the collation implies that the receiver um is a receiver that has been revoked.

Then, at the next step S1403, by adoption of the technique explained earlier, the receiver um computes a subset key of the subset associated with the selected cryptogram as a key for decrypting the cryptogram.

In the process to compute a subset key, the receiver um carries out the following operations.
(1): If the subset key for decrypting the cryptogram is not a subset key that can be computed by supplying the label of a special subset to the pseudo random number generator G, the receiver um supplies a label held by itself as a label not associated with a special subset to the pseudo random number generator G repeatedly as many times as required to eventually find the subset key for decrypting the cryptogram.
(2): If the subset key for decrypting the cryptogram is a subset key that can be computed by supplying the label of a special subset to the pseudo random number generator G, on the other hand, the receiver um determines whether or not the subset key to be used for decrypting the cryptogram can be computed from a label held by the receiver um itself by merely supplying the held label to the pseudo random number generator G.
(2-1): If the receiver um determines that the subset key for decrypting the cryptogram can be computed from a label held by the receiver um itself by merely supplying the held label to the pseudo random number generator G, the subset key for decrypting the cryptogram is computed from the held label by merely supplying the held label to the pseudo random number generator G repeatedly as many times as required.
(2-2): If the receiver um determines that the subset key for decrypting the cryptogram cannot be computed from a label held by the receiver um itself by merely supplying the held label to the pseudo random number generator G, on the other hand, the label of a new special subset is found by applying the held label to the one-way function F repeatedly as many times as required and the label of a new special subset is supplied to the pseudo random number generator G as many times as required to compute the subset key for decrypting the cryptogram.

Operations (2-2) to compute the label of a subset are carried out as processing to find the label of a special subset including nodes on a path from a leaf associated with the receiver um to the root in the 2-branch one-way hierarchical tree. In this processing, from a label held by the receiver u4 as the label of a special subset of a node on a lower-level hierarchical layer of the 2-branch one-way hierarchical tree, the label of a special subset of a node on a hierarchical layer at a higher level is found by applying the one-way function F.

Then, at the next step S1404, the receiver um decrypts the cryptogram selected from a set of cryptograms at the step S1402 by using the subset key computed in the operations carried out at the step S1402 to obtain the secret information. An example of the secret information is a content key for decrypting an encrypted content transmitted by a television-broadcasting system. In this case, the receiver um receives the encrypted content and uses the computed content key for decrypting the encrypted content.

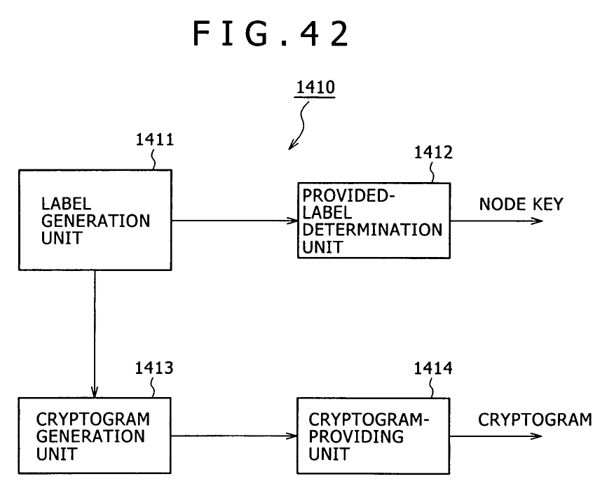

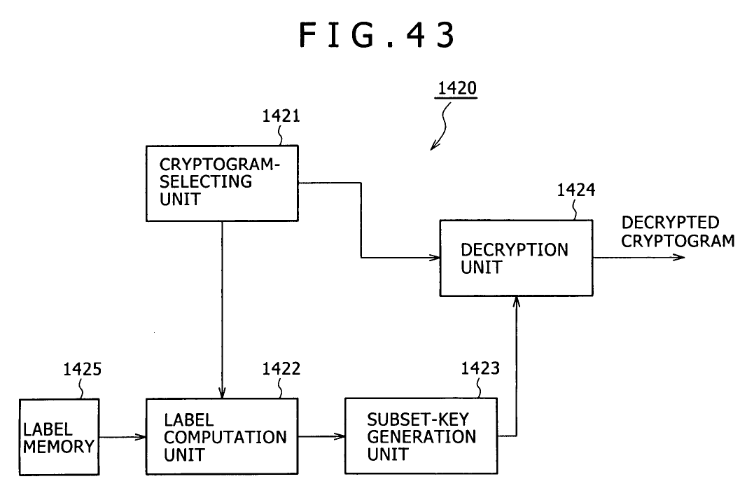

By referring to FIGS. 42 and 43, the following description explains the functional configuration of an information-processing apparatus for carrying out a process to determine labels and a process to generate cryptograms and the functional configuration of the information-processing apparatus functioning as a receiver for carrying out a process to decrypt a cryptogram.

The description begins with an explanation of the functional configuration of an information-processing apparatus 1410 for carrying out a process to determine labels and a process to generate cryptograms with reference to FIG. 42. As shown in the figure, the information-processing apparatus 1410 comprises a label generation unit 1411, a provided-label determination unit 1412, a cryptogram generation unit 1413 and a cryptogram-providing unit 1414.

The information-processing apparatus 1410 is an information-processing apparatus applying the broadcast encryption method based on a hierarchical tree configuration to carry out processing to provide cryptograms to only specially selected apparatus capable of decrypting the cryptograms by excluding revoked apparatus from targets of cryptogram distribution. The label generation unit 1411 is a unit for generating labels of subsets included in a 2-branch one-way hierarchical tree on the basis of the SD (subset difference) method. The labels are set at such values that the value of a special subset selected from the subsets can be found from the value of another special subset by applying the one-way function F. Examples of the one-way function F are MD4, MD5 and SHA-1.

A subset S_{i,j} of ancestor-offspring nodes i and j with the node i being the ancestor node of the node j is defined for each of internal nodes i where i=1, 2, . . . , and (N−1). A subset S_{i,j} is a difference obtained by subtracting a partial tree having the node j at its vertex from a partial tree having the node i at its vertex. A subset S_{i,j} is also referred to as a subset of the node j with the node i used as a starting node. The special subsets selected in the label generation unit 1411 include at least first special subsets or the second special subset. Subsets S_{i,j} with the node i being the parent node of the node j are each referred to as a first special subset SS_{i,j}. A second special subset SS_{1,φ} including all receivers is defined to be used as a subset of the entire tree having the node 1 at its vertex for a no-revocation case in which no receiver is revoked.

As described above, the label generation unit 1411 is a unit for generating labels of subsets included in a 2-branch one-way hierarchical tree on the basis of the SD (subset difference) method, and the labels are set at such values that the value of a special subset selected from the subsets can be found from the value of another special subset by applying the one-way function F.

To put it concretely, in the case of a 2-branch one-way hierarchical tree having N terminal nodes each serving as a leaf, for example, in accordance with the algorithm explained earlier by referring to FIG. 28, the label generation unit 1411 executes the steps of:

selecting N values x_{N}, x_{N+1}, . . . , and x_{2N-1};

setting a variable i at an initial value of (2N−1) and then, while decrementing the variable i by 1 from the initial value to 1, carrying out repetitive processing starting with the initial value to compute x_{i/2} (=F(xᵢ)) by applying the one-way function F to the value x i if the variable i is even; and

using the values x₁, x₂, . . . , and x_{2N-1} obtained as results of the computation as labels of all (2N−1) special subsets included in the 2-branch one-way hierarchical tree including the N terminal nodes.

The provided-label determination unit 1412 is a unit for determining a minimum number of specific labels to be provided to every receiver associated with any specific one of the terminal nodes in the 2-branch one-way hierarchical tree and providing the labels to the receiver. The specific labels include labels of special subsets and labels of subsets other than special subsets. The specific labels given to a receiver are further selected to result in a minimum number of labels of excluding those that can be computed from other labels by using the one-way function F.

Concrete processing carried out by the provided-label determination unit 1412 is explained as follows. First of all, labels to be given to the receiver um are selected as tentatively selected labels. The tentatively selected labels are LABEL_{i,j} of every subset S_{i,j} with an internal node i used as a starting minuend node and a node j serving as a subtrahend node, which is a direct-branch node from a partial path from a leaf associated with the receiver um to the internal node i on a path (referred to as path-m) from the leaf to the root. The tentatively selected labels also include LABEL_{1,φ} of the second special subset SS_{1,φ}, which is the subset of the entire 2-branch one-way hierarchical tree including all receivers. Then, the provided-label determination unit 1412 reselects labels to be provided to the receiver um from the tentatively selected labels. The reselected labels are tentatively selected labels satisfying conditions (a) or (b) described as follows:
(a): Reselected LABEL_{i,j} is a tentatively selected label, which shall be neither a label corresponding to the subset key of a first special subset SS_{i,j} nor a label corresponding to the subset key of the second special subset SS_{1,φ}. As described earlier, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked.
(b): A reselected label is a tentatively selected label, which shall be a label corresponding to the subset key of a first special subset SS_{i,j} or the subset key of the second special subset SS_{1,φ}. As described earlier, a first special subset SS_{i,j} is a subset of a parent node i and a child node j of the parent node i. On the other hand, the second special subset SS_{1,φ} is a subset of the entire 2-branch one-way hierarchical tree including all receivers. The second special subset SS_{1,φ} is thus a subset used for a no-revocation case in which no receivers are revoked. However, the tentatively selected label satisfying condition (b) must satisfy the following sub-conditions:
(b1): nodes y shall be included in PathNodes-m and
(b2): nodes 2y shall not be included in PathNodes-m,
   where symbol y is the number of a node y whose associated value x_{y} is used as tentatively selected LABEL_{P(y),S(y)} where subscript P(y) is the node number of the parent node of the node indicated by the node number y and subscript S(y) is the node number of a sister node of the node indicated by node number y as explained earlier by referring to FIG. 31.

Tentatively selected labels satisfying condition (a) and tentatively selected labels satisfying condition (b) are determined as final labels to be given to the receiver um.

As a result, the provided-label determination unit 1412 provides the receiver um with LABEL_{P(y),S(y)} having the value x_{y} computed for the node number y indicating a leaf serving as the self node of the receiver um and j labels as labels for special subsets where j has a value in the range 0 to log N and N is the number of leaves included in the 2-branch one-way hierarchical tree as terminal nodes that can be associated with receivers.

The cryptogram generation unit 1413 is a unit for carrying out an encryption process to generate cryptograms. The cryptogram generation unit 1413 carries out the encryption process by selectively using subset keys that can be computed from labels generated by the label generation unit 1411. The cryptogram-providing unit 1414 is a unit for distributing cryptograms generated by the cryptogram generation unit 1413 to receivers by way of a network or by recording the cryptograms on a recording medium.

By referring to FIG. 43, the following description explains the functional configuration of an information-processing unit 1420 functioning as a receiver for carrying out a process to decrypt cryptograms.

As shown in the figure, the information-processing unit 1420 functioning as a receiver for carrying out a process to decrypt cryptograms comprises a cryptogram-selecting means 1421, a label computation means 1422, a subset-key generation means 1423, a decryption means 1424 and a label memory 1425.

The information-processing unit 1420 functioning as a receiver for carrying out a process to decrypt cryptograms is an apparatus for carrying out a process to decrypt cryptograms each encrypted by using a subset key set for a subset on the basis of the SD (subset difference) method, which is a broadcast encryption technique based on the configuration of a hierarchical tree. The cryptogram-selecting means 1421 is a unit for carrying out a process to select a cryptogram from cryptograms distributed by the cryptogram-providing unit 1414. The selected cryptogram is a cryptogram generated by using a subset key computed from a label held in the label memory 1425 or another label, which is not held in the label memory 1425 but computable from the held label. The subset key is computed by using the pseudo random number generator G from the held label or the other label, which is computed from the held label by applying the one-way function F.

The label computation means 1422 is a unit for computing the other label cited above by applying the one-way function F to the held label. The other label is used to find another subset key for decrypting the selected cryptogram in case the selected cryptogram is a cryptogram encrypted by using the other subset key different from a subset key that can be computed from the held label by using the pseudo random number generator G.

To put it in detail, the label computation means 1422 carries out the process to find a label as follows. The subset key to be used for decrypting a cryptogram is a subset key that can be computed from a label of a special subset by using the pseudo random number generator G. If the label is not stored in the label memory 1425, the label is computed from another label stored in the label memory 1425 by applying the one-way function F to the other label. The special subset can be a first special subset SS_{i,j} or the second special subset SS_{1,φ}. As described earlier, a subset S_{i,j} in a 2-branch one-way hierarchical tree is a difference obtained by subtracting a partial tree having the node j at its vertex from a partial tree having the node i at its vertex, and a first special subset SS_{i,j} is a subset S_{i,j} of a parent node i and a child node j of the parent node i in the 2-branch one-way hierarchical tree. On the other hand, the second special subset SS_{1,φ} is a subset of the entire 2-branch one-way hierarchical tree including all receivers with the node 1 (or the root) used as a starting node. The second special subset SS_{1,φ} is thus a subset used for a no-revocation case in which no receivers are revoked.

The label computation means 1422 carries out a process to compute the label of a special subset including nodes on a path from a leaf associated with the receiver um for decrypting the cryptogram to the root in the 2-branch one-way hierarchical tree by applying the one-way function F to another label stored in the label memory 1425. Examples of the one-way function F are MD4, MD5 and SHA-1.

The subset-key generation means 1423 is a unit for computing a necessary subset key by using the pseudo random number generator G from a label stored in the label memory 1425 or another label computed by the label computation means 1422 from the label stored in the label memory 1425 in case the subset key cannot be found directly from the stored label.

The decryption means 1424 is a unit for carrying out a process to decrypt the cryptogram by using a subset key computed by the subset-key generation means 1423.

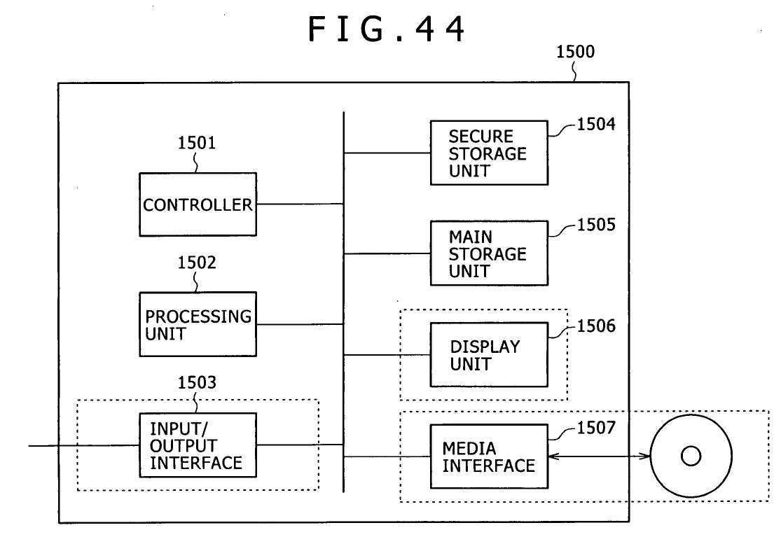

FIG. 44 is a diagram showing a typical hardware configuration of the information-processing apparatus 1500 for carrying out a process to determine labels and a process to generate cryptograms and the information-processing apparatus 1500 functioning as a receiver for carrying out a process to decrypt cryptograms. Every block enclosed by a dotted line in the figure is optional. For example, a media interface 1507 is a functional block employed only in the information-processing apparatus functioning as a receiver such as an optical-disk player. On the other hand, an input/output interface 1503 is a functional block employed only in an information-processing apparatus if the information-processing apparatus exchanges information with other apparatus or receives a signal from an antenna. If the information-processing apparatus 1500 is an information-processing apparatus functioning as a receiver, a secure storage unit 1504 is a component of importance. The secure storage unit 1504 is a memory for safely storing labels, which are received from the TC (trusted center) at a setup phase.

As shown in FIG. 44, the information-processing apparatus 1500 for carrying out a process to generate cryptograms and the information-processing apparatus 1500 functioning as a receiver for carrying out a process to decrypt cryptograms comprises a controller 1501, a processing unit 1502, the input/output interface 1503 cited above, the secure storage unit 1504 mentioned above, a main storage unit 1505, a display unit 1506 and the media interface 1507 cited above.

The controller 1501 includes a CPU for executing functions to serve as a control unit for carrying out data processing according to typically a computer program. The processing unit 1502 is a component functioning as a dedicated processing unit as well as a dedicated encryption unit, which typically carry out an encryption-key generation process, a random-number generation process and an encryption process. The processing unit 1502 also carries out a process to compute the label of a specific subset by applying the one-way function F to the label of another subset largest among subsets in the specific subsets. In addition, the processing unit 1502 also carries out a process to compute the subset key for a subset by supplying the label for the subset to the pseudo random number generator G. If the information-processing apparatus 1500 is an apparatus functioning as a receiver, the processing unit 1502 also carries out a process to decrypt a cryptogram by using a subset key.

The input/output interface 1503 is an interface for carrying out data transmission/reception processes of inputting data from an input unit such as a keyboard and a mouse and outputting data to an external output apparatus by way of a network.

If the information-processing apparatus 1500 is an information-processing apparatus functioning as a receiver, the secure storage unit 1504 is a memory for storing data in a safe and confidential manner. Data stored in the secure storage unit 1504 includes a variety of IDs and labels generated at the setup phase, from the TC (trusted center).

The labels stored in the secure storage unit 1504 are labels for special subsets selected among subsets and labels for subsets other than special subsets.

If the information-processing apparatus 1500 is an information-processing apparatus functioning as a receiver, the labels stored in the secure storage unit 1504 are labels for special subsets, which are first special subsets and the second special subset. As described earlier, a subset S_{i,j} in a 2-branch one-way hierarchical tree is a difference obtained by subtracting a partial tree having the node j at its vertex from a partial tree having the node i at its vertex, and a first special subset SS_{i,j} is a subset S_{i,j} of a parent node i and a child node j of the parent node i in the 2-branch one-way hierarchical tree. On the other hand, the second special subset SS_{1,φ} is a subset of the entire 2-branch one-way hierarchical tree including all receivers with the node 1 (or the root) used as a starting node. The second special subset SS_{1,φ} is thus a subset used for a no-revocation case in which no receivers are revoked.

The labels stored in the secure storage unit 1504 are labels that cannot be computed from labels stored in the secure storage unit 1504 itself.

That is to say, as described earlier, the secure storage unit 1504 is used for storing the LABEL_{P(y),S(y)} having the value X_{y} computed for the node number y indicating a leaf serving as the self node of the receiver um and j labels as labels for special subsets where j has a value in the range 0 to log N and N is the number of leaves included in the 2-branch one-way hierarchical tree as terminal nodes that can be associated with receivers.

The main storage unit 1505 is a memory for storing typically a data-processing program executed by the controller 1501. The main storage unit 1505 is also used for example as a work area for storing processing parameters on a temporary basis during execution of programs. The main storage unit 1505 can also be used for storing the one-way function F described above. Typically, the secure storage unit 1504 and the main storage unit 1505 are each a RAM or a RAM. The display unit 1506 is a component for displaying typically a content obtained as an output of a decryption process. The media interface 1507 is a component for executing functions to read out data from media and write data onto the media. Examples of the media are a CD, a DVD and an MD.

5: Overview of a Basic LSD (Layered Subset Difference) Method

Next, an overview of a basic LSD (Layered Subset Difference) method is explained.

In non-patent reference 2 (i.e., Advances in Cryptography-Crypto 2002, Lectures Notes in Computer Science 2442, Springer, 2002, pp. 47-60 “The LSD Broadcast Encryption Scheme” authored by D. Halevy and A. Shamir cited in the chapter with a title of “Background of the Invention,” an LSD (Layered Subset Difference) method is proposed as an improved version of the SD (Subset Difference) method. There are 2 LSD methods, namely, the basic LSD method cited above or a general LSD method, which is an extension of the basic LSD method. The following description explains the basic LSD method.

The LSD method is an extension of the basic SD method. The LSD method introduces a new concept called a layer comprising a plurality of sub-layers as will be described later. A sub-layer is the so-called hierarchical layer in the descriptions given so far. A sub-layer at a specific height from the bottom of a tree structure of the SD method is referred to as a special sub-layer. In the basic LSD method, there is only one type of special sub-layer. In the general LSD method, on the other hand, there is a plurality of special sub-layers having different degrees of importance.

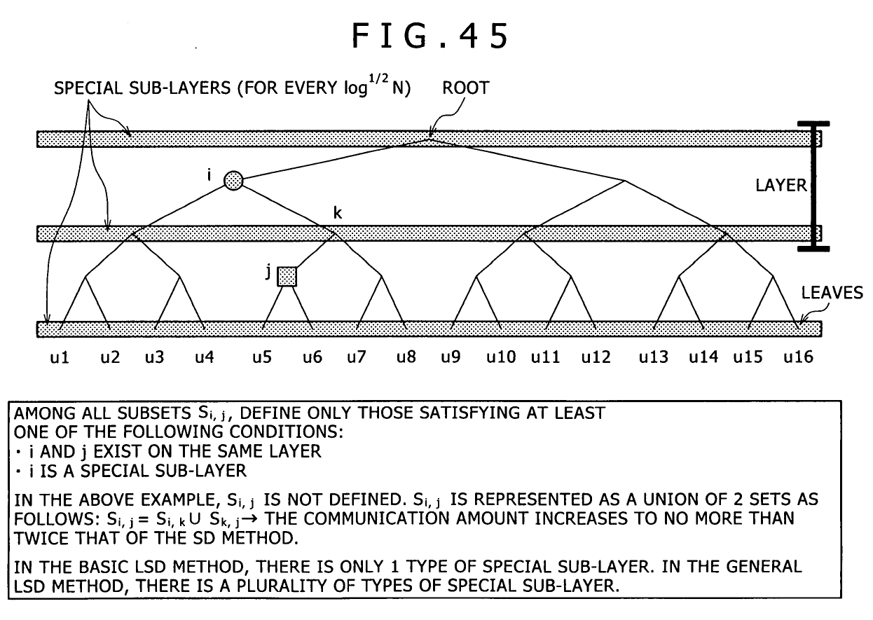

For the sake of simplicity, log^{1/2} N is assumed to be an integer. In the 2-branch one-way hierarchical tree, there is a plurality of sub-layers between the root and the leaves. In the basic LSD method, for log^{1/2} N sub-layers, there are special sub-layers including the special sub-layer consisting of only the root and the sub-layer consisting of leaves as shown in FIG. 45. In the example shown in FIG. 45, the special sub-layer consisting of only the root, the sub-layer including a node k and the sub-layer consisting of the leaves are each a special sub-layer. Sub-layers sandwiched between two adjacent special sub-layers are called a layer, which includes the special sub-layers. Thus, in the example shown in FIG. 45, sub-layers sandwiched by the special sub-layer consisting of only the root and the sub-layer including the node i form a layer including a sub-layer on which the node i exists. By the same token, sub-layers sandwiched by the special sub-layer including the node k and the special sub-layer consisting of the leaves also form another layer including a sub-layer on which the node j exists.

In the SD method, subsets S_{i,j} are defined for all nodes i and j. In the basic LSD method, on the other hand, subsets S_{i,j} are defined only for nodes i and j satisfying at least one of the following conditions:
(1): Nodes i and j pertain to the same layer.
(2): The node i exists on a special sub-layer.

Thus, some subsets used in the SD method are no longer defined in the basic LSD method. However, these subsets no longer defined in the basic LSD method can be represented by a union of up to 2 subsets defined in the basic LSD method. In the configuration shown in FIG. 45, for example, a subset S_{i,j} is not defined in the basic LSD method. However, the subset S_{i,j} can be expressed as a union of subsets S_{i,k} and S_{k,j} as follows:

S_{i,j=S}_{i,k}∪S_{k,j}

where the node k is located-on a special sub-layer closest to the node i and exists on a path from the node i to the node j.

That is to say, instead of transmitting a cryptogram encrypted by using the subset key SK_{i,j} of the subset S_{i,j} to receivers in the SD method, in the basic LSD method, 2 cryptograms encrypted by using the subset keys of the subsets S_{i,k} and S_{k,j} respectively are transmitted.

With this devised scheme, the number of transmitted cryptograms merely becomes, at the most, twice the number of cryptograms transmitted in the SD method. However, the number of labels held in every receiver can be reduced from the label count for the SD method.

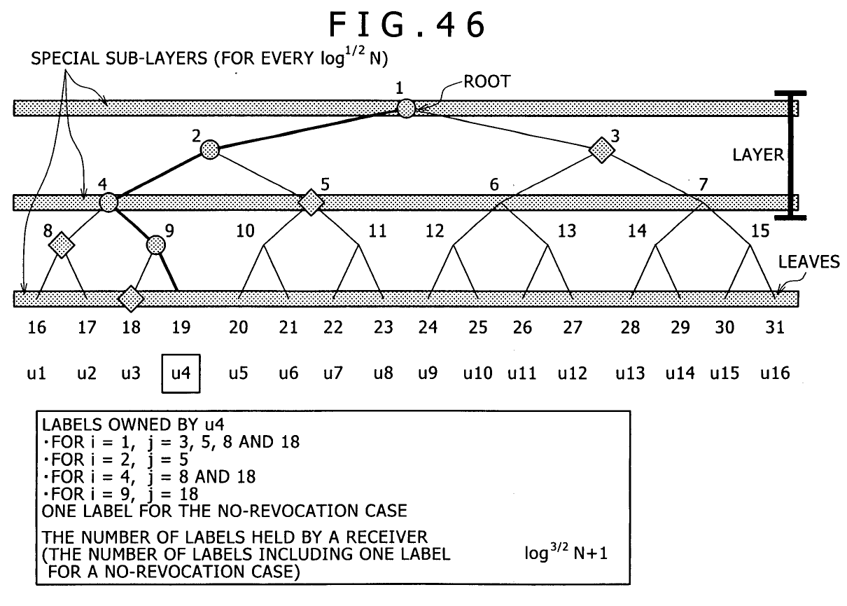

The number of labels held in every receiver in the SD method has been explained earlier by referring to FIG. 23. This time, the number of labels held in every receiver in the basic LSD method having the same setting as the SD method is explained by referring to FIG. 46 as follows. The receiver u4 shown in FIG. 46 needs only to hold LABEL_{i,j} where the nodes i and j are on the same layer or the node i is on a special sub-layer. To put it concretely, the receiver u4 needs to hold only labels listed as follows:

LABEL_{1,3}

LABEL_{1,5}

LABEL_{1,8}

LABEL_{1,18}

LABEL_{2,5}

LABEL_{4,8}

LABEL_{4,18}

LABEL_{9,18}

In addition, much like the SD method, the receiver u4 also needs to hold LABEL1, φ for the second special subset used for a no-revocation case in which no receivers are revoked.

Assuming that the number of all receivers that can be associated with leaves of the 2-branch one-way hierarchical tree is N, the number of labels that need to be held in every receiver is found as follows. First of all, consider only subsets S_{i,j} with the nodes i and j thereof existing in the same layer in conformity with condition (1) described earlier as a condition for the basic LSD method. For a given layer including the node i, the number of nodes j existing in the same layer is proportional to the height of the node i. Thus, the number of labels of subsets S_{i,j} per layer can be expressed by the following equation:

$${\sum }_{i = 1}^{log \frac{1}{2} N} i = \frac{1}{2} ( log N + {log}^{\frac{1}{2}} N ) \qquad ( 11 )$$

The number of layers in the 2-branch one-way hierarchical tree is log(1/2*N). Thus, the number of labels in all layers existing in the 2-branch one-way hierarchical tree can be expressed by the following equation:

$$\frac{1}{2} ( {log}^{\frac{3}{2}} N + log N ) \qquad ( 12 )$$

Next, consider subsets S_{i,j} with the node i thereof existing on a special sub-layer in conformity with condition (2) described earlier as a condition for the basic LSD method. In this case, the number of nodes j is proportional to the height of the node i in the entire 2-branch one-way hierarchical tree exist. Thus, the number of labels of subsets S_{i,j} for nodes j on sub-layers in the entire 2-branch one-way hierarchical tree up to the special sub-layer, on which the node i exits, can be expressed by the following equation:

$${\sum }_{i = 1}^{{log}^{\frac{1}{2}} N} ( {log}^{\frac{1}{2}} N ) i = \frac{1}{2} ( {log}^{\frac{3}{2}} N + log N ) \qquad ( 13 )$$

If the node i exists on a special sub-layer and the node j exists on the same layer as the node i, the label for the subset S_{i,j} defined for the node j is counted twice. It is thus necessary to subtract the number of labels counted twice from the total number of labels. The number of labels counted twice for a layer is equal to the number of pairs each consisting of the node i existing on a special sub-layer and a node j existing on the same layer as the node i, and the number of such pairs is equal to the number of sub-layers in the layer. Thus, the number of labels counted twice in the entire 2-branch one-way hierarchical tree is equal to the total sub-layer count (=log N) in the tree. Since every receiver also needs to hold a special sub-layer used for a no-revocation case in which no receivers are revoked, the number of labels that need to be held in every receiver in the basic LSD method is expressed as follows:

$$\frac{1}{2} ( {log}^{\frac{3}{2}} N + log N ) + \frac{1}{2} ( {log}^{\frac{3}{2}} N + log N ) - log N + 1 = {log}^{\frac{3}{2}} N + 1 \qquad ( 14 )$$

6: Configuration for Reducing a Label Count of the Basic LSD Method by Using a One-Way Hierarchical Tree

The following description explains a configuration for reducing the number of labels in the basic LSD method by using a one-way hierarchical tree. In accordance with the present invention based on the SD method described earlier, the number of labels held by every receiver can be reduced by virtue of the fact that LABEL_{i,j} for a subset S_{i,j} of nodes i and j serving as parent and child nodes respectively can be computed by applying the one-way function F to another label. This technique of reducing the number of labels can also be adopted in the same way in the basic LSD method.

The concrete configuration method is all but the same as the embodiment described earlier as an embodiment of the present invention. In a process carried out by the TC (trusted center) to compute LABEL_{i,j} by using the pseudo random number generator G repeatedly at a setup time in the case of the basic LSD method, however, if the node i does not exist on a special sub-layer, labels each associated with a node j on a level lower than a special sub-layer right below the node i are not utilized so that the computation of such labels can be skipped. Thus, fewer labels are created at the setup time and distributed to receivers.

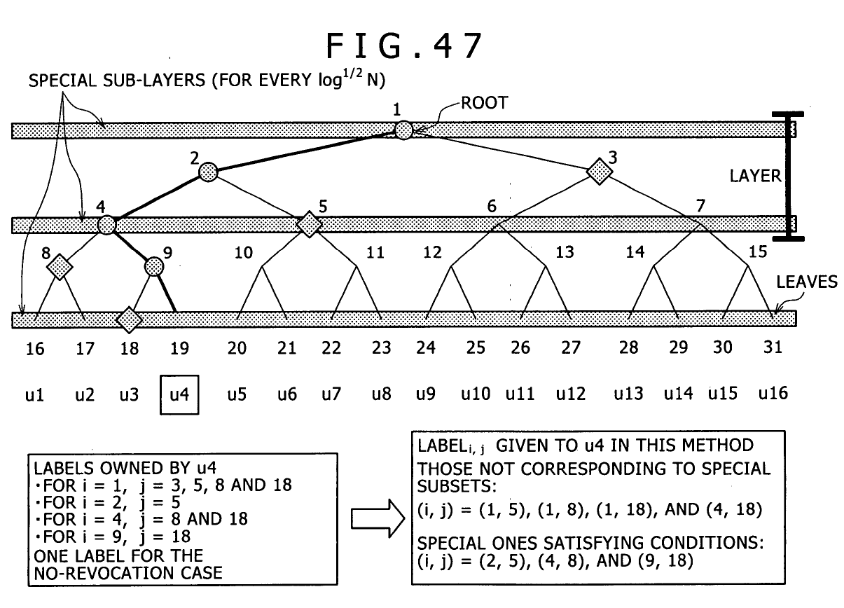

FIG. 47 is a diagram showing a configuration for reducing the number of labels in the basic LSD method by using a one-way hierarchical tree for the same setting as that explained earlier by referring to FIG. 46. As described before by referring to FIG. 46, in the basic LSD method, the receiver u4 needs to hold only labels listed as follows:

LABEL_{1,3}

LABEL_{1,5}

LABEL_{1,8}

LABEL_{1,18}

LABEL_{2,5}

LABEL_{4,8}

LABEL_{4,18}

LABEL_{9,18}

In addition, much like the SD method, the receiver u4 also needs to hold LABEL_{1,φ} for the second special subset used for a no-revocation case in which no receivers are revoked. Thus, the receiver u4 must hold a total of 9 labels. For the purpose of reference, in the case of the SD method, the number of labels to be held by the receiver u4 is 11 as described earlier.

In accordance with the present invention, on the other hand, the receiver u4 needs only to hold 4 labels listed below as labels not corresponding to special subsets:

LABEL_{1,5}

LABEL_{1,8}

LABEL_{1,18}

LABEL_{4,18}

In addition, the receiver u4 needs also to hold 4 LABEL_{i,j} corresponding to special subsets. The labels corresponding to special subsets are each set at a value X_{Y} where subscript y is the node number y of a node y satisfying the following conditions:
(b1): The node y shall be included in PathNodes-m
(b2): The node 2y shall not be included in PathNodes-m
   where symbol y is the number of a node y whose associated value x_{y} is used as LABEL_{i,j} where subscript i is the node number of the parent node of the node indicated by the node number y and subscript j is the node number of a sister node of the node indicated by the node number y.

In the case of the receiver u4 of the example shown in FIG. 46:
(b-1): nodes y included in PathNodes-m are nodes 1, 2, 4, 9 and 19 included in PathNodes-4={1, 2, 4, 9, 19} and
(b-2): nodes 2y not be included in PathNodes-m are nodes 4, 9 and 19 only. This is because, for y=1, the node number of 2y (=2×1=2) is included in PathNodes-4={1, 2, 4, 9, 19} and, by the same token, for y=2, the node number of 2y (=2×2=4) is also included in PathNodes-4={1, 2, 4, 9, 19}.

In the case of the receiver u4, the following sub-conditions must be satisfied:
(b1): Nodes y shall be included in PathNodes-m
(b2): Nodes 2y shall not be included in PathNodes-m.

Thus, only nodes 4, 9 and 19 having node numbers of 4, 9 and 19 satisfy above conditions (b1) and (b2).

As described above, the node numbers y of 4, 9 and 19 satisfy sub-conditions (b1) and (b2). The node numbers y of 4, 9 and 19 correspond to respectively values x₄, x₉ and x₁₉, which are used as labels as follows:

x₄ used as LABEL_{2,5}

x₉ used as LABEL_{4,8} and

x₁₉ used as LABEL_{9,18}

Thus, satisfying conditions (b1) and (b2), the 3 labels listed above are determined as labels to be given to the receiver u4.

As a result, the receiver u4 is provided with 4 labels not corresponding to special subsets and 3 labels each satisfying conditions (b1) and (b2). As described above, the 4 labels not corresponding to special subsets are listed as follows:

LABEL_{1,5}

LABEL_{1,8}

LABEL_{1,18}

LABEL_{4,18}

On the other hand, the 3 labels each satisfying conditions (b1) and (b2) are listed as follows:

LABEL_{2,5} set at x₄,

LABEL_{4,8} set at x₉ and

LABEL_{9,18} set at x₁₉.

Thus, the receiver u4 is provided with a total of 7 labels.

Thus, in accordance with the present invention, 2 labels eliminated from labels to be given to the receiver u4 are LABEL_{1,3} and LABEL_{1,φ}. However, the receiver u4 is capable of finding the values of LABEL_{1,3} and LABEL_{1,φ} from the values of other labels given to the receiver u4. To put it in detail, LABEL_{1,3} and LABEL_{1,φ} have the values x₂ and x₁ respectively as described above. By the way, the receiver u4 holds the value x₄ of LABEL_{2,5} given to the receiver u4. Thus, the receiver u4 is capable of finding the values x₂ and x₁ of LABEL_{1,3} and LABEL_{1,φ} respectively from the value x₄ of LABEL_{2,5} given to the receiver u4 by using the following equation based on the algorithm explained earlier by referring to the flowchart shown in FIG. 28. As described above, the equation is used to find (2N−1) C-bit values x₁, x₂, . . . , and x_{2N-1} for their respective nodes.
x_{i/2}=F(xᵢ)

Thus, the receiver u4 is capable of finding the values x₂ and x₁ of LABEL_{1,3} and LABEL_{1,φ} respectively from the value x₄ of LABEL_{2,5} given to the receiver u4 by using the following equations:
LABEL_{1,3}=x₂=F(x₄)
LABEL_{1,φ}=x₁=F(x₂)

As described above, also in the case of the basic LSD method, by adoption of a configuration applying the 2-branch one-way hierarchical tree, the number of labels to be held by every receiver can be reduced.

Consider the number of labels that can be reduced from those held by every receiver in the present invention with a leaf count N. First of all, consider the number of labels each represented by LABEL_{i,j}, where nodes i and j are parent and child nodes respectively, as labels that must be held by every receiver in the case of a basic LSD method not applying the present invention.

With the nodes i and j serving as parent and child nodes respectively, there are 3 conceivable cases listed as follows:
(A): The node i exists on a special sub-layer
(B): The node j exists on a special sub-layer
(C): Both the nodes i and j do not exist on a special sub-layer

In all the above cases, the nodes i and j serve as parent and child nodes respectively. That is to say, the nodes i and j are nodes adjacent to each other so that they exist on the same layer. In other words, the nodes i and j of the subset S_{i,j} satisfy the conditions for the nodes i and j as conditions set in the definition of the subset S_{i,j} in the basic LSD method. That is to say, since such a subset is defined as a subset to be used in the basic LSD method, every receiver needs to hold LABEL_{i,j} for the subset S_{i,j}.

There are as many pairs of such nodes i and j for each receiver as nodes i, the number of which is determined by the height of the 2-branch one-way hierarchical tree. That is to say, the number of such parent-child pairs is equal to the number of all nodes existing on a path from the leaf associated with the receiver to the root with the leaf itself not counted. Only one node number j is determined for each node number i. That is to say, the node j forming such a parent-child pair in conjunction with the node i is a node existing outside the path as the child node of the parent node i. As described earlier, such a child node j is referred to as a sister node. In other words, the number of such parent-child pairs is log N, which is proportional to the height of the 2-branch one-way hierarchical tree.

That is to say, also in the case of the basic LSD method, the same number of labels as the SD method described earlier can be reduced as long as labels for special subsets are concerned. To put it concretely, also in the case of the basic LSD method, a receiver is provided with LABEL_{P(y),S(y)} having the value x_{y} computed for the node number y indicating a leaf serving as the self node of the receiver and j labels for special subsets where j has a value in the range 0 to log N and N is the number of leaves included in the 2-branch one-way hierarchical tree as terminal nodes that can be associated with receivers. For a leaf count of N also representing the number of receivers, the number of labels to be held by every receiver as labels for special subsets is thus (j+1).

By adoption of the method provided by the present invention, for some specific receivers among the N receivers, j labels can be eliminated from those that should be held by each of the specific receivers. The number of such specific receivers is expressed by the following equation:

$$( \begin{matrix}log N \\ j\end{matrix} ) \qquad ( 15 )$$

This is because the value of every eliminated label can be found by applying the one-way function F to the value of a label held by the specific receiver.

7: Overview of a General LSD (Layered Subset Difference) Method

Next, an overview of a general LSD (Layered Subset Difference) method is explained.

As described earlier, in the basic LSD method, there is only one type of special sub-layer. In the general LSD method, on the other hand, there is a plurality of special sub-layers having different degrees of importance.

Much like a thesis proposing the LSD method, in a hierarchical tree, a path starting from the root, passing through nodes and ending at a node j is considered as a graph. The root of the tree and the node j are each a terminal point of the path. All nodes on the path are nodes of the graph. A node i is one of internal nodes other than the terminal points. Any node on the graph is represented by a distance from the root to the node. The distance consists of d bth-order digits where b=(log^{1/d} N)−1 where b>1 and d is a power of 2. For example, take a case for which d=1 and N=16. In this case, b=3, which means that the bth order digit is an octal digit. In this case, the root is expressed by d (=1) digit of 0, a child node of the root is represented by an octal digit of 1 and a leaf is represented by an octal digit of 4. As another example, assume d=4 and N=16. In this case b =1, which means that the bth-order digit is a binary digit or a bit. Thus, the root is expressed by d (=4) bits of 0000, a child node of the root is represented by 4 bits of 0001 and a leaf is represented by 4 bits of 0100.

A subset S_{i,j} is considered to be a final transformation from a node i to a node j in a combination of defined transformations, which are each a transition from a node to another. A defined transformation represents a defined subset. Thus, individual transitions required in the last transition each represent a defined subset, which is obtained as a result of splitting the subset S_{i,j} and required for representing the subset S_{i,j}. As described in this thesis, given nodes i, k₁, k₂, - - - k_{d-1} and j existing on a path in a tree in an order the nodes are enumerated here, a subset S_{i,j} in the SD method is expressed by an equation given below in the general LSD method:
S_{i,j}=S_{i,k}_{₁}∪Sₖ_{₁}_{,k}_{₂}∪ . . . ∪Sₖ_{_{d−1}}_{,j} (16)

That is to say, a subset Sᵢⱼ in the SD method is a union of up to d subsets in the general LSD method.

In the general LSD method, let the node i on the graph mentioned above be represented by notation [x] (→) a [0] (→) where symbol a denotes a right-most number among non-zero numbers, notation [x] (→) denotes any array of numbers and notation a [0] (→) denotes an array of zeros. In this case, all transitions to a node j represented by either [x+1] (→) 0 [0] (→) or [x] (→) a′ [y] (→) are defined, where a′>a and [y] (→) is any numerical array having the same length as [0] (→). That is to say, all subsets S_{i,j} each represented by a pair of such i and j are defined.

With the above concept of the general LSD method, the basic LSD method can be regarded as a general LSD method in which a sub-layer represented by a d (=2)-digit number with the last digit on the right-most side equal to 0 is a special sub-layer. In the general LSD method, the number of digits in a zero array on the right-most side in a number representing a node i indicates the importance of the sub-layer. It is quite within the bounds of possibility that the node j can also be any of nodes ranging from a node (i+1) to the first node having a higher degree of importance than the node i. The range of such nodes includes nodes at both ends of the range. With such setting, consider an example for i=825,917 and j=864,563. In this example, a transition from i to j, that is, a subset S_{i,j} in the SD method, can be represented by 4 transitions in the general LSD method. The 4 transitions are 825,917→825,920→826,000→830,000→864,563.

That is to say, the subset S_{i,j} can be represented by the following equation:
S_{i,j}=S_{i,k}_{₁}∪Sₖ_{₁}_{,k}_{₂}∪Sₖ_{₂}_{,k}_{₃}∪Sₖ_{₃}_{,j} (17)
where k₁=825,920, k₂=826,000 and k₃=830,000.

In order to distribute secret information to receivers pertaining to the subset S_{i,j} in the SD method, in the general LSD method, 4 cryptograms are transmitted. The transmitted cryptograms are cryptograms encrypted by using subset keys of subsets expressed by the following equation:
S_{i,k}_{₁}, Sₖ_{₁}_{,k}_{₂}, Sₖ_{₂}_{,k}_{₃}, Sₖ_{₃}_{,j} (18)

In the general LSD method, the number of labels that should be held by every receiver can be reduced by increasing the parameter d. Eventually, the number of labels that should be held by every receiver is expressed by the following expression:
O(log^{1+ε} N)
where ε=1/d.

In addition, at that time, the upper limit of the number of cryptograms to be transmitted is expressed by the following expression:
d(2r−1)
For details, refer to the thesis.
8: Configuration for Reducing a Label Count of the General LSD Method by Using a One-Way Hierarchical Tree

The following description explains a configuration for reducing the number of labels in the general LSD method by using a 2-branch one-way hierarchical tree. The technique for reducing the number of labels in the basic LSD method by using a 2-branch one-way hierarchical tree can be applied to the general LSD method. To put it concretely, the only difference between the basic and general LSD methods is the condition that must be satisfied by a defined subset and there is no difference in the portions utilizing the 2-branch one-way hierarchical tree.

Also in the case of the general LSD method, each receiver um needs to hold LABEL_{i,j} for every subset S_{i,j} of a parent node i and a child node j as a label, which is determined in the SD method as a label to be given to the receiver um. This is because, without regard to what value i is assigned to a node i, the condition defined above as a condition for a transition can be applied to a transition from the node i to its child node j (=i+1). That is to say, much like the basic LSD method, the number of labels for special subsets S_{i,j} with the nodes i and j serving as the parent and child nodes respectively among labels to be held by the receiver is log N. Since at least some of the labels can be found by applying the one-way function F to the label of another special subset, the number of labels to be held by the receiver can be reduced.

That is to say, also in the case of the general LSD method, the same number of labels as the SD method described earlier can be reduced. To put it concretely, also in the case of the general LSD method, a receiver is provided with LABEL_{P(y),S(y)} having the value x_{y} computed for the node number y indicating a leaf serving as the self node of the receiver and j labels for special subsets where j has a value in the range 0 to log N and N is the number of leaves included in the 2-branch one-way hierarchical tree as terminal nodes that can be associated with receivers. For a leaf count of N also representing the number of receivers, the number of labels to be held by every receiver as labels for special subsets is thus (j+1).

By adoption of the method provided by the present invention, for some specific receivers among the N receivers, j labels can be eliminated from those that should be held by each of the specific receivers. The number of such specific receivers is expressed by the following equation:

$$( \begin{matrix}log N \\ j\end{matrix} ) \qquad ( 19 )$$

This is because the value of every eliminated label can be found by applying the one-way function F to the value of a label held by the specific receiver.

Originally, in the general LSD method, the number of labels that should be held by every receiver is expressed by the following expression:
O(log^{1+ε} N)
where symbol ε denotes any positive number. Thus, in comparison with the SD and basic LSD methods, the number of labels that should be held by every receiver is small. Since this low number can be further reduced by the same label count as the SD and basic LSD methods, the number of labels that should be held by every receiver in the general LSD method is extremely small.

The present invention has been explained in detail so far by referring to preferred embodiments. It is obvious, however, that a person skilled in the art is capable of changing the embodiments and/or providing substitutes for the embodiments in a range not departing from essentials of the present invention. That is to say, the embodiments are no more than typical implementations of the present invention and should not therefore be interpreted as limitations to the present invention. In order to form a judgment on essentials of the present invention, only claims appended to this specification applying for a patent of the present invention should be referred to.

It is to be noted that the series of processes described above can be carried out by hardware and/or execution of software. If the series of processes described above is carried out by execution of software, programs composing the software can be installed into a computer embedded in dedicated hardware, a general-purpose personal computer or the like from typically a program-recording medium. By installing a variety of programs into the general-purpose personal computer, the personal computer is capable of carrying out a variety of functions.

The aforementioned program-recording medium for recording the programs to be installed into a computer or a general-purpose personal computer as programs to be executed by the computer or the general-purpose personal computer respectively is a removable recording medium referred to as package media. Examples of the package media are a magnetic disk including a flexible disk, a CD-ROM (Compact Disk-Read Only Memory), an MO (magneto-optical) disk, a DVD (Digital Versatile Disk) and the semiconductor memory. Instead of installing the programs from the package media, the programs can also be stored in advance in a storage unit, which is used for recording the programs temporarily or permanently. Programs recorded in the package media are referred to as the so-called package software. Instead of installing the programs from a removable recording medium, the programs can also be stored in advance in a recording medium such as a hard disk or a ROM (Read Only Memory).

It is to be noted that, instead of installing a program from a removable recording medium into a hard disk as described above, the program can also be downloaded from a download site to the computer through radio communication, or through wire communication by way of a network such as a LAN (Local Area Network) or the Internet. The computer receives the downloaded program and installs the program into a memory such as a hard disk.

It is also worth noting that various kinds of processing described in this specification can be carried out not only in a pre-prescribed order along the time axis, but also concurrently or individually in accordance with the processing power of an apparatus for carrying out the processing or in accordance with necessity. In addition, the technical term “system” used in this specification implies the configuration of a logical confluence comprising a plurality of apparatus, which are not necessarily accommodated in a single cabinet.

As described above, in accordance with the configuration of the present invention, in the information distribution configuration applying the structure of a hierarchical tree as an implementation of the broadcast encryption system, by further applying the 2-branch one-way hierarchical tree to the relatively efficient SD and the LSD methods, it is possible to reduce the amount of information that should be held by every receiver or every information-processing apparatus in a safe manner.

In addition, in accordance with the configuration of the present invention, as a rule, labels of subsets determined on the basis of the SD and LSD methods should be held in every receiver. However, some of the labels assigned to some selected particular special subsets can each be set at a value computable by applying the one-way function F to the value of a label for another special subset. Thus, only labels not provided for special subsets and the labels provided for as few special subsets as possible are given to every receiver. The labels for the few special subsets do not include the labels assigned to the particular special subsets because the labels assigned to the particular special subsets can each be set at a value computable by applying the one-way function F to the value of another label determined as a label given to the receiver. Thus, in comparison with the conventional SD and LSD methods, the number of labels to be held by every receiver is small. This is because the value of each label eliminated from a list of labels to be held in the receiver can be found by applying the one-way function F to the value of a label held by the receiver. Thus, it is possible to carry out processing for all subsets set on the basis of the conventional SD and LSD methods. As a result, by adopting the configuration of the present invention, it is possible to reduce the amount of information to be held in every receiver as labels in a safety manner.

1. An information-processing method for generating a hierarchical tree to be applied to processing to provide decryption apparatus with cryptograms, which can be decrypted only by specifically selected ones of said decryption apparatus excluding revoked decryption apparatus, by adoption of a broadcast encryption method based on a hierarchical tree configuration, said information-processing method comprising:
a tree generation step of generating a one-way hierarchical tree as a tree in which a node key assigned to each of nodes composing said one-way hierarchical tree is set at such a value that said node key assigned to a node on a hierarchical layer at a higher level can be computed by applying a one-way function F to at least one. of node keys assigned to nodes on a hierarchical layer at a lower level; and
a node-key selection step at which, as node keys to be provided to each of said decryption apparatus each serving as a receiver associated with any particular one of terminal nodes on a hierarchical layer at a lowest level of said one-way hierarchical tree, as few node keys as possible are selected among node keys assigned to nodes on a path from said particular lowest-layer terminal node associated with said receiver to a node serving as a root on a hierarchical layer at a highest level of said one-way hierarchical tree except that, as selectable node keys, those of nodes each having a node key computable by applying said one-way function F are excluded.

2. An information-processing method according to claim 1, further comprising a cryptogram generation step of generating a cryptogram by carrying out an encryption process using a node key selected from node keys assigned to nodes composing said one-way hierarchical tree.

3. An information-processing method according to claim 1, wherein said tree generation step is the step of generating a 2-branch one-way hierarchical tree in which a node key assigned to each of nodes composing said 2-branch one-way hierarchical tree as a key for a node on a hierarchical layer at a higher level is set at a value computable by applying said one-way function F to values of node keys assigned to one of 2 nodes existing on a hierarchical layer at a level lower than said hierarchical layer at said higher level as nodes directly subordinate to said node on said hierarchical layer at said higher level.

4. An information-processing method according to claim 1, wherein said tree generation step includes the step of computing node keys x₁ to x_{2N-1} of respectively all (2N−1) nodes composing said 2-branch one-way hierarchical tree by execution of:
a selection step of selecting N values x_{N}, x_{N+1}, . . . , and x_{2N-1} for said 2-branch one-way hierarchical tree having a 2-branch tree configuration with N terminal nodes;
an initialization step of initializing a variable i at (2N−1); and
a computation step of computing x_{i/2}=F(xᵢ) for even values of said variable i in the range (2N−1) to 1 where F is said one-way function.

5. An information-processing method according to claim 1, wherein, at said node-key selection step, in said one-way hierarchical tree having a node number i of 1 assigned to a node serving as a root in said one-way hierarchical tree at the highest level and remaining node numbers i assigned to nodes on hierarchical layers at lower levels in a breadth first order, any specific one of receivers associated with respective terminal nodes of said one-way hierarchical tree is provided only with the node keys of nodes i identified by such node numbers i that nodes i are included in a path from said terminal node associated with said specific receiver to said root but nodes 2i are not included in said same path.

6. An information-processing method according to claim 1, wherein said one-way function F is MD4, MD5 or SHA-1.

7. A decryption method for carrying out a process to decrypt a cryptogram obtained as a result of an encryption process using a node key for a node in a hierarchical tree by adoption of a broadcast encryption method based on a hierarchical tree configuration, said decryption method comprising:
a cryptogram selection step of selecting a decryptable cryptogram from a set of cryptograms each obtained as a result of said encryption process as a cryptogram that can be decrypted by using a node key held by an apparatus adopting said decryption method or a higher-level node key computable from said held node key;
a node-key computation step at which, if a node key to be used for decrypting said selected cryptogram is not said held node key, said node key to be used for decrypting said selected cryptogram is computed by applying a one-way function F to said held node key; and
a cryptogram decryption step of decrypting said selected cryptogram by using said held node key or said node key computed by applying said one-way function F to said held node key.

8. A decryption method according to claim 7, wherein, at said cryptogram selection step, in said hierarchical tree having a node number i of 1 assigned to a node serving as a root in said hierarchical tree at the highest level and remaining node numbers i assigned to nodes on hierarchical layers at lower levels in a breadth first order, any specific one of receivers associated with respective terminal nodes of said hierarchical tree selects such a specific node number i assigned to a node i from a list of node numbers each associated with a node key used in said encryption process to generate a cryptogram that said node i is included in a path from said terminal node associated with said receiver to said root.

9. A decryption method according to claim 8, wherein said node-key computation step includes:
a determination step, in said hierarchical tree having a node number i of 1 assigned to said node serving as said root in said hierarchical tree at the highest level and remaining node numbers i assigned to nodes on hierarchical layers at lower levels in said breadth first order, of determining such a smallest k that a node number of 2^{k}i is included in said path from said terminal node associated with said receiver to said root but a node number of 2^{k+1}i is not where i is the value of said specific node number; and
a node-key calculation step of carrying out a process to calculate a node key to be used for decrypting said selected cryptogram by applying said one-way function F repeatedly k times to the value of a node key NK₂_{^{k}}ᵢ held by said receiver.

10. A decryption method according to claim 7, wherein said one-way function F is MD4, MD5 or SHA-1.

11. An information-processing apparatus for generating a hierarchical tree to be applied to processing to provide decryption apparatus with cryptograms, which can be decrypted only by specifically selected ones of said decryption apparatus excluding revoked decryption apparatus, by adoption of a broadcast encryption method based on a hierarchical tree configuration, said information-processing apparatus comprising:
a tree generation unit for generating a one-way hierarchical tree as a tree in which a node key assigned to each of nodes composing said one-way hierarchical tree is set at such a value that said node key assigned to a node on a hierarchical layer at a higher level can be computed by applying a one-way function F to at least one of node keys assigned to nodes on a hierarchical layer at a lower level; and
a node-key selection unit wherein, as node keys to be provided to each of said decryption apparatus each serving as a receiver associated with any particular one of terminal nodes on a hierarchical layer at a lowest level of said one-way hierarchical tree, as few node keys as possible are-selected among node keys assigned to nodes on a path from said particular lowest-layer terminal node associated with said receiver to a node serving as a root on a hierarchical layer at a highest level of said one-way hierarchical tree except that, as selectable node keys, those of nodes each having a node key computable by applying said one-way function F are excluded.

12. An information-processing apparatus for carrying out a process to decrypt a cryptogram obtained as a result of an encryption process using a node key for a node in a one-way hierarchical tree by adoption of a broadcast encryption method based on a hierarchical tree configuration, said information-processing apparatus comprising:
a cryptogram selection unit for selecting a decryptable cryptogram from a set of cryptograms each obtained as a result of said encryption process as a cryptogram that can be decrypted by using a node key held by said information-processing apparatus or a higher-level node key computable from said held node key;
a node-key computation unit for computing a node key to be used for decrypting said selected cryptogram by applying a one-way function F to said held node key in case said node key to be used for decrypting said selected cryptogram is not said held node key; and
a cryptogram decryption unit for decrypting said selected cryptogram by using said held node key or said node key computed by applying said one-way function F to said held node key.

13. An information-processing apparatus according to claim 12, wherein, in said one-way hierarchical tree having a node number i of 1 assigned to a node serving as a root in said one-way hierarchical tree at the highest level and remaining node numbers i assigned to nodes on hierarchical layers at lower levels in a breadth first order, said cryptogram selection unit carries out a process to select such a specific node number i assigned to a node i that said node i is included in a path from a terminal node associated with said information-processing apparatus to said root from a list of node numbers each associated with a node key used in an encryption process to generate a cryptogram.

14. An information-processing apparatus according to claim 13, wherein said node-key computation unit carries out:
a process to determine, in said one-way hierarchical tree having a node number i of 1 assigned to a node serving as a root in said one-way hierarchical tree at the highest level and remaining node numbers i assigned to nodes on hierarchical layers at lower levels in said breadth first order, such a smallest k that a node number of 2^{k}i is included in said path from said terminal node associated with said receiver to said root but a node number of 2^{k+1}i is not where i is the value of said specific node number; and
a process to calculate a node key to be used for decrypting said selected cryptogram by applying said one-way function F repeatedly k times to the value of a node key NK₂_{^{k}}ᵢ held by said receiver.

15. A computer program for generating a hierarchical tree to be applied to processing to provide decryption apparatus with cryptograms, which can be decrypted only by specifically selected ones of said decryption apparatus excluding revoked decryption apparatus, by adoption of a broadcast encryption method based on a hierarchical tree configuration, said computer program comprising:
a tree generation step of generating a one-way hierarchical tree as a tree in which a node key assigned to each of nodes composing said one-way hierarchical tree is set at such a value that said node key assigned to a node on a hierarchical layer at a higher level can be computed by applying a one-way function F to at least one of node keys assigned to nodes on a hierarchical layer at a lower level; and
a node-key selection step at which, as node keys to be provided to each of said decryption apparatus each serving as a receiver associated with any particular one of terminal nodes on a hierarchical layer at a lowest level of said one-way hierarchical tree, as few node keys as possible are selected among node keys assigned to nodes on a path from said particular lowest-layer terminal node associated with said receiver to a node serving as a root on a hierarchical layer at a highest level of said one-way hierarchical tree except that, as selectable node keys, those of nodes each having a node key computable by applying said one-way function F are excluded.

16. A computer program for carrying out a process to decrypt a cryptogram obtained as a result of an encryption process using a node key for a node in a hierarchical tree by adoption of a broadcast encryption method based on a hierarchical tree configuration, said computer program comprising:
a cryptogram selection step of selecting a decryptable cryptogram from a set of cryptograms each obtained as a result of said encryption process as a cryptogram that can be decrypted by using a node key held by an apparatus adopting said decryption method or a higher-level node key computable from said held node key;
a node-key computation step of computing a node key to be used for decrypting said selected cryptogram by applying a one-way function F to said held node key if said node key to be used for decrypting said selected cryptogram is not said held node key; and
a cryptogram decryption step of decrypting said selected cryptogram by using said held node key or said node key computed by applying said one-way function F to said held node key.

17. An information-processing method for generating a hierarchical tree to be applied to processing to provide decryption apparatus with cryptograms, which can be decrypted only by specifically selected ones of said decryption apparatus excluding revoked decryption apparatus, by adoption of a broadcast encryption method based on a hierarchical tree configuration, said information-processing method comprising:
a label generation step of generating labels, which have values of labels for some selected special subsets as values each computable by applying a one-way function F to the value of another label, as labels for subsets determined on the basis of an SD. (Subset Difference) method applying a hierarchical tree configuration;
a provided-label determination step of determining labels to be provided to each of said decryption apparatus each serving as a receiver associated with a terminal node of said hierarchical tree; and
a final-label determination step of selecting labels not provided for special subsets and as few labels provided for special subsets as possible among said labels to be provided to said receiver as final labels to be provided to said receiver by screening said few labels provided for special subsets to exclude those computable by applying said one-way function F to the value of one of said final labels provided to said receiver.

18. An information-processing method according to claim 17, further comprising a cryptogram generation step of generating a cryptogram by carrying out an encryption process using a selected subset key computable from a label generated at said label generation step as a label for a subset and providing said cryptogram to said receiver.

19. An information-processing method according to claim 17, wherein said selected special subsets used at said label generations step:
are special subsets selected from subsets S_{i,j} each defined as a set obtained as a result of subtracting a partial tree having a node j at its vertex from a partial tree having a node i at its vertex in said hierarchical tree; and
include at least first special subsets S_{i,j} each having said nodes i and j serving as parent and child nodes respectively in said hierarchical tree and a second special subset S_{1,φ} obtained as a result of subtracting no partial tree from said entire said hierarchical tree having said root at its vertex and including all leaves of said hierarchical tree.

20. An information-processing method according to claim 17, wherein said label generation step is a step of generating labels, which each have the value of a label for any specific one of said selected special subsets as a value computable by applying said one-way function F to the value of another label for another special subset largest among subsets in said specific selected special subset, as labels for subsets determined on the basis of said SD (Subset Difference) method applying a hierarchical tree configuration.

21. An information-processing method according to claim 17, wherein said label generation step includes a step of computing values x₁ to x_{2N-1} of labels for respectively all (2N−1) special subsets in a 2-branch one-way hierarchical tree having N terminal nodes by execution of:
a selection step of selecting N values x_{N}, x_{N+1}, . . . , and x_{2N-1} in said 2-branch one-way hierarchical tree having a 2-branch tree configuration with N terminal nodes;
an initialization step of initializing a variable i at (2N−1); and
a computation step of computing x_{i/2}=F(xᵢ) for even values of said variable i in said range (2N−1) to 1 where F is said one-way function.

22. An information-processing method according to claim 21, wherein, at said provided-label determination step is executed to carry out the following operations in which:
labels to be given to a receiver um are selected as tentatively selected labels wherein said tentatively selected labels are LABEL_{i,j} of every subset S_{i,j} with an internal node i used as a starting minuend node and a node j serving as a subtrahend node, which is a direct-branch node from a partial path from a leaf associated with said receiver um to said internal node i on a path (referred to as path-m) from said leaf to said root, and also include LABEL_{1,φ} of a second special subset SS_{1,φ} where said second special subset SS_{1,φ} is defined as a subset of said entire 2-branch one-way hierarchical tree including all receivers and is therefore a subset used for a no-revocation case in which no receivers are revoked;
labels are reselected from said tentatively selected labels as labels satisfying conditions (a) or (b) described as follows:
(a): a reselected label is a tentatively selected label, which shall be neither a label corresponding to the subset key of any of first special subsets SS_{i,j} nor a label corresponding the subset key of said second special subset SS_{1,φ} where a first special subset SS_{i,j} is defined as a subset of a parent node i and a child node j of said parent node i;
(b): a reselected label is a tentatively selected label, which shall be a label corresponding to the subset key of any of said first special subsets SS_{i,j} or the subset key of said second special subset SS_{1,φ}, but said tentatively selected label satisfying condition (b) must satisfy the following sub-conditions:
(b1): nodes y shall be included in nodes on said path-m and
(b2): nodes 2y shall not be included in nodes on said path-m,
where symbol y is the number of a node y whose associated value x_{y} is used as said tentatively selected LABEL_{P(y),S(y)} where subscript P(y) is the node number of the parent node of said node indicated by said node number y and subscript S(y) is the node number of a sister node of said node indicated by said node number y; and
said tentatively selected labels satisfying condition (a) and tentatively selected labels satisfying condition (b) are given to said receiver um.

23. An information-processing method according to claim 17, wherein said provided-label determination step is a step of providing said receiver with j labels each provided for a special subset, where j=0, 1, . . . , and log N and N is the number of terminal nodes (or leaves) included in said hierarchical tree as nodes each associated with a receiver, in addition to a label having a value equal to X_{y}, that is, LABEL_{P(y),S(y)}=x_{y}, where subscript y is the node number of a terminal node (or a self node) associated with said receiver, subscript P(y) is the node number of the parent node of said terminal node indicated by said node number y and subscript S(y) is the node number of a sister node of said node indicated by said node number y.

24. An information-processing method according to claim 17, wherein said one-way function F is MD4, MD5 or SHA-1.

25. An information-processing method according to claim 17, wherein said label determination step is a step of setting a label for each of some special subsets selected among subsets set in accordance with a basic LSD (Layered Subset Difference) method at a value computable by applying said one-way function F to the value of a label for another special subset where said basic LSD method is an extended SD method having a subset management configuration of managing subsets by introducing the concept of layers delimited from each other by special sub-layers set in said hierarchical tree as special sub-layers of one type.

26. An information-processing method according to claim 17, wherein said label determination step is a step of setting a label for each of some special subsets selected among subsets set in accordance with a general LSD (Layered Subset Difference) method at a value computable by applying said one-way function F to the value of a label for another special subset where said general LSD method is an extended basic LSD method having a subset management configuration of managing subsets by introducing the concept of layers delimited from each other by special sub-layers set in said hierarchical tree as special sub-layers having a plurality of different types.

27. A decryption method for carrying out a process to decrypt a cryptogram obtained as a result of an encryption process using a subset key for a subset in a hierarchical tree by adoption of an SD (Subset Difference) method implemented as a broadcast encryption method based on a hierarchical tree configuration, said decryption method comprising:
a cryptogram selection step of selecting a decryptable cryptogram from a set of cryptograms each obtained as a result of said encryption process as a cryptogram that can be decrypted by a subset key computable by carrying out a pseudo random number generation process on a label held by a decryption apparatus or another label derivable from said held label;
a label derivation step of deriving a label required for computing a subset key to be used for decrypting said selected cryptogram by applying a one-way function F to said held label as a label different from said held label if said subset key to be used for decrypting said selected cryptogram is not a subset key computable by carrying out said pseudo random number generation process on said held label;
a subset key generation step of generating a subset key computed by carrying out said pseudo random number generation process on said held label or said label derived from said held label; and
a cryptogram decryption step of carrying out a process to decrypt said selected cryptogram by using said subset key computed by carrying out said pseudo random number generation process on said held label or said label derived from said held label.

28. A decryption method according to claim 27, wherein, at said label derivation step, another label provided for a special subset is derived as a label required for computing a subset key to be used for decrypting said selected cryptogram by applying said one-way function F to a held label in case said other label is not a held label and said subset key is computed by carrying out said pseudo random number generation process on said derived other label for said special subset, which:
is selected from subsets S_{i,j} each defined as a subset obtained as a result of subtracting a partial tree having a node j at its vertex from a partial tree having a node i at its vertex in said hierarchical tree; and
must be a first special subset S_{i,j} having said nodes i and j serving as parent and child nodes respectively in said hierarchical tree or a second special subset S_{1,φ} obtained as a result of subtracting no partial tree from said entire hierarchical tree having said root at its vertex and including all leaves of said hierarchical tree.

29. A decryption method according to claim 28, wherein said label derivation step is a step of applying said one-way function F to compute said other label for a special subset including nodes on a path from a leaf associated with said decryption apparatus functioning as a receiver for carrying out a decryption process to said root in said hierarchical tree.

30. An information-processing apparatus for generating a hierarchical tree to be applied to processing to provide decryption apparatus with cryptograms, which can be decrypted only by specifically selected ones of said decryption apparatus excluding revoked decryption apparatus, by adoption of a broadcast encryption method based on a hierarchical tree configuration, said information-processing apparatus comprising:
a label generation unit for generating labels, which have values of labels for some selected special subsets as values each computable by applying a one-way function F to the value of another label, as labels for subsets determined on the basis of an SD (Subset Difference) method applying a hierarchical tree configuration;
a provided-label determination unit for determining labels to be provided to each of said decryption apparatus each serving as a receiver associated with a terminal node of said hierarchical tree; and
a final-label determination unit for selecting labels not provided for special subsets and as few labels provided for special subsets as possible among said labels to be provided to said receiver as final labels to be provided to said receiver by screening said few labels provided for special subsets to exclude those computable by applying said one-way function F to the value of one of said final labels provided to said receiver.

31. An information-processing apparatus for carrying out a process to decrypt a cryptogram obtained as a result of an encryption process using a subset key for a subset in a hierarchical tree by adoption of an SD (Subset Difference) method implemented as a broadcast encryption method based on a hierarchical tree configuration, said information-processing apparatus comprising:
a cryptogram selection unit for selecting a decryptable cryptogram from a set of cryptograms each obtained as a result of said encryption process as a cryptogram that can be decrypted by a subset key computable by carrying out a pseudo random number generation process on a label held by said information-processing apparatus itself or another label derivable from said held label;
a label derivation unit for deriving a label required for computing a subset key to be used for decrypting said selected cryptogram by applying a one-way function F to said held label as a label different from said held label if said subset key to be used for decrypting said selected cryptogram is not a subset key computable by carrying out said pseudo random number generation process on said held label;
a subset key generation unit for generating a subset key computed by carrying out said pseudo random number generation process on said held label or said label derived from said held label; and
a cryptogram decryption unit for carrying out a process to decrypt said selected cryptogram by using said subset key computed by carrying out said pseudo random number generation process on said held label or said label derived from said held label.

32. A computer program for generating a hierarchical tree to be applied to processing to provide decryption apparatus with cryptograms, which can be decrypted only by specifically selected ones of said decryption apparatus excluding revoked decryption apparatus, by adoption of a broadcast encryption method based on a hierarchical tree configuration, said computer program comprising:
a label generation step of generating labels, which have values of labels for some selected special subsets as values each computable by applying a one-way function F to the value of another label, as labels for subsets determined on the basis of an SD (Subset Difference) method applying a hierarchical tree configuration;
a provided-label determination step of determining labels to be provided to each of said decryption apparatus each serving as a receiver associated with a terminal node of said hierarchical tree; and
a final-label determination step of selecting labels not provided for special subsets and as few labels provided for special subsets as possible among said labels to be provided to said receiver as final labels to be provided to said receiver by screening said few labels provided for special subsets to exclude those computable by applying said one-way function F to the value of one of said final labels provided to said receiver.

33. A computer program for carrying out a process to decrypt a cryptogram obtained as a result of an encryption process using a subset key for a subset in a hierarchical tree by adoption of an SD (Subset Difference) method implemented as a broadcast encryption method based on a hierarchical tree configuration, said computer program comprising:
a cryptogram selection step of selecting a decryptable cryptogram from a set of cryptograms each obtained as a result of said encryption process as a cryptogram that can be decrypted by a subset key computable by carrying out a pseudo random number generation process on a label held by a decryption apparatus or another label derivable from said held label;
a label derivation step of deriving a label required for computing a subset key to be used for decrypting said selected cryptogram by applying a one-way function F to said held label as a label different from said held label if said subset key to be used for decrypting said selected cryptogram is not a subset key computable by carrying out said pseudo random number generation process on said held label;
a subset key generation step of generating a subset key computed by carrying out said pseudo random number generation process on said held label or said label derived from said held label; and
a cryptogram decryption step of carrying out a process to decrypt said selected cryptogram by using said subset key computed by carrying out said pseudo random number generation process on said held label or said label derived from said held label.
